(19) United States
(12) Patent Application Publication
(10) Pub. No.: US 2007/0031283 A1
(43) Pub. Date: Feb. 8, 2007

(54) Assay cartridges and methods for point of care instruments

(76) Inventors: Charles Quentin Davis, Frederick, MD (US); John E. Liljestrand, Ijamsville, MD (US); Jonathan Leland, Silver Spring, MD (US); Martin Blankfard, Falls Church, MD (US); Jonathan M. Miller, Fairfax, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/473,535

(22) Filed: Jun. 23, 2006

Related U.S. Application Data
(60) Provisional application No. 60/693,041, filed on Jun. 23, 2005.
(60) Provisional application No. 60/799,837, filed on May 12, 2006.

(51) Int. Cl. G01N 31/22

(52) U.S. Cl. 422/58

(57) ABSTRACT

Devices and methods are provided for performing a test to detect and/or quantify the presence of an analyte of interest within a sample using a portable instrument.

### CROSS-REFERENCE TO RELATED APPLICATIONS

This application claims the benefit of U.S. Provisional Application No. 60/693,041, filed Jun. 23, 2005, and U.S. Provisional Application No. 60/799,837, filed May 12, 2006, which are herein incorporated by reference in their entireties.

### FIELD OF THE INVENTION

This invention relates generally to instruments, assay cartridges, kits, and methods for testing a sample for analytes of interest, and more specifically to portable systems for conducting such tests. It also relates to components of assay cartridges, which may be incorporated into the cartridges and instruments of the invention.

### BACKGROUND OF THE INVENTION

It is well known in the art to test biochemical, environmental, or biological substances to detect and/or quantify analytes of interest. For example, tests can be conducted to detect and/or quantify the presence of microorganisms, pharmaceuticals, hormones, viruses, antibodies, nucleic acids and other proteins.

A variety of instruments known in the art are capable of performing testing on samples to detect analytes of interest. However, typical testing instruments are large and are typically housed in a fixed location in a laboratory or hospital. In many cases, samples to be tested with an assay instrument are obtained off-site, meaning that they must be transported to the location of the assay instrument. There exists the need for a portable diagnostic device useable in decentralized settings that maintains the low test cost, the diverse menu and/or the high performance of tests carried out on fixed laboratory or hospital instruments.

### BRIEF SUMMARY OF THE INVENTION

Consistent with embodiments of the present invention, devices and methods for testing for analytes of interest and other biochemical assays in a sample using a portable instrument are provided.

In accordance with one embodiment, a portable instrument for detecting the presence of an analyte of interest in a sample is provided. The instrument can comprise a housing and a cartridge adapted to receive a sample. The cartridge can contain a binding reagent and can be adapted to contact the binding reagent with the sample. The housing can contain a testing apparatus adapted to detect the presence of the analyte of interest in the sample contained in the cartridge. The instrument can also comprise a notification apparatus adapted to notify a user of the results of the assay. The instrument can further comprise a sample collection system operative to obtain a sample and transfer it to the cartridge. The sample collection system can be adapted to connect to the cartridge and/or can be built into the cartridge. The sample collection system may comprise a needle and/or a needle-pierceable membrane.

In another embodiment, a method for detecting the presence of an analyte of interest in a sample is provided. The method can comprise obtaining a sample using a sample collection system comprising a needle or a needle-pierceable membrane. The sample collection system can be adapted to connect to a cartridge adapted to store the sample. The method can further comprise inserting the cartridge into a portable testing instrument and performing a test to detect the presence of the analyte of interest in the sample. The method can further comprise communicating the results of the test to an external device using a communications system contained in the portable testing instrument.

In assay cartridges comprising a blood separation filter used in blood analysis, a pressure gradient drives the blood across the filter. Also disclosed herein are embodiments for a method of getting the blood donor's cardiovascular system (e.g., the heart) to provide some of the pressure.

Also disclosed herein are various embodiments for assay cartridges. In one embodiment, an assay cartridge comprises one or more incubation zones, a sample collection system, and a fluidic architecture configured to fluidically connect a sample from the sample collection system to the one or more incubation zones. An assay cartridge may further comprise a separation filter and a storage zone, wherein the separation filter is located fluidically between the storage zone and the sample collection system. In another embodiment, a separation filter may be fluidically located between the sample collection system and the one or more incubation zones.

Also disclosed herein are embodiments for assay cartridges having one or more binding reagent for one or more analytes of interest, one or more labeled molecules, and one or more incubation zones. The one or more incubation zones may include a dry composition having a plurality of magnetizable capture beads.

In a further embodiment, the assay cartridges may comprise at least one incubation zone, at least one measurement zone, and a liquid reagent storage zone. The incubation zone may include one or more binding reagents for one or more analytes of interest, one or more labeled molecules, and a plurality of magnetizable capture beads. In another embodiment, the incubation zone may include an assay- performance substance, a plurality of magnetizable capture beads, and a plurality of magnetizable separation beads. The dry composition may be in the form of a cake that occupies a substantial percentage (e.g., 10% or more) of the incubation zone.

Also disclosed herein are assay cartridges having an incubation zone, a storage zone, and a sample entry zone. In a further embodiment, the assay cartridge may have an opaque surface that can complete a light-tight enclosure for an interior portion of an instrument that comprises a light detector. While particularly important-for portable instruments where size and complexity are critical, this concept also has utility for non-portable instruments as well.

Also disclosed herein are methods and apparatus for a novel form of free- bound separation, Stoke's washing. Also disclosed herein are methods and apparatus for a new form of free-bound separation that uses ferrofluids, magnetizable capture beads, and labeled molecules comprising non-magnetic beads. Bound label linked to the capture beads can be attracted by a magnet while free label can be repelled by the interaction of the magnetic field and the ferrofluid.

Also disclosed herein are methods and apparatus for the passive redirection of flow from one outlet to another in an assay cartridge. Passive redirection may reduce cartridge and instrument complexity and/or improve performance.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1A is an exemplary housing of an instrument consistent with the principles of the embodiments disclosed herein.

FIG. 1B is another exemplary housing of an instrument consistent with the principles of the embodiments disclosed herein.

FIG. 2A is an exemplary assay cartridge of an instrument consistent with the principles of the embodiments disclosed herein.

FIG. 2B is also an exemplary assay cartridge of an instrument consistent with the principles of the embodiments disclosed herein.

FIG. 3A is a cross-sectional view of an exemplary instrument consistent with the principles of the embodiments disclosed herein with one version of an assay cartridge plugged into one version of a housing.

FIG. 3B is a cross-sectional view of another exemplary instrument consistent with the principles of the embodiments disclosed herein with a second version of an assay cartridge plugged into a second version of a housing.

FIG. 3C is a cross-sectional view of another exemplary instrument consistent with the principles of the embodiments disclosed herein with a third version of an assay cartridge plugged into a third version of a housing.

FIG. 3D is a cross-sectional view of another exemplary instrument consistent with the principles of the embodiments disclosed herein with a fourth version of an assay cartridge plugged into a fourth version of a housing.

FIG. 4 is a cross-sectional view of yet another exemplary instrument consistent with the principles of the embodiments disclosed herein showing an assay cartridge capable of moving relative to the housing after insertion.

FIG. 5A is an exemplary assay cartridge consistent with the principles of the embodiments disclosed herein comprising a removable sample collection system and sample storage system.

FIG. 5B is the exemplary assay cartridge system of FIG. 5A with a needle of the sample collection system extended.

FIG. 6 is an exemplary assay cartridge consistent with the principles of the embodiments disclosed herein incorporating a sample storage system and a removable sample collection system.

FIGS. 7A, 7B, and 7C each depict exemplary assay cartridges consistent with the principles of the embodiments disclosed herein incorporating a removable sample storage system.

FIG. 8 illustrates an exemplary instrument consistent with the principles of the embodiments disclosed herein comprising a display screen.

FIG. 9 illustrates an exemplary instrument consistent with the principles of the embodiments disclosed herein plugged into a docking station.

FIG. 10 is a partial, cross-sectional top view of an exemplary assay cartridge consistent with the principles of the embodiments disclosed herein.

FIG. 11 is a schematic of an exemplary configuration of an excitation mechanism and an assay cartridge consistent with the principles of the embodiments disclosed herein.

FIG. 12 is a partial cross-sectional top view of an exemplary assay cartridge consistent with the principles of the embodiments disclosed herein.

FIG. 13 is an illustration of an exemplary instrument consistent with the principles of the embodiments disclosed herein with a top portion of the housing removed.

FIG. 14 is a partial cross-sectional top view of an exemplary assay cartridge consistent with the principles of the present invention.

FIG. 15A is a cross-sectional view of an exemplary assay cartridge consistent with the principles of the embodiments disclosed herein taken along A-A of FIG. 14.

FIG. 15B is a cross-sectional view of an exemplary assay cartridge consistent with the principles of the embodiments disclosed herein taken along B-B of FIG. 14.

FIG. 15C is a cross-sectional view of an exemplary assay cartridge consistent with the principles of the embodiments disclosed herein taken along C-C of FIG. 14.

FIG. 16 is a top view of an exemplary assay cartridge consistent with the principles of the embodiments disclosed herein having a top cover of the cartridge removed.

FIGS. 17A, 17B, 17C, 17D, 17E, and 17F illustrate exemplary configurations for Stoke's washing consistent with the principles of the embodiments disclosed herein.

FIGS. 18A, 18B, 18C, 18D, 18E, 18F and 18G also illustrate exemplary configurations for Stoke's washing consistent with the principles of the embodiments disclosed herein.

FIG. 19 is a photograph demonstrating an embodiment of Stoke's washing consistent with the principles of the embodiments disclosed herein.

FIGS. 20A and 20B illustrate families of fluidic architectures for an assay cartridge consistent with the principles of the embodiments disclosed herein.

FIG. 20C depicts a family of fluidic architectures that form a part of the fluidic architectures of FIGS. 20A and 20B.

FIGS. 20D, 20E, and 20F each depict families of fluidic architectures that form a part of the fluidic architecture of FIG. 20C.

FIGS. 20G and 20H depict families of fluidic architectures that form a part of the fluidic architectures of FIGS. 20A and 20B.

FIGS. 20I, 20J, 20J, 20L, 20M, and 20N depict families of fluidic architectures that form a part of the fluidic architecture of FIG. 20G and 20H.

FIG. 20O depicts a family of fluidic architectures that form a part of the fluidic architectures of FIGS. 20A and 20B.

FIGS. 21A-21E illustrate an exemplary assay cartridge from various views. FIG. 21A shows a 3-dimensional view of an assay cartridge. FIG. 21B shows an exploded view of the cartridge components. FIG. 21C shows a bottom view of the cartridge base. FIG. 21D shows a cross-sectional side view of the cartridge. FIG. 21E shows a bottom view of the cartridge top.

### DETAILED DESCRIPTION OF THE INVENTION

The following description refers to the accompanying drawings in which, in the absence of a contrary representation, the same numbers in different drawings represent similar elements. The implementations in the following description do not represent all implementations consistent with principles of the claimed invention. Instead, they are merely some examples of systems and methods consistent with those principles. It is to be understood that both the foregoing general description and the following detailed description are exemplary and explanatory only and are not restrictive of the invention as claimed.

### I. DEFINITIONS

In order to more clearly understand the invention, certain terms are defined as follows.

The term “portable,” as used herein, refers to items described herein weighing less than or equal to 1 kg.

The term “dry composition,” as used herein, means that the composition has a moisture content of less than or equal to 5% by weight, relative to the total weight of the composition. Examples of dry compositions include compositions that have a moisture content of less than or equal to 3% by weight, relative to the total weight of the composition and compositions that have a moisture content ranging from 1% to 3% by weight, relative to the total weight of the composition.

The term “linked” or “linking” refers to an association between two moieties. The association can be a covalent bond. The association can be a non-covalent bond, including but not limited to, ionic interactions, hydrogen bonds, and van der Waals forces. Exemplary non-covalent bonds include hybridization between complementary oligonucleotides and/or polynucleotides, biotin/streptavidin interactions, and antibody/antigen interactions.

The term “binding partner,” as used herein, means a substance that can bind specifically to an analyte of interest. In general, specific binding is characterized by a relatively high affinity and a relatively low to moderate capacity. Nonspecific binding usually has a low-affinity-with a moderate to high capacity. Typically, binding is considered specific when the affinity constant Ka is higher than about 10⁶ M⁻¹. For example, binding may be considered specific when the affinity constant Ka is higher than about 10⁸ M⁻¹. A higher affinity constant indicates greater affinity, and thus typically greater specificity. For example, antibodies typically bind antigens with an affinity constant in the range of 10⁶ M⁻¹ to 10⁹ M⁻¹ or higher.

Examples of binding partners include complementary nucleic acid sequences (e.g., two DNA sequences which hybridize to each other; two RNA sequences which hybridize to each other; a DNA and an RNA sequence which hybridize to each other), an antibody and an antigen, a receptor and a ligand (e.g., TNF and TNFr-I, CD142 and Factor VIIa, B7-2 and CD28, HIV-1 and CD4, ATR/TEM8 or CMG and the protective antigen moiety of anthrax toxin), an enzyme and a substrate, or a molecule and a binding protein (e.g., vitamin B12 and intrinsic factor, folate and folate binding protein).

Examples of binding partners include antibodies. The term “antibody,” as used herein, means an immunoglobulin or a part thereof, and encompasses any polypeptide (with or without further modification by sugar moieties (mono and polysaccharides)) comprising an antigen binding site regardless of the source, method of production, or other characteristics. The term includes, for example, polyclonal, monoclonal, monospecific, polyspecific, humanized, single chain, chimeric, synthetic, recombinant, hybrid, mutated, and CDR grafted antibodies as well as fusion proteins. A part of an antibody can include any fragment which can bind antigen, including but not limited to Fab, Fab′, F(ab′)2, Facb, Fv, ScFv, Fd, VH, and VL.

A large number of monoclonal antibodies that bind to various analytes of interest are available, as exemplified by the listings in various catalogs, such as: Biochemicals and Reagents for Life Science Research, Sigma-Aldrich Co., P.O. Box 14508, St. Louis, Mo., 63178 (1999); the Life Technologies Catalog, Life Technologies, Gaithersburg, Md.; and the Pierce Catalog, Pierce Chemical Company, P.O. Box 117, Rockford, Ill. 61105 (1994).

Other exemplary antibodies, optionally monoclonal antibodies, include those that bind specifically to β-actin, DNA, digoxin, insulin, progesterone, human leukocyte markers, human interleukin-10, human interferon, human fibrinogen, p53, hepatitis B virus or a portion thereof, HIV virus or a portion thereof, tumor necrosis factor, or FK-506. In certain embodiments, the monoclonal antibody is chosen from antibodies that bind specifically to at least one of T4, T3, free T3, free T4, TSH (thyroid-stimulating hormone), thyroglobulin, TSH receptor, prolactin, LH (luteinizing hormone), FSH (follicle stimulating hormone), testosterone, progesterone, estradiol, hCG (human Chorionic Gondaotropin), HCG+β, SHBG (sex hormone-binding globulin), DHEA-S (dehydroepiandrosterone sulfate), hGH (human growth hormone), ACTH (adrenocorticotropic hormone), cortisol, insulin, ferritin, folate, RBC (red blood cell) folate, vitamin B12, vitamin D, C-peptide, troponin T, CK MB (creatine kinase-myoglobin), myoglobin, pro-BNP (brain natriuretic peptide), HbsAg (hepatitis B surface antigen), HbeAg (hepatitis Be antigen), HIV antigen, HIV combined, H. pylori, β-CrossLaps, osteocalcin, PTH (parathyroid hormone), IgE, digoxin, digitoxin, AFP (α-fetoprotein), CEA (carcinoembryonic antigen), PSA (prostate specific antigen), free PSA, CA (cancer antigen) 19-9, CA 12-5, CA 72-4, cyfra 21 -1, NSE (neuron specific enolase), S 100, P1NP (procollagen type 1 N-propeptide), PAPP-A (pregnancy associated plasma protein-A), Lp-PLA2 (lipoprotein-associated phospholipase A2), sCD40L (soluble CD40 Ligand), IL 18, and Survivin.

Other exemplary antibodies, optionally monoclonal antibodies, include anti-TPO (antithyroid peroxidase antibody), anti-HBc (Hepatitis Bc antigen), anti-HBc/IgM, anti-HAV (hepatitis A virus), anti-HAV/IgM, anti-HCV (hepatitis C virus), anti-HIV, anti-HIV p-24, anti-rubella IgG, anti-rubella IgM, anti-toxoplasmosis IgG, anti-toxoplasmosis IgM, anti-CMV (cytomegalovirus) IgG, anti-CMV IgM, anti-HGV (hepatitis G virus), and anti-HTLV (human T-lymphotropic virus).

Further examples of binding partners include binding proteins, for example, vitamin B12 binding protein, DNA binding proteins such as the superclasses of basic domains, zinc-coordinating DNA binding domains, Helix-turn-helix, beta scaffold factors with minor groove contacts, and other transcription factors that are not antibodies.

The term “label,” as used herein, refers to a molecule or a collection of molecules that are capable of generating, modifying or modulating a detectable signal.

The term “labeled binding partner,” as used herein, means a binding partner that comprises or is linked to a label. For example, in a radiochemical assay, the labeled binding partner may be labeled with a radioactive isotope of iodine. Alternatively, the labeled binding partner antibody may be labeled with an enzyme, for example, horseradish peroxidase, that can be used in a calorimetric assay. The labeled binding partner may also be labeled with a time-resolved fluorescence reporter or a fluorescence resonance energy transfer (FRET) reporter. Exemplary reporters are disclosed in Hemmila, et al., J. Biochem. Biophys. Methods, vol. 26, pp. 283-290 (1993); Kakabakos, et al., Clin. Chem., vol. 38, pp. 338-342 (1992); Xu, et al., Clin. Chem., pp. 2038-2043 (1992); Hemmila, et al., Scand. J. Clin. Lab. Invest., vol. 48, pp. 389-400 (1988); Bioluminescence and Chemiluminescence Proceedings of the 9th International Symposium 1996, J. W. Hastings, et al., Eds., Wiley, New York, 1996; Bioluminescence and Chemiluminescence Instruments and Applications, Knox Van Dyre, Ed., CRC Press, Boca Raton, 1985; I. Hemmila, Applications of Fluorescence in Immunoassays, Chemical Analysis, Volume 117, Wiley, New York, 1991; and Blackburn, et al., Clin. Chem., vol. 37, p. 1534 (1991).

Further examples of labeled binding partners include binding partners that are labeled with a moiety, functional group, or molecule that is useful for generating a signal in an electrochemiluminescent (ECL) assay. The ECL moiety may be any compound that can be induced to repeatedly emit electromagnetic radiation by direct exposure to an electrochemical energy source. Such moieties, functional groups, or molecules are disclosed in U.S. Pat. Nos. 5,962,218; 5,945,344; 5,935,779; 5,858,676; 5,846,485; 5,811,236; 5,804,400; 5,798,083; 5,779,976; 5,770,459; 5,746,974; 5,744,367; 5,731,147; 5,720,922; 5,716,781; 5,714,089; 5,705,402; 5,700,427; 5,686,244; 5,679,519; 5,643,713; 5,641,623; 5,632,956; 5,624,637; 5,610,075; 5,597,910; 5,591,581; 5,543,112; 5,466,416; 5,453,356; 5,310,687; 5,296,191; 5,247,243; 5,238,808; 5,221,605; 5,189,549; 5,147,806; 5,093,268; 5,068,088; 5,935,779, 5,061,445; and 6,808,939; Dong, L. et al., Anal. Biochem., vol. 236, pp. 344-347 (1996); Blohm, et al., Biomedical Products, vol. 21, No. 4: 60 (1996); Jameison, et al., Anal. Chem., vol. 68, pp. 1298-1302 (1996); Kibbey, et al., Nature Biotechnology, vol. 14, no. 3, pp. 259-260 (1996); Yu, et al., Applied and Environmental Microbiology, vol. 62, no. 2, pp. 587-592 (1996); Williams, American Biotechnology, p. 26 (January, 1996); Darsley, et al., Biomedical Products, vol. 21, no. 1, p.133 (January, 1996); Kobrynski, et al., Clinical and Diagnostic Laboratory Immunology, vol. 3, no. 1, pp. 42-46 (January 1996); Williams, IVD Technology, pp. 28-31 (November, 1995); Deaver, Nature, vol. 377, pp. 758-760 (Oct. 26, 1995); Yu, et al., BioMedical Products, vol. 20, no. 10, p. 20 (October, 1995); Kibbey, et al., BioMedical Products, vol. 20, no. 9, p. 116 (September, 1995); Schutzbank, et al., Journal of Clinical Microbiology, vol. 33, pp. 2036-2041 (August, 1995); Stern, et al., Clinical Biochemistry, vol. 28, pp. 470-472 (August, 1995); Carlowicz, Clinical Laboratory News, vol. 21, no. 8, pp. 1-2 (August 1995); Gatto-Menking, et al., Biosensors & Bioelectronics, vol. 10, pp. 501-507 (July, 1995); Yu, et al., Journal of Bioluminescence and Chemiluminescence, vol.10, pp. 239-245 (1995); Van Gemen, et al., Journal of Virology Methods, vol. 49, pp. 1.57-168 (1994); Yang, et al., Bio/Technology, vol. 12, pp. 193-194 (1994); Kenten, et al., Clinical Chemistry, vol. 38, pp. 873-879 (1992); Kenten, Non-radioactive Labeling and Detection of Biomolecules, Kessler, Ed., Springer, Berlin, pp. 175-179 (1992); Gudibande, et al., Journal of Molecular and Cellular Probes, vol. 6, pp. 495-503 (1992); Kenten, et al., Clinical Chemistry, vol. 37, pp. 1626-1632 (1991); Blackburn, et al., Clinical Chemistry, vol. 37, pp. 1534-1539 (1991), and Electrogenerated Chemiluminescence, Bard, Editor, Marcel Dekker (2004).

In some embodiments, the ECL moiety comprises a metal ion chosen from osmium and ruthenium or a derivative of trisbipyridyl ruthenium (II) [Ru(bpy)₃²⁺]. For example, the ECL moiety can be [Ru(sulfo-bpy)₂bpy]²⁺ whose structure is 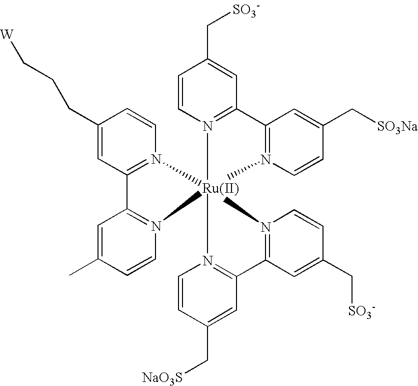
wherein W is a functional group attached to the ECL moiety that can react with a biological material, binding reagent, enzyme substrate or other assay reagent so as to form a covalent linkage such as an NHS ester, an activated carboxyl, an amino group, a hydroxyl group, a carboxyl group, a hydrazide, a maleimide, or a phosphoramidite.

In some embodiments, the ECL moiety does not comprise a metal. Such non-metal ECL moieties can be, but are not limited to, rubrene and 9,10-diphenylanthracene.

The term “analyte,” as used herein, means any molecule, or aggregate of molecules, including a cell or a cellular component of a virus, found in a sample. Examples of analytes to which the binding partner can specifically bind include bacterial toxins, viruses, bacteria, proteins, hormones, DNA, RNA, drugs, antibiotics, nerve toxins, and metabolites thereof. Also included in the scope of the term “analyte” are fragments of any molecule found in a sample. An analyte may be an organic compound, an organometallic compound or an inorganic compound. An analyte may be a nucleic acid (e.g., DNA, RNA, a plasmid, a vector, or an oligonucleotide), a protein (e.g., an antibody, an antigen, a receptor, a receptor ligand, or a peptide), a lipoprotein, a glycoprotein, a ribo- or deoxyribonucleoprotein, a peptide, a polysaccharide, a -lipopolysaccharide, a lipid, a fatty acid, a vitamin, an amino acid, a pharmaceutical compound (e.g., tranquilizers, barbiturates, opiates, alcohols, tricyclic antidepressants, benzodiazepines, anti-virals, anti-fungals, antibiotics, steroids, cardiac glycosides, or a metabolite of any of the preceding), a hormone, a growth factor, an enzyme, a coenzyme, an apoenzyme, a hapten, a lectin, a substrate, a cellular metabolite, a cellular component or organelle (e.g., a membrane, a cell wall, a ribosome, a chromosome, a mitochondria, or a cytoskeleton component). Also included in the definition are toxins, pesticide, herbicides, and environmental pollutants. The definition further includes complexes comprising one or more of any of the examples set forth within this definition.

Further examples of analytes include bacterial pathogens such as Aeromonas hydrophila and other species (spp.); Bacillus anthracis; Bacillus cereus; Botulinum neurotoxin producing species of Clostridium; Brucella abortus; Brucella melitensis; Brucella suis; Burkholderia mallei (formally Pseudomonas mallel); Burkholderia pseudomallei (formerly Pseudomonas pseudomallel); Campylobacter jejuni; Chlamydia psittaci; Clostridium botulinum; Clostridium botulinum; Clostridium perfringens; Coccidioides immitis; Coccidioides posadasii; Cowdria ruminantium (Heartwater); Coxiella burnetii; Enterovirulent Escherichia coli group (EEC Group) such as Escherichia coli—enterotoxigenic (ETEC), Escherichia coli—enteropathogenic (EPEC), Escherichia coli—O157:H7 enterohemorrhagic (EHEC), and Escherichia coli—enteroinvasive (EIEC); Ehrlichia spp. such as Ehrlichia chaffeensis; Francisella tularensis; Legionella pneumophilia; Liberobacter africanus; Liberobacter asiaticus; Listeria monocytogenes; miscellaneous enterics such as Klebsiella, Enterobacter, Proteus, Citrobacter, Aerobacter, Providencia, and Serratia; Mycobacterium bovis; Mycobacterium tuberculosis; Mycoplasma capricolum; Mycoplasma mycoides; Peronosclerospora philippinensis; Phakopsora pachyrhizi; Plesiomonas shigelloides; Ralstonia solanacearum race 3, biovar 2; Rickettsia prowazekii; Rickettsia rickettsii; Salmonella spp.; Schlerophthora rayssiae var zeae; Shigella spp.; Staphylococcus aureus; Streptococcus; Synchytrium endobioticum; Vibrio cholerae non-O1; Vibrio cholerae O1; Vibrio parahaemolyticus and other Vibrios; Vibrio vulnificus; Xanthomonas oryzae; Xylella fastidiosa (citrus variegated chlorosis strain); Yersinia enterocolitica and Yersinia pseudotuberculosis; and Yersinia pestis.

Further examples of analytes include viruses such as African horse sickness virus; African swine fever virus; Akabane virus; Avian influenza virus (highly pathogenic); Bhanja virus; Blue tongue virus (Exotic); Camel pox virus; Cercopithecine herpesvirus 1; Chikungunya virus; Classical swine fever virus; Coronavirus (SARS); Crimean-Congo hemorrhagic fever virus; Dengue viruses; Dugbe virus; Ebola viruses; Encephalitic viruses such as Eastern equine encephalitis virus, Japanese encephalitis virus, Murray Valley encephalitis, and Venezuelan equine encephalitis virus; Equine morbillivirus; Flexal virus; Foot and mouth disease virus; Germiston virus; Goat pox virus; Hantaan or other Hanta viruses; Hendra virus; Issyk-kul virus; Koutango virus; Lassa fever virus; Louping ill virus; Lumpy skin disease virus; Lymphocytic choriomeningitis virus; Malignant catarrhal fever virus (Exotic); Marburg virus; Mayaro virus; Menangle virus; Monkeypox virus; Mucambo virus; Newcastle disease virus (VVND); Nipah Virus; Norwalk virus group; Oropouche virus; Orungo virus; Peste Des Petits Ruminants virus; Piry virus; Plum Pox Potyvirus; Poliovirus; Potato virus; Powassan virus; Rift Valley fever virus; Rinderpest virus; Rotavirus; Semliki Forest virus; Sheep pox virus; South American hemorrhagic fever viruses such as Flexal, Guanarito, Junin, Machupo, and Sabia; Spondweni virus; Swine vesicular disease virus; Tick-borne encephalitis complex (flavi) viruses such as Central European tick-borne encephalitis, Far Eastern tick-borne encephalitis, Russian spring and summer encephalitis, Kyasanur forest disease, and Omsk hemorrhagic fever; Variola major virus (Smallpox virus); Variola minor virus (Alastrim); Vesicular stomatitis virus (Exotic); Wesselbron virus; West Nile virus; Yellow fever virus; and South American hemorrhagic fever viruses such as Junin, Machupo, Sabia, Flexal, and Guanarito.

Further examples of analytes include toxins such as Abrin; Aflatoxins; Botulinum neurotoxin; Ciguatera toxins; Clostridium perfringens epsilon toxin; Conotoxins; Diacetoxyscirpenol; Diphtheria toxin; Grayanotoxin; Mushroom toxins such as amanitins, gyromitrin, and orellanine; Phytohaemagglutinin; Pyrrolizidine alkaloids; Ricin; Saxitoxin; Shellfish toxins (paralytic, diarrheic, neurotoxic or amnesic) as saxitoxin, akadaic acid, dinophysis toxins, pectenotoxins, yessotoxins, brevetoxins, and domoic acid; Shigatoxins; Shiga-like ribosome inactivating proteins; Snake toxins; Staphylococcal enterotoxins; T-2 toxin; and Tetrodotoxin.

Further examples of analytes include prion proteins such as Bovine spongiform encephalopathy agent.

Further examples of analytes include parasitic protozoa and worms, such as Acanthamoeba and other free-living amoebae; Anisakis sp. and other related worms Ascaris lumbricoides and Trichuris trichiura; Cryptosporidium parvum; Cyclospora cayetanensis, Diphyllobothrium spp.; Entamoeba histolytica; Eustrongylides sp.; Giardia lamblia; Nanophyetus spp.; Shistosoma spp.; Toxoplasma gondii; and Trichinella.

Further examples of analytes include fungi such as: Aspergillus spp.; Blastomyces dermatitidis; Candida; Coccidioides immitis; Coccidioides posadasii; Cryptococcus neoformans; Histoplasma capsulatum; Maize rust; Rice blast; Rice brown spot disease; Rye blast; Sporothrix schenckii; and wheat fungus.

Further examples of analytes include genetic elements, recombinant nucleic acids, and recombinant organisms, such as:

(1) nucleic acids (synthetic or naturally derived, contiguous or fragmented, in host chromosomes or in expression vectors) that can encode infectious and/or replication competent forms of any of the select agents;

(2) nucleic acids (synthetic or naturally derived) that encode the functional form(s) of any of the toxins listed if the nucleic acids:
(i) are in a vector or host chromosome;
(ii) can be expressed in vivo or in vitro; or
(iii) are in a vector or host chromosome and can be expressed in vivo or in vitro;

(3) nucleic acid-protein complexes that are locations of cellular regulatory events:
(i) viral nucleic acid-protein complexes that are precursors to viral replication;
(ii) RNA-protein complexes that modify RNA structure and regulate protein transcription events; or
(iii) Nucleic acid-protein complexes that are regulated by hormones or secondary cell signaling molecules; or

(4) viruses, bacteria, fungi, and toxins that have been genetically modified.

Further examples of analytes include immune response molecules to the above-mentioned analyte examples such as IgA, IgD, IgE, IgG, and IgM. The term “analog of the analyte,” as used herein, refers to a substance that competes with the analyte of interest for binding to a binding partner. An analog of the analyte may be a known amount of the analyte of interest itself that is added to compete for binding to a specific binding partner with analyte of interest present in a sample. Examples of analogs of the analyte include azidothymidine (AZT), an analog of a nucleotide that binds to HIV reverse transcriptase, puromycin, an analog of the terminal aminoacyl- adenosine part of aminoacyl-tRNA, and methotrexate, an analog of tetrahydrofolate. Other analogs may be derivatives of the analyte of interest.

The term “ECL moiety” refers to any compound that can be induced to repeatedly emit electromagnetic radiation by exposure to an electrochemical energy source. Representative ECL moieties are described in Electrogenerated Chemiluminescence, Bard, Editor, Marcel Dekker, (2004); Knight, A and Greenway, G. Analyst 119:879-890 1994; and in U.S. Pat. Nos. 5,221,605; 5,591,581; 5,858,676; and 6,808,939. Preparation of primers comprising ECL moieties is well known in the art, as described, for example, in U.S. Pat. No. 6,174,709.

ECL moieties can be transition metals. For example, the ECL moiety can comprise a metal-containing organic compound wherein the metal can be chosen, for example, from ruthenium, osmium, rhenium, iridium, rhodium, platinum, palladium, molybdenum, and technetium. For example, the metal can be ruthenium or osmium. For example, the ECL moiety can be a ruthenium chelate or an osmium chelate. For example, the ECL moiety can comprise bis(2,2′-bipyridyl)ruthenium(II) and tris(2,2′-bipyridyl)ruthenium(II). For example, the ECL moiety can be ruthenium (II) tris bipyridine ([Ru(bpy)₃]²⁺). The metal can also be chosen, for example, from rare earth metals, including but not limited to cerium, dysprosium, erbium, europium, gadolinium, holmium, lanthanum, lutetium, neodymium, praseodymium, promethium, terbium, thulium, and ytterbium. For example, the metal can be cerium, europium, terbium, or ytterbium.

Metal-containing ECL moieties can have the formula
M(P)ₘ(L1)ₙ(L2)ₒ(L3)ₚ(L⁴)_{q}(L5)ᵣ(L6)ₛ
wherein M is a metal; P is a polydentate ligand of M; L1, L2, L3, L4, L5 and L6 are ligands of M, each of which can be the same as, or different from, each other; m is an integer equal to or greater than 1; each of n, o, p, q, r and s is an integer equal to or greater than zero; and P, L1, L2, L3, L4, L5 and L6 are of such composition and number that the ECL moiety can be induced to emit electromagnetic radiation and the total number of bonds to M provided by the ligands of M equals the coordination number of M. For example, M can be ruthenium. Alternatively, M can be osmium.

Some examples of the ECL moiety can have one polydentate ligand of M. The ECL moiety can also have more than one polydentate ligand. In examples comprising more than one polydentate ligand of M, the polydentate ligands can be the same or different. Polydentate ligands can be aromatic or aliphatic ligands. Suitable aromatic polydentate ligands can be aromatic heterocyclic ligands and can be nitrogen- containing, such as, for example, bipyridyl, bipyrazyl, terpyridyl, 1,10-phenanthroline, and porphyrins.

Suitable polydentate ligands can be unsubstituted, or substituted by any of a large number of substituents known to the art. Suitable substituents include, but are not limited to, alkyl, substituted alkyl, aryl, substituted aryl, aralkyl, substituted aralkyl, carboxylate, carboxaldehyde, carboxamide, cyano, amino, hydroxy, imino, hydroxycarbonyl, aminocarbonyl, amidine, guanidinium, ureide, maleimide sulfur-containing groups, phosphorus-containing groups, and the carboxylate ester of N-hydroxysuccinimide.

In some embodiments, at least one of L1, L2, L3, L4, L5 and L6 can be a polydentate aromatic heterocyclic ligand. In various embodiments, at least one of these polydentate aromatic heterocyclic ligands can contain nitrogen. Suitable polydentate ligands can be, but are not limited to, bipyridyl, bipyrazyl, terpyridyl, 1,10-phenanthroline, a porphyrin, substituted bipyridyl, substituted bipyrazyl, substituted terpyridyl, substituted 1,10-phenanthroline or a substituted porphyrin. These substituted polydentate ligands can be substituted with an alkyl, substituted alkyl, aryl, substituted aryl, aralkyl, substituted aralkyl, carboxylate, carboxaldehyde, carboxamide, cyano, amino, hydroxy, imino, hydroxycarbonyl, aminocarbonyl, amidine, guanidinium, ureide, maleimide a sulfur-containing group, a phosphorus-containing group or the carboxylate ester of N-hydroxysuccinimide.

Some ECL moieties can contain two bidentate ligands, each of which can be bipyridyl, bipyrazyl, terpyridyl, 1,10-phenanthroline, substituted bipyridyl, substituted bipyrazyl, substituted terpyridyl or substituted 1,10-phenanthroline.

Some ECL moieties can contain three bidentate ligands, each of which can be bipyridyl, bipyrazyl, terpyridyl, 1,10-phenanthroline, substituted bipyridyl, substituted bipyrazyl, substituted terpyridyl or substituted 1,10-phenanthroline. For example, the ECL moiety can comprise ruthenium, two bidentate bipyridyl ligands, and one substituted bidentate bipyridyl ligand. For example, the ECL moiety can contain a tetradentate ligand such as a porphyrin or substituted porphyrin.

In some embodiments, the ECL moiety can have one or more monodentate ligands, a wide variety of which are known to the art. Suitable monodentate ligands can be, for example, carbon monoxide, cyanides, isocyanides, halides, and aliphatic, aromatic and heterocyclic phosphines, amines, stibines, and arsines.

In some embodiments, one or more of the ligands of M can be attached to additional chemical labels, such as, for example, radioactive isotopes, fluorescent components, or additional luminescent ruthenium- or osmium-containing centers.

For example, the ECL moiety can be tris(2,2′-bipyridyl)ruthenium(II) tetrakis(pentafluorophenyl)borate. For example, the ECL moiety can be bis[(4,4′-carbomethoxy)-2,2′-bipyridine] 2-[3-(4-methyl-2,2′-bipyridine-4-yl)propyl]-1,3-dioxolane ruthenium (II). For example, the ECL moiety can be bis(2,2′-bipyridine) [4-(butan-1-al)-4′-methyl-2,2′-bipyridine]ruthenium (II). For example, the ECL moiety can be bis(2,2′-bipyridine) [4-(4′-methyl-2,2′-bipyridine-4′-yl)-butyric acid]ruthenium (II). For example, the ECL moiety can be (2,2′-bipyridine)[cis-bis(1,2-diphenylphosphino)ethylene]{2-[3-(4-methyl-2,2′-bipyridine-4′-yl)propyl]-1,3-dioxolane}osmium (II). For example, the ECL moiety can be bis(2,2′-bipyridine) [4-(4′-methyl-2,2′-bipyridine)-butylamine]ruthenium (II). For example, the ECL moiety can be bis(2,2′-bipyridine) [1-bromo-4(4′-methyl-2,2′-bipyridine-4-yl)butane]ruthenium (II). For example, the ECL moiety can be bis(2,2′-bipyridine)maleimidohexanoic acid, 4-methyl-2,2′-bipyridine-4′-butylamide ruthenium (II).

In some embodiments, the ECL moiety does not comprise a metal. Such non-metal ECL moieties can be, but are not limited to, rubrene and 9,10-diphenylanthracene.

The term “ECL coreactant,” as used herein, pertains to a chemical compound that either by itself or via its electrochemical reduction oxidation product(s), plays a role in the ECL reaction sequence.

Often ECL coreactants can permit the use of simpler means for generating ECL (e.g., the use of only half of the double-step oxidation-reduction cycle) and/or improved ECL intensity. In some embodiments, coreactants can be chemical compounds which, upon electrochemical oxidation/reduction, yield, either directly or upon further reaction, strong oxidizing or reducing species in solution. A coreactant can be peroxodisulfate (i.e., S₂O₈²⁻, persulfate) that is irreversibly electro-reduced to form oxidizing SO₄.⁻ ions. The coreactant can also be oxalate (i.e., C₂O₄²⁻) that is irreversibly electro-oxidized to form reducing CO₂.⁻ ions. A class of coreactants that can act as reducing agents is amines or compounds containing amine groups, including, for example, tri-n-propylamine (i.e., N(CH₂CH₂CH₂)₃, TPA). In some embodiments, tertiary amines can be better coreactants than secondary amines. In some embodiments, secondary amines can be better coreactants than primary amines.

Coreactants include, but are not limited to, lincomycin; clindamycin-2-phosphate; erythromycin; 1-methylpyrrolidone; diphenidol; atropine; trazodone; hydroflumethiazide; hydrochlorothiazide; clindamycin; tetracycline; streptomycin; gentamicin; reserpine; trimethylamine; tri-n-butylphosphine; piperidine; N,N-dimethylaniline; pheniramine; bromopheniramine; chloropheniramine; diphenylhydramine; 2-dimethylaminopyridine; pyrilamine; 2-benzylaminopyridine; leucine; valine; glutamic acid; phenylalanine; alanine; arginine; histidine; cysteine; tryptophan; tyrosine; hydroxyproline; asparagine; methionine; threonine; serine; cyclothiazide; trichlormethiazide; 1,3-diaminopropane; piperazine, chlorothiazide; hydrazinothalazine; barbituric acid; persulfate; penicillin; 1 -piperidinyl ethanol; 1,4-diaminobutane; 1,5-diaminopentane; 1,6-diaminohexane; ethylenediamine; benzenesulfonamide; tetramethylsulfone; ethylamine; di-ethylamine; tri-ethylamine; tri-iso-propylamine; di-n-propylamine; di-iso-propylamine; di-n-butylamine; tri-n-butylamine; tri-iso-butylamine; bi-iso-butylamine; s-butylamine; t-butylamine; di-n-pentylamine; tri-n-pentylamine; n-hexylamine; hydrazine sulfate; glucose; n-methylacetamide; phosphonoacetic acid; and/or salts thereof.

Coreactants also include, but are not limited to, N-ethylmorpholine; sparteine; tri-n-butylamine; piperazine-1,4-bis(2-ethanesulfonic acid); triethanolamine; dihydronicotinamide adenine dinucleotide; 1,4-diazobicyclo(2.2.2)octane; ethylenediamine tetraacetic acid; oxalic acid; 1-ethylpiperidine; di-n-propylamine; N,N,N′,N′-Tetrapropyl-1,3-diaminopropane; DAB-AM-4, Polypropylenimine tetraamine Dendrimer; DAB-AM-8, Polypropylenimine octaamine Dendrimer; DAB-AM-16, Polypropylenimine hexadecaamine Dendrimer; DAB-AM-32, Polypropylenimine dotriacontaamine Dendrimer; DAB-AM-64, Polypropylenimine tetrahexacontaamine Dendrimer; 3-(N-Morpholino)propanesulfonic acid; 3-Morpholino-2-hydroxypropanesulfonic acid; Glycyl-glycine; 2-Morpholinoethanesulfonic acid; 2,2-Bis(hydroxymethyl)-2,2′,2″-nitrilotriethanol; N-(2-Acetamido)iminodiacetic acid; N,N-Bis(2-hydroxyethyl)taurine; N-(2-Hydroxyethyl)piperazine-N′-(2-ethanesulfonic acid); N,N-Bis(2-hydroxyethyl)-3-amino-2-hydroxypropanesulfonic acid; 4-(N-Morpholino)butanesulfonic acid; 4-(2-Hydroxyethyl)piperazine-1-(2-hydroxypropanesulfonic acid) Hydrate; Piperazine-1,4-bis(2-hydroxypropanesulfonic acid) dihydrate; 4-(2-Hydroxyethyl)piperazine-1-propanesulfonic acid; N,N-Bis(2-hydroxyethyl)glycine; N-(2-Hydroxyethyl)piperazine-N′-(4-butanesulfonic acid).; and/or salts thereof.

The term “labeled analog of the analyte,” as used herein, is defined analogously to the term “labeled binding partner”, wherein the binding partner is substituted with analog of the analyte.

The term “labeled molecule,” as used herein, refers to a molecule that comprises or is linked to a label.

As used herein, the term “support,” refers to any of the ways for immobilizing binding partners that are known in the art, such as separation filters, beads, particles, electrodes, or even the walls or surfaces of a container. The support may comprise any material on which the binding partner is conventionally immobilized, such as nitrocellulose, polystyrene, polypropylene, polyvinyl chloride, EVA, glass, carbon, glassy carbon, carbon black, carbon nanotubes or fibrils, platinum, palladium, gold, silver, silver chloride, iridium, or rhodium. In one embodiment, the support is a bead, such as a polystyrene bead or a magnetizable bead. The bead is also inanimate.

As used herein, the term “magnetizable bead” encompasses magnetic, paramagnetic, and superparamagnetic beads.

As used herein, the term “magnetizable capture bead” refers to a magnetizable bead used as a support.

As used herein, the term “blood separation filter” refers to a separation filters used to separate red blood cells from blood so as to generate serum or plasma. A blood separation filter can also be considered as any of the following: a separation filter, a filter membrane, a membrane filter and a blood plasma filter membrane.

As used herein, the term “fluidic architecture” refers to collection of fluidic passageways, distribution channels, pumps, valves, vents, separation filters, and the like used to control the flow of fluids in a cartridge.

As used herein, the term “fluidically connectable” refers to two or more points in a fluidic architecture that can be connected (e.g., they are directly connected or can be connected by opening a valve or passing though a separation filter or pump).

As used herein, the terms “capillary stop” and “capillary stop valves” refer to a type of valve. When a capillary stop valve is gas filled, gas can flow through the valve unimpeded. An exemplary gas may be air. When a liquid approaches and contacts a gas-filled capillary stop valve from at least one direction, liquid flow stops because of lower capillarity. Some capillary stop valves can be opened by replacing the gas in the gas-filled side with liquid. Capillary stop valves can be opened by increasing the liquid pressure to overcome the lower capillarity. Capillary stop valves sometimes do not stop liquid flow, rather they greatly reduce it because some liquid can creep along the walls of the valve if sufficiently hydrophilic. In these cases of creeping flows, an element is considered to be a capillary stop valve if it substantively stops the liquid flow over the operative time period required by the design. A “vent,” as used herein, is a capillary stop valve wherein the valve cannot be operatively opened during use because of the excessive pressures required to do so.

As used herein, an “assay cartridge” is a cartridge that is useful for measuring the amount of or determining the presence of at least one analyte in a sample. An assay cartridge can utilize binding partners for a binding assay or reagents for other biochemical assays.

The term “binding reagents,” as used herein, comprise a binding partner for an analyte of interest. Binding reagents optionally comprise a labeled binding partner for an analyte of interest and/or a labeled analog of the analyte. Binding reagents optionally comprise a support. Binding reagents optionally comprise a magnetizable capture bead. Binding reagents optionally comprise buffers, salts, cryoprotectants, surfactants, blocking agents, and other materials as well known in the art.

The term “sample,” as used herein, comprises liquids that may contain the analyte. The term “liquid,” as used herein comprises—in addition to the more traditional definition of liquid—colloids, suspensions, slurries, and dispersions of particles in a liquid wherein the particles have a sedimentation rate due to earth's gravity of less than about 1 mm/s. The sample can be drawn from any source upon which analysis is desired. For example, the sample can arise from body or other biological fluid, such as blood, plasma, serum, milk, semen, amniotic fluid, cerebral spinal fluid, sputum, bronchoalveolar lavage, urine, tears, saliva, or stool. Alternatively,- the sample can be a water sample obtained from a body of water, such as lake or river. The sample can also be prepared by dissolving or suspending a sample in a liquid, such as water or an aqueous buffer. The sample source can be a surface swab. For example, a surface can be swabbed, and the swab washed by a liquid, thereby transferring an analyte from the surface into the liquid. The sample source can be air. For example, the air can be filtered, and the filter washed by a liquid, thereby transferring an analyte from the air into the liquid. Sample equally refers to the liquid that may be placed in an assay cartridge, and a filtrate generated in the cartridge by a separation filter that does not remove all of the analyte. For example, sample can refer to a whole blood specimen presented to the assay cartridge and cartridge-generated plasma when the analyte of interest, if present in the whole blood is also present in the plasma.

The term “sample matrix,” as used herein, refers to everything in the sample with the exception of the analyte. The term “environmental matrix”, as used herein, refers to components of the sample matrix derived from the environment from which the sample is collected.

The term “incubation zone,” as used herein, refers to a volume of space defined by the physical structure of an assay cartridge inside which a binding reagent can contact a sample.

The term “measurement zone,” as used herein, refers to a volume of space in which a label is detectable.

### II. INSTRUMENT AND ASSAY CARTRIDGE DESCRIPTION

As embodied herein, a portable instrument for detecting the presence of an analyte of interest in a sample is provided by performing one or more diagnostic tests. In addition to simply detecting the presence of an analyte, the instrument can also quantify the amount of analyte present. The portable instrument can be used as a field device for on-site testing of a sample, eliminating the need for the sample to be transported from the site at which it was obtained to a laboratory housing a conventional assay instrument. In certain embodiments, the instrument can notify a user of the results of the assay. Further, as will be detailed below, the instrument can be adapted to transmit data relating to the results of an assay to other devices, such as a printer, computer, personal digital assistant (PDA), cell phone, pager, or wireless device.

Consistent with the principles of the embodiments disclosed herein, the instrument can comprise a housing and a removable cartridge. The cartridge can be adapted to receive a sample. The housing can comprise a diagnostic apparatus operative to perform a diagnostic test on a sample to determine and/or quantify the presence of an analyte of interest within the sample. The cartridge can also comprise a sample collection system operative to obtain a sample and transfer it into the cartridge. The cartridge can also comprise a sample storage system operative to store the sample until a diagnostic test is performed.

A. Housing

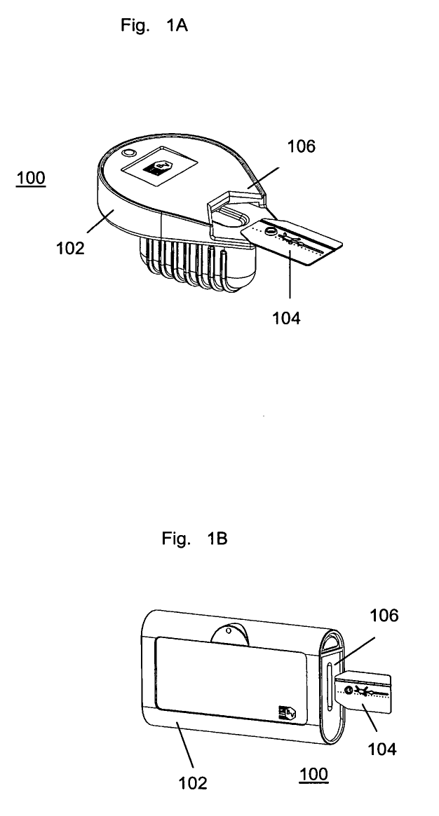

FIG. 1A illustrates an instrument 100 comprising an exemplary housing 102. FIG. 1B illustrates another version of housing 102. Housing 102 can be adapted to receive a cartridge containing a sample to be tested. Housing 102 can be sized such that it can be carried in a pocket, worn around the neck, or clipped to a belt, waistband, pocket, or sleeve, such that it can-be easily transported by a practitioner working in the field, such as emergency responders or nurses working a large area in a hospital. In some embodiments, housing 102 can be 7″×10″×3.5″ or less in size or 4″×5″×1″ or less in size. In certain embodiments, housing 102 can be 5″×6″×1.5″ in size or 4.1″×2.4″×0.57″ in size.

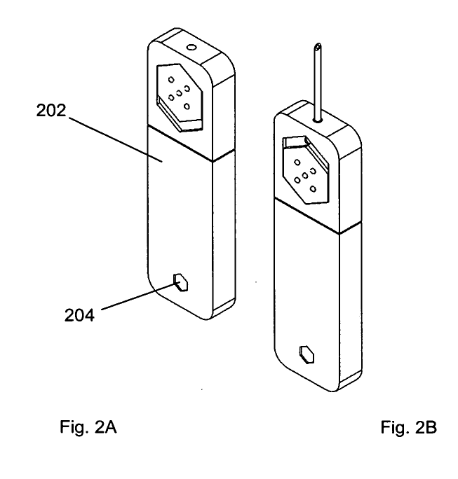

As illustrated in FIGS. 1A and 1B, housing 102 can comprise slot 106 to guide cartridge 104 into instrument 100. FIG. 2A illustrates an exemplary cartridge 202, and FIG. 9 shows cartridge 202 plugged into housing 102. Housing 102 can be configured such that cartridge 202 can be plugged into a receptacle (not pictured) adapted to retain cartridge 202 until a predetermined force is applied in the direction opposite insertion, preventing the user from inadvertently allowing cartridge 202 to slide out of housing 102. Alternatively, cartridge 202 can releasably lock into housing 102, requiring the user to engage a removal mechanism, such as a tab or a button, located on either cartridge 202 or housing 102, to release cartridge 202. In some embodiments, cartridge 202 can be 5″×2″×1.0″ or less than in size or 4″×1.5″×0.5″ or less than in size. In some embodiments, cartridge 202 can be 4″×1.5″×1.5″ in size or 3.3″×0.98″×0.33″ in size.

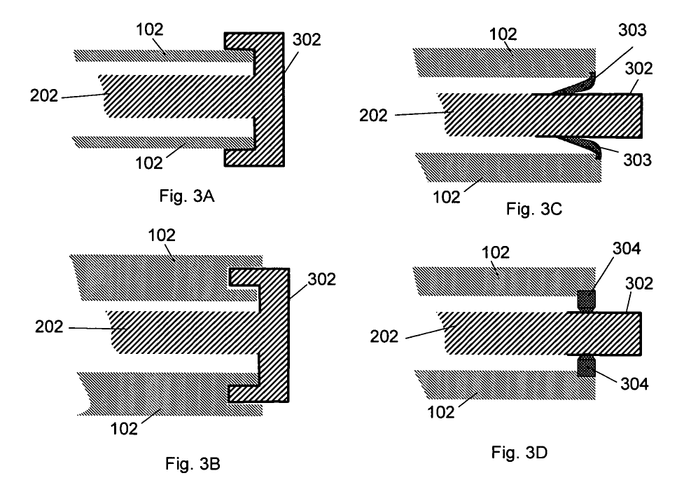

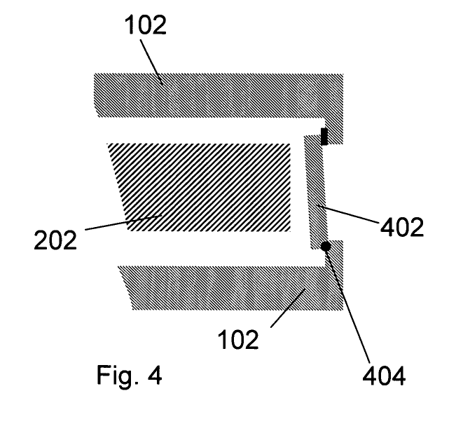

FIGS. 3A, 3B, 3C, and 3D show four exemplary structures in which cartridge 202 can plug into housing 102. As illustrated, cartridge 202 can be configured such that it does not move relative to housing 102 after insertion. FIG. 4 depicts another exemplary version of cartridge 202. Cartridge 202 can be adapted to move relative to housing 102. Depending on the testing techniques employed by instrument 100, it can be desirable to prevent ambient light from entering the interior of housing 102 after insertion of cartridge 202. In certain embodiments, instrument 100, including cartridge 202, can possess sufficient optical density such that exposure to 5,000-lux of light on the exterior of instrument 100 will not cause any light detection mechanism(s) contained in instrument 100 to register a measurable response.

Due to the potential presence of a light detector inside instrument 100, cartridge 202 can be adapted to prevent light from entering housing 102 after cartridge 202 is inserted therein (for example, FIGS. 3A, 3B, 3C, and 3D). In these embodiments, opaque surface 302 on cartridge 202 completes the light-tight enclosure upon insertion into instrument 100. In some embodiments, opaque surface can be compliant to (1) fill- in surface imperfections in the sealing interface between instrument 100 and cartridge 202 and/or (2) enable cartridge 202 to be more easily inserted in instrument 100. In some embodiments, sealing flaps 303 can be part of instrument 100. Alternatively, sealing flaps 303 can be part of cartridge 202. In some embodiments, sealing bumps 304 can be part of instrument 100. Alternatively, sealing bumps 304 can be part of cartridge 202.

Alternatively, housing 102 can be provided with a flap 402 adapted to prevent light from entering housing 102 after cartridge 400 is inserted (FIG. 4). Flap 402 can be in communication with a mechanism, such as a spring hinge 404, to bias flap 402 to a closed position, such that it automatically closes after cartridge 202 is inserted into housing 102.

Consistent with the principles disclosed herein, housing 102 can contain an apparatus operative to perform testing to detect and/or quantify one or more analytes of interest in accordance with one or more techniques known in the art. In some embodiments the apparatus can be operative-to detect or quantify the presence of an analyte of interest based on binding reactions occurring in cartridge 202 after the sample is inserted. As known in the art, the presence of an analyte of interest in a sample can often be detected or quantified by analyzing the presence or absence of an observable labeled molecule such as a labeled binding partner or a labeled analog of the analyte. In various embodiments, the apparatus can analyze a sample for the presence or quantity of an analyte of interest based on the presence or quantity of labels that can be induced to luminesce. Labels can be excited through a variety of techniques, including but not limited to photochemical (i.e. fluorescence or phosphorescence), chemical or electrochemical means (e.g. chemiluminescence or electrochemiluminescence). The apparatus can also be adapted to conduct absorption (i.e. enzyme-linked immunosorbent assay) or resistance-based assays.

B. Cartridge

Cartridge 202 can be adapted to receive a sample to be tested for one or more analytes of interest. Cartridge 202 can be adapted to store a sample until the user desires to conduct one or more tests. Cartridges can be packaged to provide up to 18 months of stability at 90% relative humidity and 30° C. In certain embodiments, cartridge 202 can be evacuated. If so, it can be designed so that the pressure inside cartridge 202 will not exceed 3 psi for at least six months.

Cartridge 202 can be equipped to enable instrument 100 to perform a group of tests, which can be related or can be unrelated. For example, test panel cartridges can be designed to perform a cardiac panel quantifying troponin t, d-dimer, C-reactive protein (CRP), or homocysteine. In certain embodiments, test panel cartridges can be designed to perform a liver panel or a fertility panel. Cartridges 202 can be color-coded based on the type of test(s) -for which they are adapted in order to assist the user in selecting the correct cartridge for the desired test. Other exemplary panels include immune status (e.g., testing for a plurality of immunological factors for specific diseases), biological warfare panels (e.g., toxins, bacterial, and/or viruses), allergy panels, active disease panels (e.g., to determine the illness of a patient), hormone panels, cancer panels, and other panels for in vitro diagnostics.

Cartridge 202 can be disposable so that it can be discarded, for example, in accordance with applicable biohazardous material safety standards after testing is performed. Cartridge 202 can also be designed such that no portion of housing 102 or the apparatus need contact the sample, avoiding the need for instrument 100 to be sterilized after each use. Cartridge 202 can comprise a latching device or tamper-proof seal or indicator to indicate to the user that cartridge 202 has not been previously used to store a sample. Even if a non-disposable version of cartridge 202 is utilized, a tamper-proof feature can be used to show that cartridge 202 has not been used since last sterilized. A tamper-proof seal or indicator can also be used to indicate to the user that cartridge 202 has not been tampered with since the loading of a sample. Such a feature would be useful, for example, when a significant period of time passes between the collection of a sample and the performance of a test or when different people collect the sample and perform testing.

Cartridge 202 can also be operative to detect and/or record events or environmental conditions relating to sample collection, including but not limited to the presence of a sample within cartridge 202, the environment temperature, humidity, exposure--of the sample to oxygen, and the number of test cartridge-interfaces. -

As illustrated in FIG. 2, cartridge 202 can comprise one or more interfaces 204 that can align with instrument 100 so that an analysis of the sample can be performed. Interface 204 can be provided in various manners consistent with the principles known in the art. For example, depending on the technique used by the apparatus, interface 204 can comprise a gas permeable, liquid permeable membrane, solid membrane, or a mesh area. Interface 204 can be located at any location on cartridge 202 allowing the apparatus the access to the sample necessary to perform a test on the sample.

C. Incubation

In some embodiments, instrument 100 may further comprise a heating mechanism (e.g., 1304). The heating mechanism can maintain the cartridge at a desired temperature, e.g., 37° C. plus or minus 2° C. In some embodiments, the temperature can optionally be lowered when instrument 100 is idle. Instrument 100 can be operative to trigger the heating mechanism when it detects the presence of a sample in cartridge 202. The heating mechanism can comprise a timer to limit operation of the heating mechanism to the appropriate amount of time needed to perform the particular assay or assays desired. Alternatively, instrument 100 can be operative to track the heating process and turn the heating mechanism off after the appropriate amount of time. Instrument 100 can also be adapted to control the temperature generated by the heating mechanism. In some embodiments, instrument 100 lacks a heating mechanism operative to maintain the sample cartridge at a desired temperature. In some embodiments the heating mechanism may be in the cartridge 202.

In some embodiments, the sample can interact with binding reagents to determine the presence of one or more analytes of interest in the sample. The term “incubation time”, as used herein, refers to the time that the sample interacts with the binding reagents before measuring the result. In some embodiments, the time to result is reduced by using an incubation time that is shorter than the time required for the binding reactions to reach equilibrium. In some embodiments, the incubation time can vary depending on the type of sample and the test performed. Instrument 100 can comprise a timing mechanism, such as an electronic or optic timing device, operative to time the incubation time.

The start of incubation time can be triggered in a number of ways consistent with the principles disclosed herein. For example, if an empty cartridge 202 is inserted into housing 102, instrument 100 can be operative to detect the insertion of a sample into cartridge 202 and start the incubation time. In some embodiments, cartridge 202 may include onboard electronics operative to measure the time duration started by a conductivity, optical,or other change within cartridge 202 created when a sample is inserted. In certain embodiments, cartridge 202 may comprise two compartments, for example, a storage zone 2004 and incubation/measurement zone 2007. The storage zone may be adapted to contain the sample until the user begins the testing process by allowing the sample to move to the incubation/measurement zone wherein the binding reagents are located. Flow from the storage zone to the incubation/measurement zone can be controlled by the instrument via a sample flow control apparatus, as described infra. Alternatively, the user may open a valve between the two zones by engaging a mechanical or electrical mechanism. The start of the incubation time can be triggered once the sample enters the second compartment. In some embodiments, the incubation time can be controlled by wicking of liquids of a known viscosity and surface energy through a capillary region, as disclosed by U.S. Pat. No. 6,905,882 and its related patents.

In some embodiments, the incubation time is not critical to control. In some embodiments, a minimum incubation time can be timed by starting a timer after the cartridge and sample are inserted into instrument 100. In some embodiments, controls and/or calibrators can be read on the same cartridge to reduce variations caused by incubation timing variations.

D. Power Source

As discussed below, instrument 100 can be powered by one or more local energy storage devices, such as lithium-ion, nickel-metal hydride, nickel-cadmium, lead acid, carbon zinc, alkaline, or zinc-air batteries. The local energy storage device can dissipate heat as part of its natural operation. The heating mechanism can utilize this heat in maintaining a sample at a desired temperature.

E. Sample Preparation

Cartridge 202 can also be operative to expose a sample to one or more reagents to prepare a sample for testing. Cartridge 202 can also be operative to facilitate transfer of the sample, and any necessary reagents or calibrators, to a reaction or measurement surface or area. For example, cartridge 202 can be operative to expose a sample to magnetizable capture beads that can be drawn to a measurement zone by a magnet located in housing 102. Depending on the assay technique employed by instrument 100 and the particular analyte of interest, cartridge 202 can comprise a variety of reagents, antigens or antibodies known in the art to assist the instrument in detecting and/or quantifying the presence of an analyte of interest in the sample.

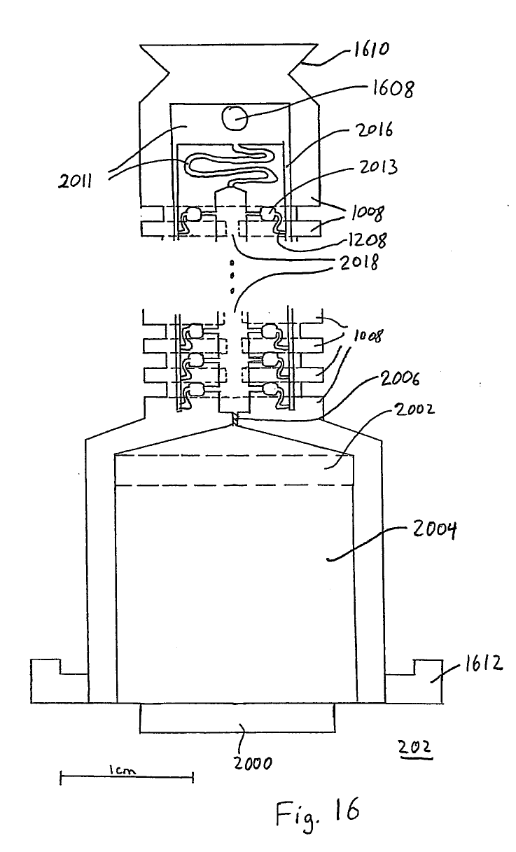

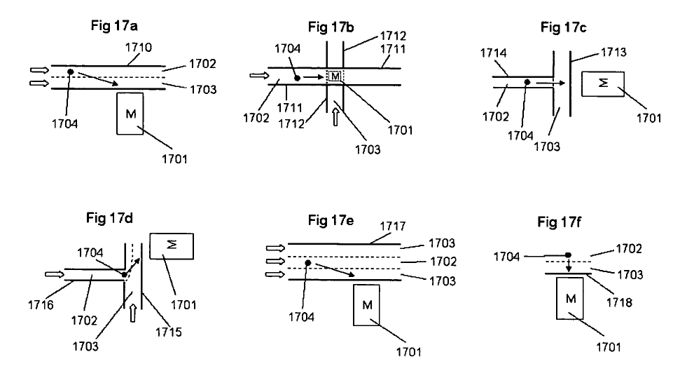

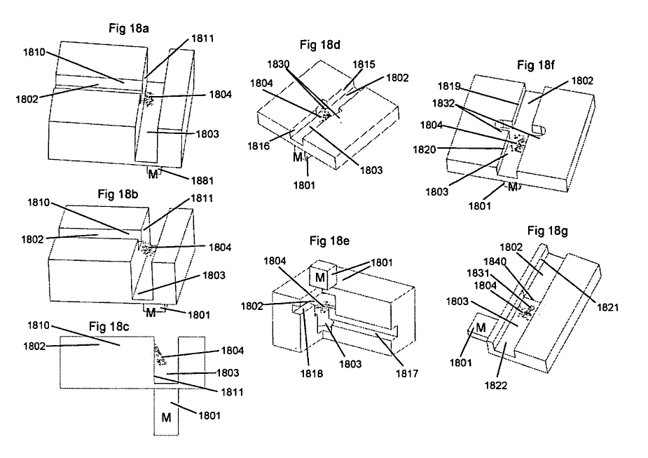

Cartridge 202 can be operative to separate a sample into a serum or plasma fraction using techniques known in the art, including but not limited to reagents (e.g. clotting factors), gel, a separation filter, a blood separation filter, a lateral flow device or centrifugal force. For example, optional filter 2002 illustrated in FIGS. 16, 20, and 21 can be a blood separation filter operative to remove particulates (e.g., red blood cells) before the sample reaches the incubation zones 2013. Cartridge 202 can also be operative to separate an analyte of interest from the sample using any number of techniques. For example, cartridge 202 can utilize techniques known in the art, including but not limited to magnetizable capture beads, a separation filter, a lateral flow device, magnetic particle separation, or using binding reagents linked to a surface on the cartridge (e.g., in incubation zone 2013).

F. Incubation Zone Size and Number

In some embodiments, in order to allow multiple tests to be performed on a single sample, cartridge 202 can comprise an incubation zone operatively connected to a plurality of distinct measurement zones, wherein each measurement zone is operative connected to one incubation zone. Differing labels can be used to distinguish among the tests. For example, fluorescent labels or ECL labels that emit at different wavelengths can be used. In further embodiments, binding reagents for each test can interact until they are separated into the distinct measurement zones.

In some embodiments, in order to allow multiple tests to be performed on a single sample, cartridge 202 can comprise a plurality of incubation zones having a one-to-one relation with distinct measurement zones. Each of the incubation zones can be adapted to receive a-portion of a sample. In addition, individual incubation zones can be adapted so that they cannot communicate convectively or via diffusion over the relevant time period (e.g., 20 minutes, 10 minutes, 5 minutes, or 3 minutes) with one another, preventing interferences (optical or assay-related) from contaminating the results of a diagnostic test performed on the contents of a incubation zone. Each incubation zone of a cartridge can be adapted to prepare a portion of a sample for a different test. As discussed herein, the structure of cartridge 202 can vary depending on the number of incubation zones it comprises, as well as the technique used to detect and/or quantify the presence of an analyte in a sample.

The size and number of incubation zones in part determine the minimum volume of sample required. Thus, in some embodiments, minimizing the volume of the incubation zones can be useful. On the other hand, smaller incubation zones reduces the number of analytes of interest present for a given concentration, thus leading to a reduction in the number of binding events associated with a particular analyte of interest. As the number of binding events is reduced, errors from Poisson counting statistics (counting noise) and detector noise may become limiting factors in the lowest detectable limit (LDL) of analyte concentration. Other noise sources that can be important are background noise, non-specific binding (NSB) noise, and sample metering noise.

1. Noise

Counting noise is well characterized by a Poisson process, one feature of which is that the variance of the process equals the mean (See, e.g., Fundamentals of Applied Probability Theory, Alvin Drake, McGraw-Hill, 1967). Expressed as a percent precision, counting noise limits the precision of measuring binding events to 100% divided by the square root of the expected number of binding events. The expected number of binding events is not necessarily equivalent to the number of analytes in the incubation zone. The binding events can be reduced by aspects such as not waiting for reaction equilibrium and having a finite affinity constant Kₐ. Under reasonable assumptions (e.g., a 5 minute incubation time) the ratio of analyte number to binding events may be 2.5 (i.e., 40% of the analyte binds). For example, if the reaction volume contains 250 analyte molecules, 100 might bind on average giving a 10% counting noise. Depending on the lower reference range for a particular analyte of interest and the desired counting noise at that lower reference range, one can compute the smallest reaction volume possible. For example, TSH has a lower reference range of 5 μUl/mL, or 1.75×10⁹ molecules/mL. With a desired counting precision ≦1 %, the reaction volume must be ≧14 nL assuming 40% of the analyte binds. Because, e.g., analytes vary in their reference ranges and binding partners for those analytes vary in their binding rates and equilibrium constants, cartridge 202 can have multiple sizes of reaction volumes.

Detector noise can also limit the size of the reaction volume by placing a limit on the smallest detectable signal. Selection of the photodetector (e.g., photodiode, avalanche photodiode, CCD, CMOS detectors, and photomultiplier tubes) can help make detector noise non-limiting. Multiple labels can be used on the binding partners to increase the signal generated per binding event. For example, U.S. Pat. No. 6,808,939 apparently discloses ECL labels wherein more than 20 can be placed on a binding partner, U.S. Patent Application Publication No. 2006/0078912 apparently discloses containers of ECL labels comprising more than 10⁹ labels that can be linked to a binding partner, and U.S. Pat. No. 5,326,692 apparently discloses fluorescently labeled microparticles that incorporate multiple labels to increase both the signal generated and its Stoke's shift (See, for example, TransFluoSpheres® (Molecular Probes; Eugene, Oreg., USA)). In some embodiments, each binding event can generate 10¹-10⁵ photons per second for two seconds. The detection mechanism of instrument 100 can possess a light collection efficiency of 10⁻²-10⁻¹. The electronic noise floor can be 10⁵ photons per second, using for example, an S2386-18K or an S1 227-3b33BR photodiode (Hamamatsu; Hamamatsu City, Japan), a transimpedance amplifier based on, for example, a low bias current operational amplifier such as OPAL129 (Texas Instruments; Dallas, Tex., USA) with a large resistance (1-10 GΩ) feedback resistor and a filtering capacitor (5-200 pF) and a low-noise A/D converter such as the 24 bit ADS1210 (Texas Instruments; Dallas, Tex., USA). Accordingly, the detection limit caused by detector noise is estimated to be 10¹-10⁶ binding events, depending for example, on the achieved collection efficiency and the label's performance as well as the detector's noise.

2. Incubation Zone Volume

In some embodiments, the volume of each incubation zone ranges from 1 nL to 1 mL; from 10 nL to 100 μL; from 100 nL to 10 μL; from 300 nL to 3 μL; or 1 nL or less. Exemplary incubation zone volumes include 1 nL, 3 nL, 10 nL, 30 nL, 100 nL, 300 nL, 500 nL, 800 nL, 1 μL, 2 μL, 3 μL, 5 μL, 10 μL, 30 μL, and 100 μL. In some embodiments, all the incubation zones have the same volume. In other embodiments, the incubation zones can have differing volumes.

In some embodiments, the sum of the volumes of all the incubation zones ranges from 1 nL to 5 mL; from 10 nL to 1 mL; from 100 nL to 500 μL; from 1 μL and to 100 μL; from 1 μL to 20 μL; or 1 nL or less. Exemplary sums of volumes of all the incubation zones include 1 nL, 3 nL, 10 nL, 30 nL, 100 nL, 300 nL, 500 nL, 1 μL, 2 μL, 3 μL, 4 μL, 5 μL, 6 μL, 7 μL, 8 μL, 9 μL, 10 μL, 15 μL, 20 μL, 30 μL, 50 μL, 100 μL, 200 μL, 500 μL, 1 mL, 2 mL, and 5 mL.

In some embodiments, the number of incubation zones ranges from 1 to 100; from 1 to 50; or from 8 to 50. In further embodiments, the number of incubation zones is greater than or equal to 1, 2, 3, 9, or 25.

In some embodiments, only one analyte may be assayed in each incubation zone, and the number of analytes assayed is 1, 2, 3, 9, or 25 or more, respectively. In some embodiments, 2 calibrators or controls are measured for each analyte; therefore, when the number of analytes assayed is 1, 2, 3, 9, or 25 or more, respectively, the number of incubation zones is 3, 6, 9, 27, or 75 or more, respectively. In other embodiments, only 1 calibrator or control is needed for each analyte; therefore, when the number of analytes assayed is 1, 2, 3, 9, or 25 or more, respectively, the number of incubation zones is 2, 4, 6,18, or 50 or more, respectively. In other embodiments, calibrator or controls can be independent of the analyte. For example, when 2 such calibrator or controls are needed on the assay cartridge and the number of analytes assayed is 1, 2, 3, 9, or 25 or more, respectively, the number of incubation zones is 3, 4, 5,11, or 27 or more, respectively. Other relations between the number of controls or calibrators and the number of analytes are possible.

G. Supports and Initial Bead Distribution

Cartridge 202 can use binding assays to detect an analyte of interest from the sample wherein a binding partner is attached to a support. The selection of the support affects binding kinetics due to mass-transport limitations. For example, The Immunoassay Handbook (3^{rd} edition, David Wild editor. Elsevier, 2005) states that in typical microarray experiments wherein (a) antibodies are coated on a continuous surface on a boundary of the sample and (b) there is no active mixing, only a few percent of the steady state signal is reached after 1 to 2 hours of incubation. In some embodiments, having a few percent or less of the available antigen to participate in a binding reaction is sufficient while in other embodiments, having a larger fraction of the available antigen to bind is beneficial. Using magnetizable capture beads can advantageously provide reduced incubation times, increased sensitivity, or decreased complexity by enabling both the analyte and the binding partners to diffuse.

Smaller magnetizable capture beads can diffuse more easily than large beads and for the same density, are less affected by gravity. Smaller beads typically contain less magnetic material and therefore have less magnetic force in the presence of a external magnetic field. Consequently, there can be a balance in selecting a bead size that enables improved diffusion while maintaining enough magnetic material to be controllable by a magnet. In some embodiments, cartridge 202 comprises magnetizable capture beads whose diameters range from 10 μm to 10 nm; from 10 μm to 80 nm; from 3 μm to 1 μm; from 1 μm to 100 nm; or from 0.5 μm to 150 nm.

The distance a bead, a binding partner, or an analyte may diffuse during the incubation period may be small compared to the dimensions of an incubation zone. Consequently, beads dried to a surface of the incubation zone may not interact with the entire sample in the incubation zone. In some embodiments, the initial bead distribution is part of a dry composition that occupies at least 10% of the incubation zone, at least 20% of the incubation zone, at least 33% of the incubation zone, at least 50% of the incubation zone, at least 75% of the incubation zone, or at least 90% of the incubation zone. Upon rehydration by the sample, this initial bead distribution will provide shorter diffusion lengths than the alternative of drying the beads onto a surface. By having the beads start with an initial distribution that spans a percentage of the incubation zone, the beads have to diffuse shorter distances to have some beads reach all parts of the incubation volume.

One method to achieve this distributed initial distribution is to at least partially fill the incubation zone with a mixture comprising the beads, freeze the mixture, and lyophilize the mixture to form a cake. The mixture prior to dispensing into the incubation zone can be made uniform, by example, using a vortexer, a rotary mixer, or similar device. Steps to reduce the amount of evaporation of the mixture before freezing increase the volume that the lyophilized cake occupies. These steps can be, for example, to have the incubation zone below freezing point so that the mixture freezes on contact or seconds thereafter. Alternatively, these steps can be, for example, to keep the temperature of the incubation zone no more than 10° C., 5° C., 3° C., or 2° C., respectively, above the dew point until the mixture can be frozen.

In certain embodiments, the mixture comprising the magnetizable capture beads can further comprise a lyophilization buffer. Lyophilization buffers are well known in the art and may contain phosphate buffer and, optionally, one or more cryoprotectants. The mixtures comprising the magnetizable capture beads may further comprise a compound such as trehalose, dextran, or sucrose.

In certain embodiments, the mixture comprising the magnetizable capture beads can comprise a binding reagent for an analyte of interest and a labeled molecule comprising a label. For example, the labeled molecule can be a labeled binding partner or a labeled analog of the analyte. In other embodiments, the dry composition occupying at least 10% of the incubation zone does not contain a binding reagent for the analyte of interest or a labeled molecule; these can be significantly smaller than the magnetizable capture beads and therefore better able to diffuse.

In certain embodiments, the magnetizable capture beads or other supports can be treated to block or reduce the nonspecific binding of the labeled molecule, analyte, or analog of the analyte to the support. Any conventional blocking agents can be used. Suitable blocking agents are described, for example, in U.S. Pat. Nos. 5,807,752; 5,202,267; 5,399,500; 5,102,788; 4,931,385; 5,017,559; 4,818,686; 4,622,293; and 4,468,469; CA 1,340,320; WO 97/05485; EP-A1-566,205; EP-A2-444,649; and EP-A1-165,669. Exemplary blocking agents include serum and serum albumins, such as animal serum (e.g., goat serum), bovine serum albumin, gelatin, biotin, and milk proteins (“blotto”). The support can be blocked by absorption of the blocking agent either prior to or after immobilization of the capture binding partner in the case of sandwich binding assays or of the binding partner in the case of competitive binding assays. In some embodiments, the support can be blocked by absorption of the blocking agent after immobilization of the binding partner. The exact conditions for blocking the support, including the exact amount of blocking agent used, may depend on the identities of the blocking agent and support.

H. Sample Collection System

Instrument 100 can also incorporate a sample collection system. The sample collection system can comprise a device for obtaining a sample and an interface for transferring the sample to cartridge 202 or a sample storage container. The sample collection system can be removably or permanently attached to cartridge 202 or to a sample storage container. The sample collection system can be operative to obtain a sample from an external sample storage container, directly from a patient, sample donor, or object, or from a port installed in a patient or sample donor.

The structure of the sample collection system can vary depending on the type of sample to be obtained. For example, the sample collection system can comprise a needle or a butterfly needle operative to withdraw a blood sample from a patient. For a procedure requiring a tissue biopsy, the sample collection system can comprise a scalpel. For a procedure requiring a sample of saliva or from a mucus membrane, the collection system can comprise a swab. Alternatively, the sample collection system can comprise an absorbance pad or surface containing assay beads. In this embodiment, after absorption of the sample into the pad, the sample can travel via a lateral flow device, microfluidic channels or bead transport (i.e. magnets, dissolved beads or suspended beads) into the cartridge or a sample storage system. It is recognized that the sample collection systems described herein are exemplary in nature, and that the sample collection system can comprise a wide variety of mechanisms to obtain a sample and introduce it into cartridge 202 for testing consistent with the principles of the disclosed herein.

Like cartridge 202, the sample collection system can be disposable. The sample collection system can comprise a tamper-proof seal or indicator to indicate to the user that the sample collection system has not previously been used (for a disposable system) or that it has not been used since its last sterilization (for a non-disposable system).

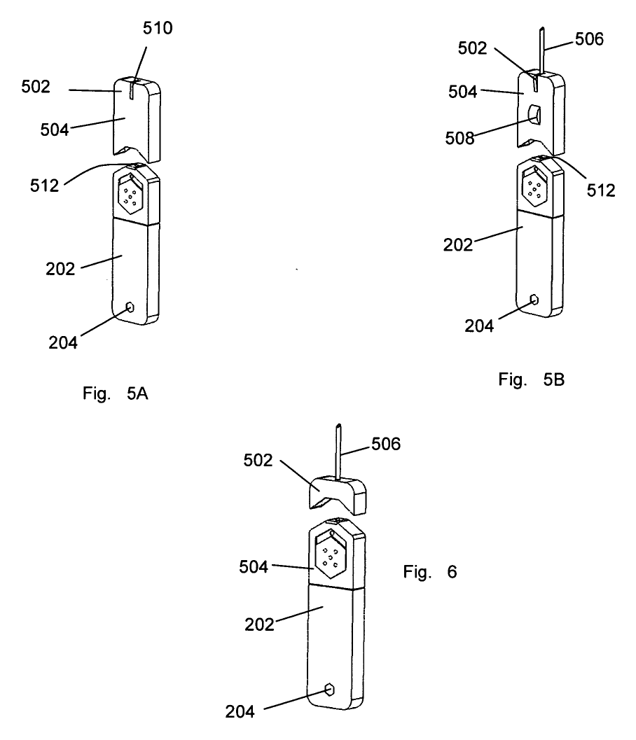

FIGS. 5A and 5B illustrate an exemplary sample collection system 502 comprising a needle 506 adapted to pierce a patient's skin in order to obtain a sample. Sample collection system 502 can be attached to a sample storage system 504 in communication with cartridge 202. As demonstrated in FIGS. 5A and 5B, needle 506 can be retractable. As pictured in FIG. 5B, sample collection system 502 can comprise a dial 508 operative to eject and retract needle 506. Dial 508 is merely exemplary, and various trigger mechanisms known in the art can be provided to eject and retract the needle, including but not limited to a button, slide, rocker, lever, twist knob, or switch. Needle 506 can also be ejected and retracted using mechanical advantage through a linkage, gear train, spring, pressure gradient or other techniques known in the art allowing the displacement of the trigger mechanism required for actuation to be smaller than or equal to the displacement of needle 506 in ejection and retraction. Depending on the intended collection method, needle 506 can be spring-loaded such that it is ejected with a predetermined puncturing force.

Sample collection system 502 can include a door 510 over needle 506 as added protection against accidental sticks when needle 506 is in the retracted position. Door 510 can be spring-hinged such that door 510 can be forced open when needle 506 is ejected and can automatically close when needle 506 retracts. In some embodiments, needle 506 can be adapted to swing out of the top or side of sample collection system 502, rather than ejecting out of the end of it. Sample collection system 502 can also be provided with an elastomer or absorbent material on or near door 510 to absorb any extra sample remaining on needle 506 to prevent it from dripping off the instrument. As an alternative to door 510, sample collection system 502 can comprise a protective snap-off, twist-off or break-off cover or a septum that can be punctured by needle 506 (not pictured). The cover can be adapted to be replaced after use in order to alleviate the sharps hazard encountered in further handling.

Instrument 100 can comprise one or more absorbent pads, gauze, or chambers that are presoaked or filled with a sterilizer fluid or gel, such as 70% isopropyl alcohol, ethyl alcohol or silver particles. The fluid or gel can be used to clean the sample collection area before, during and/or after sample collection. The fluid or gel can also contain an antibiotic and/or antifungal ointment to reduce bleeding and the chance of infection at the location of the needle stick or lancing operation. If a fluid chamber is provided, it can comprise a trigger button that can be engaged to squirt or otherwise deposit the fluid onto the sample collection site. Sample collection system 502 can also comprise a heating system (not pictured) operative to heat the sample location such that fluid sample flow is increased without altering the sample. In particular, the heating system can be desirable in taking blood samples from a patient, as it can reduce the pain commonly associated with the sampling process. The heat system can employ various techniques operative to heat a sample collection location consistent with the principles disclosed herein, including but not limited to convection, conduction, radiation, open- or closed-loop control, laser light, a light bulb, chemical or electrochemical reaction, etched foil or a formed coil/element heater.

I. Sample Storage System

In addition to sample collection system 502, instrument 100 can comprise a sample storage system 504. Sample storage system 504 can be removably or permanently attached to cartridge 202. Sample collection system 502 can comprise a portion of sample storage system 504 or, alternatively, can be removably attached to storage system 504. Storage system 504 can interface with the collection system to transfer all or a portion of a collected sample into storage system 504. Storage system 504 can comprise a tamper-proof seal or indicator to indicate to the user that storage system 504 has not been tampered with or previously used.

Storage system 504 can be operative to preserve and store a sample until the user desires to perform a test. Once the user desires to perform a test, storage system 504 can be operative to interface with cartridge 202 to transfer all or a portion of the sample into cartridge 202. Storage system 504 can be operative to mix a sample with reagents, including but not limited to ethylene-diamine tetraacetic acid (EDTA), lithium heparin, sodium heparin and/or sodium citrate, that help to preserve or prepare a sample for a subsequent test. Storage system 504 can also be operative to separate a sample into serum or plasma using techniques including but not limited to reagents (e.g. clotting factors), gel, a separation filter, a lateral flow device or centrifugal force. Storage system 504 can also be operative to separate analytes from a sample (and/or matrix) using techniques including but not limited to magnetizable capture beads, a separation filter, or a lateral flow device.

Storage system 504 can also be operative to store data related to sample storage, including but not limited to time and date of sample acquisition, freshness or expiration dates for a sample, current volume of sample, volume of gas in the sample, confirmation that the sample is adequately stored, and patient identification information. Storage system 504 can also be operative to detect and record sample environmental conditions, including but not limited to temperature, humidity and oxygen exposure. Storage system 504 can also be operative to communicate stored information to instrument 100 or other external devices through the techniques described above in regard to communication between instrument 100 and external devices. Storage system 504 may also comprise storage zone 2004.

Referring still to FIGS. 5A and 5B, cartridge 202 can comprise a seal 512 operative to improve the efficiency of sample transfer between storage collection system 502 or, if provided, sample storage system 504. Seal 512 can also reduce the possibility of sample contamination or biohazard contamination of the instrument. In addition to or instead of seal 512, a seal (not pictured) can be located on sample collection system 502 or, if provided, sample storage system 504.

As shown in FIG. 6, cartridge 202 can incorporate a fixed sample storage system 504 but utilize a removable sample collection system 502. In this aspect, sample collection system 502 can be stationary in the ejected position. A cover or septum (not shown) can also be provided to cover removable sample collection system 502 when not in use to alleviate the risk of needle sticks.

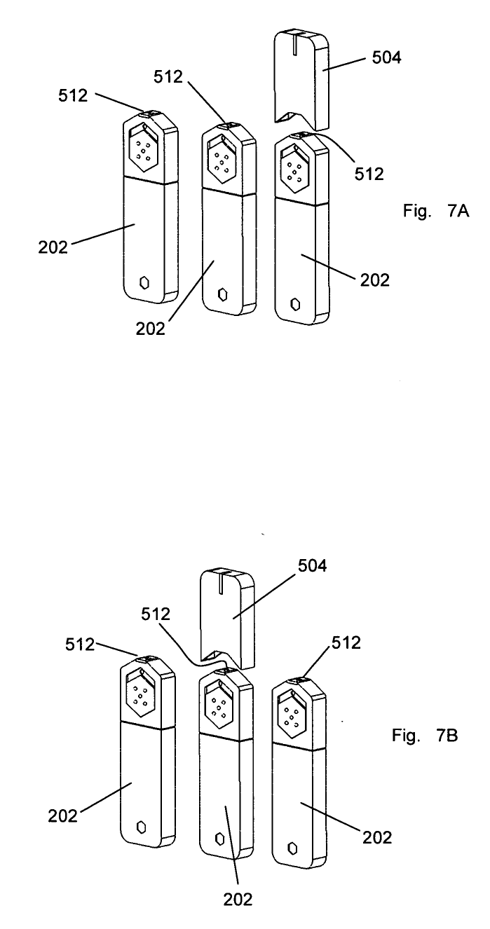

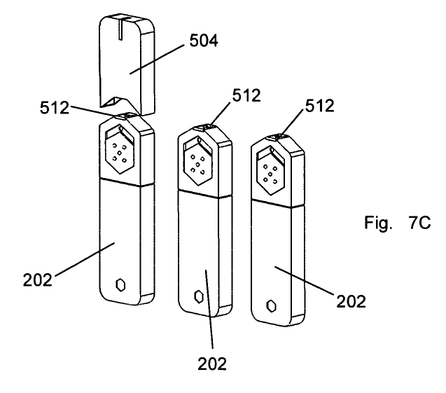

FIGS. 7A, 7B, and 7C illustrate cartridge 202 incorporating a removable sample storage system 504. As demonstrated in FIGS. 7A, 7B and 7C, removable storage system 504 can be rotated between multiple cartridges 202. As only a fraction of the sample contained in storage system 504 may be necessary to perform a test or panel of tests in a single cartridge 202, storage system 504 can be adapted to dispense only a fraction of its contents into each cartridge 202. Accordingly, multiple cartridges 202 can receive samples from a single storage system 504, which may reduce the number of needle sticks a patient must endure-when multiple tests must be performed.

J. Data/information Collection, Storage, Transfer, and Usage

Instrument 100 can be operative to detect the presence of a sample in cartridge 202. Sample detection can be accomplished through a variety of techniques known in the art, including but not limited to electrical and optical techniques. For example, instrument 100 can be adapted to detect the presence of a sample through a pair of leads located in each incubation zone or downstream of each incubation zone. Instrument 100 can be adapted to measure the conductivity between the two leads. The leads can be located so that a liquid filling the incubation zone to a level adequate for testing purposes will reach both leads. Instrument 100 can then detect the presence of a sample based on the conductivity difference between the liquid and the gas previously filling the incubation zone.

Instrument 100 can also be adapted to detect the presence of a sample using oblique illumination. Through this technique, the refractive index of the interior of the incubation zone or downstream of the incubation zone can be monitored, with the presence of a sample confirmed by a shift in refractive index as the sample replaces gas in the incubation zone. The total lack of a signal can indicate the absence of any liquid. For example, light emitter 1006 can shine light through surface 1403 into measurement zone 1108 at such an angle that in the presence of gas the light undergoes total internal reflection while in the presence of liquid a portion of the light transmits as 1407. A light detector arranged to receive light ray 1407 can be used to measure presence of a sample. In some embodiments, instrument 100 can utilize the same optical system used to detect and/or quantify the presence of an analyte of interest within a sample to detect the presence of a sample in cartridge 202.

Instrument 100 can be operative to control or assist cartridge 202 in facilitating any necessary chemical reactions occurring in cartridge 202 after a sample is inserted. Instrument 100 can also be operative to control the test sequence.

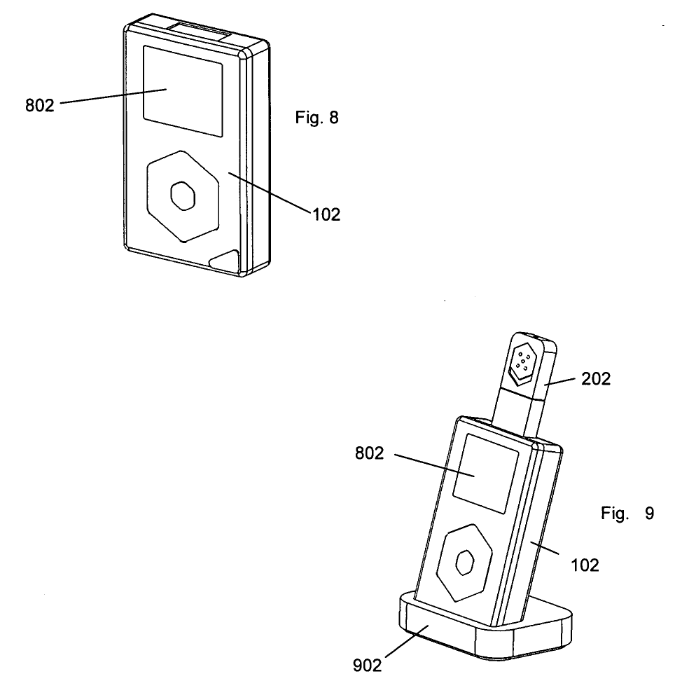

Instrument 100 can be operative to notify the user of the results of testing. As illustrated in FIG. 8, housing 102 can comprise a display screen 802 on which the results of an assay can be displayed to the user. Results can be displayed on display screen 802 through any technique known in the art for displaying information, including but not limited to LED, LCD, plasma and CRT displays. Instrument 100 can also be adapted to generate and store an electronic file containing test results, and can be further adapted to transmit the file to an external device for communicating the test results to one or more users.

Instrument 100 can be operative to notify a user of test results through other techniques, as well. For example, instrument 100 can notify the user through audio means, such as by sounding a tone or beep to indicate a certain result or through an artificial voice system operative to sound a certain word or series of words indicative of a particular test result. Audio information can be delivered through a speaker housed on the instrument and/or instrument 100 can contain an output jack, enabling the user to receive information through headphones for situations where the environment is noisy or the user does not wish to disturb others in the vicinity or through external speakers. Instrument 100 can also be operative to allow a user to select a language in which text or audio information is delivered. It is recognized that the above-described features apply not only to notifying a user of test results, but to any aspect in which instrument 100 communicates information to a user or another device.

Consistent with the principles disclosed herein, instrument 100 can also be operative to store the results of a diagnostic test, as well as other information. Instrument 100 can be operative to transform raw data resulting from testing into refined results. For example, analyte concentrations may be expressed in units of moles per volume, mass per volume, colony forming units per volume, plaque forming units per volume, and/or international units (IU) wherein the volume may be either the sample volume or a subset of the sample volume (e.g., plasma volume in a whole blood sample). In some embodiments, reference ranges are also given for the tested analytes. In some embodiments, measurements outside of the reference ranges can be highlighted. In some embodiments, the instrument can report the measurement is invalid for example, by examining the raw data for either non-physical results or physically possible results that are known to create inaccuracies in the measurements. For example, instrument 100 can be operative to perform functions including but not limited to table look-ups, computations and graphical representation of results.

In addition to storing and processing test results, instrument 100 can store patient-related information, such as names, patient identification numbers, birth dates, physician orders, known allergies, medical histories and images. In order to input such information into the memory of the instrument, housing 102 can be equipped with one or more input mechanisms. For example, housing 102 can be equipped with a keyboard or keypad allowing the user to enter information into a memory component of instrument 100. Housing 102 can be equipped with a barcode reader, RFID tag reader and/or a magnetic strip reader that can be used to scan information relating to a patient, a sample or a cartridge into the memory of instrument 100. It is recognized, however, that a keyboard and-a barcode reader are exemplary only, and that many input devices- known in the art can be utilized to enter information into the instrument, including but not limited to point-and-click devices, capacitive sensory inputs, touch screens, buttons, slides, dials, joysticks and voice recognition systems. In some embodiments, information generated by instrument 100, stored in its memory or received through other means, can also be displayed to the user on display screen 802.

Depending on the assay technique implemented by instrument 100, as well as the type of sample and the analyte of interest, environmental factors can influence the reliability of the test result. In some embodiments, to provide both the operator of the device, as well as others reviewing the test results at a later time, with the necessary information, instrument 100 can be adapted to store environment-related information that can influence test results. For example, instrument 100 can be operative to store information relating to the test facility, temperature, and humidity level at the date and time the sample was obtained and/or the date and time the test was conducted. As mentioned above, instrument 100 can include one or more data input features allowing a user to enter data into a memory component. Such input features can be engaged by the user to enter environment-related information. However, consistent with the principles of the present invention, instrument 100 can also include other mechanisms operative to gather environment-related data. As a non-limiting example, instrument 100 can contain a temperature sensor (e.g., an RTD, thermistor, or a thermocouple) and/or a humidity sensor. Mechanisms to gather and record environment-related information can be triggered by the user of instrument 100 or can be adapted to automatically gather and record information when a test is performed or when a sample is obtained.

Consistent with the principles disclosed herein, instrument 100 can also be operative to store information regarding use of instrument 100 and/or cartridge 202. For example, in certain embodiments, instrument 100 can store information regarding the number of tests performed by the device, the type of tests, number of successful tests and device verification/calibration status. As with environment-related information, instrument 100 can be adapted to allow the user to enter information regarding instrument 100 and/or cartridge 202 manually, such as by typing the information on a keypad or by scanning a barcode attached to cartridge 202. Instrument 100 can also be adapted to gather and record information automatically, such as making a record of each time instrument 100 conducts a test or is calibrated. In addition to gathering and recording such information, instrument 100 can be adapted to sort and categorize information at the request of a user or another device with which instrument 100 is interfaced.

In some embodiments, instrument 100 can also provide a user with instructions regarding the proper operation of the device and/or proper technique for obtaining a sample for a certain test. For example, instrument 100 can be operative to provide a step-by-step protocol comprising at least one of instructing a user how to scan cartridge 202, how to collect a sample, how to request consent for a procedure, how to properly insert cartridge 202 into housing 102, how to operate instrument 100 to conduct a test, how to view test results, how to use instrument 100 to process test results, and how to interface instrument 100 with other devices to communicate information. Similarly, instrument 100 can be operative to prompt the user with questions regarding one or more procedures related to the diagnostic test. For example, a version of instrument 100 operative to perform diagnostic testing on a sample from a human patient can be operative to prompt a medical practitioner to determine whether the patient has eaten within a certain number of hours, whether the sample collection site has been sterilized, whether the patient is currently on medication, and/or whether the medical practitioner confirmed the patient's identity.

Instrument 100 can be operative to communicate the instructions regarding operation of the device or proper medical procedure in various manners known in the art. For example, instrument 100 can utilize a display screen, as described above, to display text-based instructions to the user. The display screen can also be operative to display graphic illustrations, still pictures or video, either instead of or in conjunction with text instructions. Similarly, instrument 100 can be operative to provide audio instructions to the user.

In addition to providing the user with information regarding proper medical procedure, such as asking the patient questions regarding consent and medical history, instrument 100 can be adapted to store information received from the patient. As mentioned above, instrument 100 can be adapted to receive information input by the user, but it can also be equipped with other information-gathering mechanisms for receiving patient information. For example, it can be desirable for legal reasons to have concrete evidence of information given to or consent received from a patient. Instrument 100 can therefore be equipped with a microphone to record a patient's voice into a memory device of the instrument. Alternatively, instrument 100 can be equipped with a mechanism to electronically record a signature, such as a pressure pad similar to those commonly used by delivery companies and credit card machines.

As briefly mentioned above, instrument 100 can be operative to communicate information, such as test results or patient information, to one or more external devices, including but not limited to a pager, PDA, cell phone, wireless device, computer or printer. Data transmission can be accomplished through many techniques known in the art consistent with the principles of the present invention. Techniques for transmitting information to other devices that can be employed by instrument 100 include, but are not limited to, (i) radiofrequency; (ii) near-infrared; (iii) TCP/IP; (iv) USB; (v) IEEE 1394; (vi) RS-232; (vii) IEEE-802.11, (viii) inductive coupling, and (ix) frequency modulation of power lines. In some embodiments, instrument 100 can push information onto a network or to another device. In some embodiments, information can be pulled from instrument 100, through specific requests by another device. In some embodiments, information can be transmitted to multiple individuals interested in the results of testing. Instrument 100 can also employ encryption and/or data protection techniques to ensure the privacy of transmitted information. In addition to transmitting information to external devices, instrument 100 can also be adapted to receive information from external devices through the above-described techniques, as well as others known in the art.

In some embodiments consistent with the principles disclosed herein, instrument 100 can comprise a docking station interface allowing it to plug into a docking station connecting instrument 100 to another device or network of devices, such as central or decentralized information systems, allowing instrument 100 to share and receive information. FIG. 9 illustrates an instrument comprising a housing 102 connected to a docking station 902. In addition to allowing instrument 100 to communicate with external devices, accessory devices interfaced with the instrument, including but not limited to a sample collection system and a sample storage system, can communicate with external device(s) through docking station 902. Docking station 902 can use any combination of the above-described techniques to share information with an external device. Docking station 902 can also provide the instrument, as well as its accessory devices, direct access to electrical power. When not connected to docking station 902 or another external source of power, instrument 100 can be adapted to run on local energy storage devices, including but not limited to rechargeable lithium-ion, nickel-metal hydride, nickel-cadmium, lead acid, carbon zinc, alkaline, or zinc-air batteries. Docking station 902 can allow instrument 100 and its accessory devices to energize/re-energize its local energy storage devices.

Instrument 100 can also comprise identification accessories. For example, instrument 100 can comprise a digital camera allowing the user to capture and record an image of the person or object from which a sample is obtained. As with other information that can be stored on the instrument, images captured by instrument 100 can be transmitted to external devices. This feature can be particularly applicable for emergency response applications, where it can be desirable to transmit an image of a person to an external computer for analysis by pattern-recognition software for identification purposes. Instrument 100 can also utilize other techniques for identifying a person, such as electronic fingerprint or iris scans. Instrument 100 can be operative to identify a person or object based on records stored in the memory of instrument 100, or it can collaborate with an external device in order to make an identification and assemble associated data. Instrument 100 can also utilize-one or- more of the above- described input features to identify a patient or object. For example, instrument 100 can use a bar code, RFID tag or magnetic strip to identify a compatible label containing identification information. In one aspect, instrument 100 can be capable of scanning “smart” cards, such as driver's licenses and credit cards carrying identification information regarding the owner.

K. Assay Methods

As described herein, instrument 100 can utilize a number of techniques in performing diagnostic tests on a sample. In certain embodiments, instrument 100 can be adapted to perform a fluorescence immunoassay. Fluorescence immunoassays traditionally are encumbered with a number of disadvantages, including problems with background fluorescence from proteins, other sample components and components of the cartridge and instrument; additional effort required for free-bound separation due to the entire sample emitting fluorescence; and, when a high-density cartridge is used, additional cross-talk complexities caused by the requirements to uniformly illuminate the intended sample regions while not illuminating unintended sample regions. However, the disadvantages of fluorescence immunoassay can be overcome using advanced fluorescent techniques. Background fluorescence can be substantially reduced using fluorophores that are excited and emit in the infrared (IR). Free-bound separation can be improved by using total internal reflection fluorescence (TIRF). The cross-talk issue can be overcome by careful engineering of the cartridge, although it may compromise the number of diagnostic tests that can be performed in a single sample, which can be called the cartridge “density.”

One skilled in the art would recognize that other methods of detection, including but not limited to electrochemiluminescence (ECL), chemiluminescence, absorption assays, (e.g. enzyme-linked immunosorbent assay) or resistance-based assays could also be used. For example, methods of labeling antibodies, analyte binding partners, and nucleic acids with electrochemiluminescent moieties are well known in the art. (See, for example, U.S. Pat. No. 6,451,225; U.S. Pat. No. 6,325,973; U.S. Pat. No. 5,746,974; and U.S. Pat. No. 5,731,147.) Assays using ECL labels are sensitive and resistant to the effects of the sample matrix. In further embodiments, assay cartridges using ECL may also comprise one or more ECL coreactants.

An instrument 100 operative to perform a fluorescent immunoassay can be adapted to maintain complete separation of the diagnostic apparatus, as well as the remainder of instrument 100, from the sample. Instead, only light need traverse interface 204 of cartridge 202. The instrument can comprise a light source, or excitation mechanism, such as a laser diode. In some embodiments, the excitation mechanism can additionally comprise optical filters, polarizers, mirrors, lenses, optical fibers, and/or apertures. The label detector of instrument 100 can comprise a light detection mechanism to measure the amount of fluorescence generated near the total internal reflection surface. The light detection mechanism can comprise (a) an optical filter designed to block light from the excitation mechanism and transmit light from the fluorophore and (b) a light detector such as a photodiode (including PIN and avalanche photodiodes), a CCD, a CMOS sensor, a photomultiplier tube (PMT), or a channel multiplier tube (CMT). The signal read by the light detector can be amplified by using label holding a large number of fluorophores. The fluorophores can be encased inside a particle, e.g., a polystyrene bead, so that quenching from the sample and non-specific binding of the fluorophores on the capture species are eliminated. With the use of fluorophore-containing beads, between 10¹-10⁶ photons per second per binding event can be realized.

L. Free-Bound Separation

Commonly, binding assays are used to detect and quantify the presence of an analyte of interest through the use of a labeled molecule such as a labeled binding partner or a labeled analog of the analyte. The labels that have interacted with the analyte of interest must be distinguished from those that do not interact with the analyte of interest in order to generate a measurement of label that is indicative of analyte concentration or analyte amount. For many binding assays (e.g., many sandwich and competitive assays; See also, The Immunoassay Handbook, 3^{rd} edition, David Wild, editor, Elsevier 2005), a support is used to assist in distinguishing the label that have and have not participated in a binding reaction. Label that is linked to the support is termed “bound label”, while label that is not linked to the support is termed “free label”. For many binding assays, separation of the bound label and the free label (herein termed “free-bound separation”), enables measurement of either the free or bound label, which can then be related to the concentration or amount of analyte. In various embodiments, cartridge 202 can comprise structures that assist in free-bound separation.

In various embodiments, cartridge 202 can comprise a separation filter operative to capture analytes present in a sample. This can be accomplished by spotting capture antibodies in a particular region of the separation filter and passing the sample through the separation filter. In certain embodiments, a light source can be adapted to illuminate the entire three-dimensional volume of the separation filter containing the capture antibody. However, a number of complexities must be recognized and addressed. For example, the free-bound separation requirement is rigorous, and the interaction time of a small volume of the sample and the capture antibody is very short (the interaction time being determined by the particle velocity through the separation filter). Further, the reaction rates are reduced because the capture antibody cannot diffuse.

1. Surface-Selective Excitation, General

When utilizing total internal reflection fluorescence (TIRF) in performing a fluorescence immunoassay, the excitation light can travel to the sample in an optical waveguide or light path. The waveguide and the light source can be arranged so that the light undergoes total internal reflection at the boundary of the measurement zone. Accordingly, the excitation light does not propagate throughout the entire sample. Instead, an exponentially decaying evanescent wave is created by the total internal reflection (TIR), entering the sample to a depth of λ/5, where λ is the wavelength of the excitation light in the sample (the exact relation is given below). The amplitude of the evanescent wave drops off exponentially with distance from the TIR surface, creating a surface-selective excitation. Using a 785 nm laser, a region within 160 nm of the total internal reflection surface can be excited. The evanescent space constant equals:

$$λ / ( 2 π \sqrt{- {n}_{2}^{2} + {n}_{1}^{2} {sin ( {Θ}_{i} )}^{2}} ,$$

where λ is the wavelength of light in the sample, n₂ is the refractive index in the sample, n₁ is the refractive index of the optical waveguide, and Θᵢ is the angle of incidence.

TIRF methods can provide a free-bound separation, for example, if the labeled binding reagent that has bound to the analyte can be collected in the measurement zone. For example, if a 785 nm laser is used as the light source, the measurement zone is only 785/5 or 160 nm thick. The incubation zone in the cartridge can be 0.5 mm thick, so that only 0.160/500=0.03% of the incubation zone will be excited (assuming the measurement zone and incubation zone have equal areas). If the unbound label is uniformly distributed in the incubation zone, then 0.03% will be in the measurement zone. Thus, the lowest measurable signal will be 0.03% of all the labels being excited. The largest measurable signal will be 100% of all the labels being excited due to their collection in the measurement zone. Thus, a dynamic range of 1/0.03% or 3,125 is achieved by just (1) collecting the labeled binding reagent that has bound to the analyte in the measurement zone and (2) using TIRF as a surface-selective excitation mechanism.

Assay methods that utilize the benefits of surface-selective excitation include those that link a capture binding reagent to the appropriate surface of the measurement and those that use magnetizable capture beads linked to a capture binding reagent that can be captured on the appropriate surface of the measurement zone. As known in the art, sandwich and competitive assays can be used. In sandwich assays, the capture binding reagent is specific for the analyte of interest. In competitive assays, the capture binding reagent may be a binding reagent specific for the analyte of interest, or the analyte of interest or an analog of the analyte of interest.

The surface-selective excitation discussions on free-bound are not limited to TIRF; rather it is applicable to any surface selective excitation technique (e.g., electrochemiluminescence and surface plasmon resonance). Surface selective excitation enables one dimension of the measurement zone to be very small. In one embodiment, a measurement zone is 160 nm. In some embodiments, the smallest dimension of the measurement zone is 10 μm, 1 μm, or 0.5 μm or less, respectively.

2. Surface-Selective Excitation, Free Label Repulsion

Surface-selective excitation enables other techniques to improve the free-bound separation beyond the levels mentioned above, because the free labeled binding reagent only has to be moved out of the measurement zone—which can be very small (e.g., 160 nm). In certain embodiments, a non-magnetic force (in the case of utilizing magnetizable capture beads) or any force (in the case of linking directly to the surface of the measurement zone) can be applied to repel free label away from the measurement zone. Accordingly, unbound label will be kept out of the measurement zone, reducing background. However, this repulsion force must be sufficiently small not to remove bound label from the measurement zone. For example, a charged labeled bead can be used in combination with an electric field created by non-contact electrodes located in instrument 100 operative to repel free label bead from the measurement zone. In some embodiments, a magnetic force may be able to repel a non-magnetic labeled bead. For example, in the presence of a ferrofluid, a non-magnetic bead will be repelled from a magnet (A. T. Skjeltorp, One- and Two-Dimensional Crystallization of Magnetic Holes. Physical Review Letters, Vol. 51, Number 25, pp. 2306-2309 (1983)).

In one embodiment, magnetizable capture beads attached to a capture antibody, smaller (for example, 10 nm) magnetizable capture beads as a ferrofluid, and a non-magnetic bead comprising one or more fluorophores attached to a binding partner are used. Such ferrofluids are commercially available from, for example, Ferrotec (Nashua, NH). Upon application of a magnet, the capture binding partners and sandwiched labeled binding partners will be collected, while free labeled binding partners will be repelled. The free labeled binding partners act as magnetic “holes” having an effective negative magnetic moment equal to the total moment of the displaced ferrofluid. While these magnetic holes can create braids, chains, and other complex structures in the long time scale, these effects can be minimized by using small non-magnetic beads (e.g., 1 μm or less, 0.1 μm or less, 20 nm, or 40 nm size beads from Active Motif Chromeon GmbH (Tegernheim, Germany) or Molecular Probes (Eugene, Oreg., USA)) to increase Brownian motion and by measuring the labels in the measurement zone shortly after (e.g., 300 s or less, ≦30 s or less, or 10 s or less) applying the magnetic field.

In some embodiments, a heavy labeled bead relying on gravity separation can be used to repel free label bead from the measurement zone. This gravitational method may require appropriate orientation of instrument 100 immediately prior to label measurement. In some embodiments, the label may be attached to an optically absorbing bead. Instrument 100 may include a mechanism to optically push the label away from the measurement zone. If an absorbing labeled bead is used, absorption should not occur near the emission wavelengths.

3. Wash Methods

In some embodiments, other free-bound separation techniques can be used alone or in combination with other separation techniques disclosed herein or known in the art. In some embodiments, a fraction of the sample is used in the binding reaction, while another fraction of the sample is used to wash away free (i.e., unbound) label. In some embodiments, (1) a fraction of the sample flows past binding reagents dried to a surface in an incubation zone (e.g., the instrument 100 mechanically displaces part of storage zone 2004, forcing sample to flow into incubation zone 2013 that comprising binding reagents), (2) the flow of sample stops before a substantial fraction of the binding reagents can dissolve, (3) the binding reagents dissolve, interact with the analyte, and label is bound inside incubation zone 2013, and (4) retrograde flow washes away free label (e.g., the mechanical displacement of part of storage zone 2004 is reversed). In some embodiments, a liquid other than the sample or a gas is used to wash away free label.

In some embodiments, a wash liquid (distinct from the sample) is used for free-bound separation. Advantages of using a wash liquid include the possibility of reducing the amount of sample matrix present while measuring the label. As the wash liquid washes away free label, it replaces the sample matrix surrounding the bound label. Removal of the sample matrix may improve measurement of the label through a diverse set of means, for example, by elimination of sample-dependent luminescent quenchers (see, e.g., Principles of Fluorescence Spectroscopy, 2^{nd} Edition, Joseph Lakowicz, 1999; and WO 98/53316), elimination of sample-dependent signal enhancers (see, e.g., WO 90/05302 and Kricka et al., 1987 Enhanced chemiluminescence enzyme immunoassay, Pure & Appl. Chem. Vol. 69, No. 5, pp 651-654), elimination sample dependent enzyme inhibitors, elimination of background signals (e.g., autofluorescence of proteins), and/or by affecting the potential or impedance of an electrode. The wash liquid can also introduce a chemical used to aid in the measurement of the label, for example, an ECL coreactant (e.g., tripropylamine), signal enhancer (e.g., 4-iodophenol, Triton® X-100), and/or signal activators (e.g., luminol, hydrogen peroxide, adamantyl 1,2-dioxetane arylphosphate, other 1,2-dioxetanes, acridinium esters, and acridinium sulphonamides). The wash liquid can be an aqueous solution. For example, it can comprise 300 mM KH₂PO₄, 150 mM tri-n-propylamine (TPA), 150 mM NaCl, 0.2 g/L polyoxyethylene 9 lauryl ether, and 1 g/L Oxaban-A™ (Dow Chemical, Midland, Mich.). The wash liquid can comprise organic liquids, for example, acetonitrile, methylene chloride, dimethylformamide, benzonitrile, benzene, trichloromethane, toluene, methanol, trifluoroethanol, dimethylsulfoxide, glycerol, oil, and mixtures thereof. In some embodiments, the wash liquid is immiscible with the sample. In other embodiments, the wash liquid is miscible with the sample. Typically, the wash liquid has an absolute viscosity that is less than or equal to 0.1 Pa·s at 20° C., although it can be higher. In some embodiments, the wash liquid has an absolute viscosity that is less than or equal to 10 Pa·s. Typically, the wash liquid has a density that is less than or equal to 2,000 kg/m³ at 20° C., although it can be higher.

The common way to use a wash liquid in free-bound separation when employing magnetizable capture beads as the support to draw the bound label to a surface and exchange the liquid. For example, many companies sell 96 well plate magnetic separators (e.g., catalog number BMP-00-0004 from Rockland Immunochemicals, Gilbertsville, Pa.). Having magnetizable capture beads in the wells of a 96-well plate, one can use the magnetic separator to draw the beads to the bottom of the plate, so the liquids can be exchanged. Flow-cell based ECL equipment (e.g., M-Series® 384 and Ml M analyzers (BioVeris Corp, Gaithersburg, Md., USA) and Elecsys® 1010, 2020, and E-170 instruments (Roche Diagnostics, Basel, Switzerland))-aspirate the mixture of bound label, free label, and sample matrix into the instrument across the electrodes in the measurement cell. The magnetizable capture beads are collected on the working electrode, and then the magnetizable capture beads and electrode are washed. Because the fluid particle velocity approaches 0 at the surface in these types of flows (the no-slip condition, see Fay, J., Introduction of Fluid Mechanics, MIT Press, 1994), washing the electrode and the liquid near the beads is difficult. In some embodiments, the principles of diffusion and convection facilitate particles and electrode washing (see Probstein, R., Physicochemical Hydrodynamics, an Introduction, 2^{nd} Ed. Wiley Interscience, 1994). Consequently, the washing time and volume of washing liquid are significant fractions of the measurement cycle.

4. Stokes Washing

Contemplated herein are new methods and apparatus (hereafter referred to as “Stoke's washing”) of using magnetizable capture beads and wash liquids that can provide at least one of the following improvements: a reduction in the wash volume, a reduction in the wash time, and a reduction in the amount of sample matrix that contacts the measurement surface for surface-selective methods (e.g., the electrode in ECL methods). Stoke's washing uses a magnet to pull the magnetizable capture beads from a liquid comprising the beads and sample matrix into a wash liquid. For example, the wash liquid can be located on the measurement surface and the beads are pulled through the wash liquid to the measurement surface, reducing the amount of sample matrix and/or free label that contacts the measurement surface. Stoke's washing is used in some embodiments. Other embodiments do not use Stoke's washing. Without wanting to be bound by theory, a mechanism for improving the wash efficiency is now described. Each bead will bring with it-some sample matrix in its boundary layer. This boundary layer can be characterized by Stoke's flow around a sphere (see Physicochemical Hydrodynamics, an Introduction, supra) and drops off in the far field as the ratio of the bead radius to the distance. While there is some angular dependence of the boundary layer, at the worst-case angle (in-line with the direction of motion), the velocity at 1 bead diameter away is 48% that of the bead, and at 5 diameters, the velocity is 15% that of the bead. Thus, only a thin layer of sample matrix is carried into the wash liquid by the bead. This thin layer can diffuse away rapidly. For example, an IgG molecule having a diffusion coefficient of 3.9×10⁻⁷ cm²/s (Khoury, Adalsteinsson, Johnson, Crone, and Beebe. Tunable Microfabricated Hydrogels—A study in protein interaction and diffusion. Biomedical Devices 5:1, 35-45. 2003) requires only 0.2 seconds to diffuse 2.8 μm (one of many typical bead diameters—smaller bead sizes will have smaller boundary layers enabling diffusion to work even faster) using the approximation D˜x²/t, where D is the diffusion coefficient, x is distance and t is time.

The analysis of 1 bead moving through and surrounded by a wash liquid may also be valid for many beads moving through and surrounded by a wash liquid—the mean bead-to-bead spacing is much larger than the bead diameter. To the extent that bead boundary layers overlap significantly, additional wash volume and time may be required. The condition of the beads being surrounded by the wash liquid (hereafter “Stoke's bulk washing”) enables diffusion and convection to work together in 3 dimensions to reduce the amount of sample matrix surrounding the beads. In another embodiment, the beads roll, slide, or otherwise travel within the fluidic boundary layer of a wall (hereafter, “Stoke's surface washing”. While in Stoke's surface washing sample matrix can diffuse away only in a half-space, this method is still effective for small beads. For beads 10 μm or less in diameter, the diffusion time for IgG-sized molecules is under 1 second; thus, diffusion can carry free label and/or sample matrix from the wall into and out of the boundary layer.

In addition to contemplating the general technique of Stoke's washing for free-bound separation and/or measurement surface protection from sample matrix, many specific embodiments are contemplated herein. FIGS. 17A-17F illustrate different configurations of Stoke's washing consistent with the principles of the present invention. Each figure utilizes magnet 1701, magnetizable capture beads 1704, incubated Sample 1702, and wash liquid 1703. The solid arrows indicate trajectories that magnetizable capture beads 1704 can take to travel from incubated sample 1702 to wash liquid 1703 under the influence of magnet 1701. Not shown is the measurement zone that is located in or near magnet 1701. The open arrows indicate that the bulk phase of the liquids is moving, while lack of those arrows (e.g., FIGS. 17C and 17F) indicates that one or both liquids can be stationary. Dashed lines represent a possible contact surface between incubated sample 1702 and wash liquid 1703.

FIG. 17A shows fluidic structure 1710 in which incubated sample 1702 and wash liquid 1703 form 2 layers as they flow past magnet 1701. Magnet 1701 applies magnetic force to magnetizable capture beads 1704, drawing them from incubated sample 1702 to wash liquid 1703.

FIG. 17B shows fluidic structure 1711 and fluidic structure 1712 that control the flow of the two liquids in non-parallel directions. Fluidic structure 1712 contains wash liquid 1703 that flows under incubated sample 1702. Fluidic structure 1711 has an opening in the bottom so that wash liquid 1703 and incubated sample 1702 are in fluidic contact. Magnet 1701, which pulls magnetizable capture beads 1704 from incubated sample 1702 to wash liquid 1703, is below fluidic structure 1712.

FIG. 17C shows fluidic structure 1714 intersecting fluidic structure 1713. Incubated sample 1702 fills fluidic structure 1714, stopping at the interface between fluidic structure 1714 and fluidic structure 1713 due to any one of a variety of mechanisms (e.g., due to capillary forces created by geometry and/or surface energy or due to a possibly feedback-controlled active pump). Afterwards, fluidic structure 1713 is filled with wash liquid 1703, and either while wash liquid 1703 has stopped or is flowing, Magnet 1701 applies magnetic force to magnetizable capture beads 1704, drawing them from incubated sample 1702 to wash liquid 1703.

FIG. 17D shows fluidic structure 1716 intersecting fluidic structure 1715. Incubated sample 1702 fills fluidic structure 1716 and continues to flow into fluidic structure 1715. Fluidic structure 1715 is also being filled with wash liquid 1703. Magnet 1701 applies magnetic force to magnetizable capture beads 1704, drawing them from incubated sample 1702 to wash liquid 1703.

FIG. 17E shows fluidic structure 1717 with 3 liquid layers-incubated sample 1702 in the middle of two layers of wash liquid 1703. Magnet 1701 applies magnetic force to magnetizable capture beads 1704, drawing them from incubated sample 1702 to wash liquid 1703.

FIG. 17F shows fluidic structure 1718 with 2 liquid layers. Both incubated sample 1702 and wash liquid 1703 are optionally stationary when magnet 1701 applies magnetic force to magnetizable capture beads 1704, drawing them from incubated sample 1702 to wash liquid 1703.

In some embodiments, fluidic structures 1710, 1711, 1712, 1713, 1714, 1715, 1716, 1717, and/or 1718 can be channels, and/or wells. In some embodiments the regions of the fluidic structures 1710, 1711, 1712, 1713, 1714, 1715, 1716, 1717, and/or 1718 comprising incubated sample 1702 can be an incubation zone. In some embodiments, the measurement zone lies solely in wash liquid 1703. In some embodiments, the incubated sample 1702 completely flows past magnet 1701 before the measurement process begins. In other embodiments, at least part of incubated sample 1702 remains in the vicinity of magnet 1701 during the measurement process.

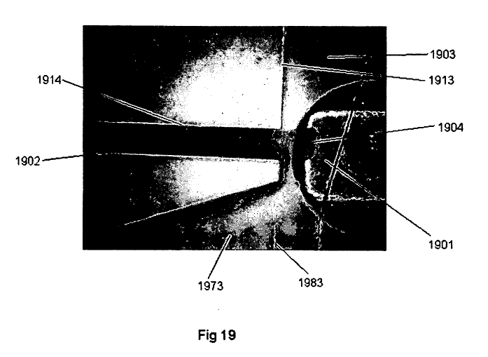

FIGS. 18A-18G show different configurations of Stoke's washing consistent with the principles of the present invention. Each example utilizes magnet 1801, magnetizable capture beads 1804, incubated sample 1802, and wash liquid 1803. Magnetizable capture beads 1804 are shown in transit from incubated sample 1802 to wash liquid 1803. Not shown is the measurement zone that is located in or near magnet 1801.

FIGS. 18A, 18B, and 18C show fluidic structure 1810 intersecting fluidic structure 1811. Incubated sample 1802 fills fluidic structure 1810, stopping at the interface between fluidic structure 1810 or 1812 and fluidic structure 1811 or 1813 due to any one of a variety of mechanisms (e.g., due to capillary forces created by geometry and/or surface energy or possibly due to a feedback-controlled active pump). Afterwards, fluidic structure 1811 or 1813 is filled with wash liquid 1803, and either while wash liquid 1803 has stopped or is flowing, magnet 1801 or magnet 1881 (not shown) applies magnetic force to magnetizable capture beads 1804, drawing them from incubated sample 1802 to wash liquid 1803. Magnet 1881 is smaller and/or offset from magnet 1801 to ensure that all of magnetizable capture beads 1804 under Stoke's bulk washing. FIG. 18C is a side view 1814 of FIG. 18B.

FIGS. 18D, 18F, and 18G show some exemplary “head-on” embodiments, wherein incubated sample 1802 and wash liquid 1803 do not flow past one another. Turning to FIG. 18D, fluidic structure 1815 stops incubated sample 1802 at the interface between fluidic structure 1815 and fluidic structure 1816 (e.g., due to capillary forces created by geometry and/or surface energy or due to a possibly feedback-controlled active pump). Fluidic structure 1816 brings wash liquid 1803 into fluidic contact with incubated sample 1802. Vents 1830 enable gas to escape in the event the system is not evacuated. Optionally, one of vents 1830 may be absent.

FIG. 18F shows a similar design, wherein the geometry surrounding the stopping point differs at the interface between fluidic structure 1819 and fluidic structure 1820. Vents 1832 enable gas to escape in the event the system is not evacuated. Optionally, one of vents 1832 may be absent.

FIG. 18G shows a similar design, wherein capillary stop 1820 (e.g., a strip of low surface energy material) implements the stopping function at the interface between fluidic structure 1821 and fluidic structure 1822. Vent 1831 enables gas to escape in the event the system is not evacuated. Magnet 1801 is located in close enough proximity to the stopping point so that magnetizable capture beads 1804 are drawn from incubated sample 1802 to wash liquid 1803.

FIGS. 18E shows fluidic structure 1817 forming a well-like structure to hold Incubated sample 1803. Fluidic structure 1818 provides a passageway for wash liquid 1802 to form a layer on top of incubated sample 1803. Venting is not shown. Two possible locations for magnet 1801 are shown for magnetizable capture beads 1804 to be drawn from incubated sample 1803 to wash liquid 1802.

M. Labels

While various labels can be used in conjunction with a fluorescence immunoassay, certain embodiments can employ a label that is insensitive to variations in the sample matrix. In some embodiments, the label can be resistant to quenching from the sample matrix. For instance, the absorption and emission wavelengths can be in a region where the matrix is expected to transmit at least 95% of the light in the designed optical path length, which, in some embodiments, can be 0.5 mm or less. The label can be stimulated at wavelengths at which almost nothing contained in the sample can be stimulated to emit fluorescence. Additionally, if possible, the label can emit at wavelengths where almost nothing in the sample emits fluorescence. The label can have a large Stoke's shift to help differentiate the label from other material that can be excited by the excitation light. Other considerations in selecting an appropriate candidate to be used as a label in performing a fluorescence immunoassay include the candidate's solubility, quantum efficiency, and excitation wavelength. In some embodiments, the label can have a peak excitation wavelength 630 nm, 700 nm, or 750 nm or more, respectively. In some embodiments, the label can be an organic substance having a high quantum efficiency and an excitation wavelength 700 nm or more. In some embodiments, the label can have a Stoke's shift that is 20 nm; 30 nm; 40 nm; 50 nm; 80 nm; 100 nm; 120 nm; or 150 nm or more, respectively.

Large Stoke's shifts can be obtained, for example, by utilizing at least two fluorophores in a fluorescent resonant energy transfer (FRET) arrangement. For example, the fluorophores can be located in the same bead (see, e.g., U.S. Pat. No. 5,326,692), or they can be covalently coupled (e.g., Tandem dyes, U.S. Pat. Nos. 5,783,673; 5,272,257; and 5,171,843 such as Alexa Fluor® APC-Alexa Fluor 750 (Molecular Probes; Carlsbad, Calif., USA)). The APC-Alexa Fluor 750 has a peak excitation wavelength of 650 nm and a peak emission of 779 nm—yielding a 129 nm Stoke's shift. This fluorophore also has a large extinction coefficient (700,000 M⁻¹ cm⁻¹) and a 68% quantum efficiency.

One label that can be used in accordance with instrument 100 adapted to perform fluorescence immunoassays is IRDye 800™ RS. IRDye 800™ RS has a peak absorbance at 787 nm and a peak emission at 812 nm. The quantum efficiency of IRDye 800™ RS is 15% in methanol. Quantum dots can also be used as a label. However, quantum dots must be excited in the blue, which can be problematic when using TIRF because (i) the excitation depth is halved and (ii) other compounds will fluoresce. Depending on the label used by cartridge 202, the structure of instrument 100 can vary. In one embodiment, the excitation mechanism can output light that successfully excites the label but does not have measurable power at the emission wavelengths used by the label detector of the instrument. For example, when IRDye 800™ RS is the label, the excitation mechanism can comprise a laser diode having an emission wavelength of 785 nm plus or minus 2 nm. In some embodiments, the excitation mechanism can comprise a Sanyo DL-7140-201W laser diode, an 80 mW laser diode having a parallel beam divergence of 6-10 degrees (full-width at half-maximum) and a built-in photodiode to assist in regulating light output power. Other laser diodes that can be used with this invention include those that emit at 633 nm, 635 nm, 650 nm, and 670 nm. In some embodiments, the laser diode generates some out-of-band light that can either directly pass through to the detector or excite undesired fluorophores at other wavelengths. In the embodiments where these problems are sufficiently large to necessitate action, an excitation filter can be placed in front of the laser. The excitation filter can be chosen so that it will not significantly fluoresce. For example, when coupled to a 650 nm laser, a Semrock (Rochester, N.Y.) 650/13/95 bandpass filter can be used.

In creating a label to be used in a fluorescent immunoassay performed by instrument 100, as many as 10³-10⁵ molecules can be placed inside a single bead in order to achieve a large amplification of the signal. In various embodiments, the bead can have a diameter ranging from 0.01 μm to 0.1 μm. As known in the art, the exterior of the bead can comprise a linking compound operative to link it to a binding reagent (e.g., an antibody). As also known in the art, the exterior of the bead can be blocked to prevent non-specific binding.

N. Detection Mechanism

As stated above, the diagnostic apparatus can also comprise a detection mechanism to detect fluorescence. The detection mechanism can be selected so that its signal at the excitation wavelength will not be distinguishable from noise with a one second interval. Similarly, the signal of the detection mechanism due to Raman scattering of the excitation wavelength can be indistinguishable from noise with a one second measurement interval. In some embodiments, the Raman scattering from a 785 nm excitation light can occur primarily at 1,100 nm (from water 3,600-3,700 cm⁻¹), although some Raman scattering can occur due to other bonds as low as 949 nm (2,000 cm⁻¹). The detection mechanism can have a noise floor of less than or equal to 50 fW of received light at the emission wavelength over a one second measurement interval. In certain embodiments, the detection mechanism can comprise a silicon photodiode, for example, a photodiode from Hamamatsu Corporation's S2386 series, which can be used with a 1 fW noise-equivalent power.

The detection mechanism can operate in conjunction with an optical filter that may be bonded to or in the optical path of the light detector. In certain embodiments, the optical filter can have a cut-on at 790 nm (optical density greater than or equal to 8) to 795 nm (optical density 0) and a cut-off at 875 nm (optical density 0) to 900 nm (optical density greater than or equal to 5). However, because light may enter the optical filter at non-normal angles, the optical filter can be adapted to have a cut-on at 790 nm even when the angle of entry is non-normal. Accordingly, the optical filter cut-off can be 795 nm, 800 nm, or 805 nm or more, respectively, so as to provide the optical filter with greater degrees of robustness with respect to the angle of incoming light. The filter can be an interference type, absorbance type, or a combination of the 2.

Absorbance filters have the advantage of improved performance with non-normal light incident on the filter, but have the disadvantage of less sharp optical density transitions. Additionally, because absorbance filters absorb light, they are more prone to fluorescent emissions that interference filters that reflect light. In some embodiments, a combination is used, for example, a Semrock (Rochester, N.Y.) 794/160/95 bandpass interference filter followed by a 2 mm thick piece of Schott glass RG715 absorbance filter.

O. Cartridge Structure

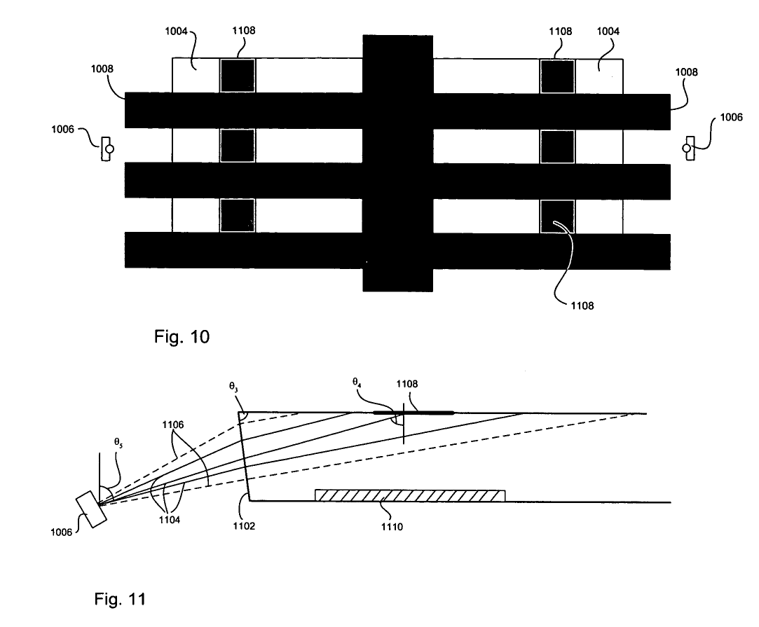

As mentioned herein, the structure of cartridge 202 can vary depending on the number of measurement zones and the assay technique performed by instrument 100. FIG. 10 is a partial, cross-sectional top view of an exemplary cartridge 202 comprising six measurement zones 1108. As pictured, each measurement zone can be associated with a light path 1004 through which an excitation mechanism 1006 can transmit light and from which a return signal can be reflected from the TIR surface and measured by a light detection mechanism. As shown in FIG. 10, instrument 100 can comprise a plurality of emitters 1006 in order to enable instrument 100 to perform assays on a greater number of measurement zones 1108. In order to prevent light transmitted down one light path 1004, or returned from a TIR surface, from contaminating another light path 1004, cartridge 202 can comprise a plurality of light barriers 1008 between measurement zones 1108 and light paths 1004. In certain embodiments, the accuracy of test results can be increased when the excitation mechanism, excitation path, emission path and light detector of a particular sample analyte are the same as that of the calibrators used to create a calibration curve for that sample analyte. However, it is not necessary that the same excitation mechanism, excitation path, emission path and light detector be used for each analyte. Accordingly, as shown in FIG. 10, a single emitter can be dedicated to more than one measurement zone through the use of different optical paths.

Cartridge 202 can comprise a top portion and a bottom portion. The top portion and the bottom portion can be connected in any number of ways known in the art. For example, cartridge 202 can include a connector comprising a pressure-sensitive, double-sided adhesive or an ultrasonic weld. The top and bottom portions of cartridge 202, as well as the connector, can serve varying purposes in the function of cartridge 202. In certain-embodiments, for example, the-bottom portion can comprise a fluidic passageway through which a sample can be introduced into measurement zone 1108. The top portion can comprise optical path 1004 and the connector can comprise light barrier 1008. If the connector forms light barrier 1008, it can comprise a variety of materials known in the art having an index of refraction sufficient to prevent light from passing between adjacent optical paths 1004, including but not limited to an epoxy resin. In certain embodiments, the top portion can comprise light barrier 1008 and can be adapted to interleave between optical paths 1004 included in the bottom portion. It is recognized that the above-described structures of cartridge 202 are exemplary and non-limiting, and that many variations on the structure of cartridge 202 are possible, including but not limited to the bottom portion comprising light barrier 1008 and optical path 1004 and the top portion comprising a fluidic passageway.

In order to keep instrument 100 as small as possible while enabling it to perform a sufficient number of diagnostic tests on a single sample, instrument 100 can be constructed to efficiently utilize the outside surface area of cartridge 202 dedicated to sample containment. In some embodiments, instrument 100 can be designed so that a minimum of five diagnostic tests can be performed using a single cartridge 202. In certain embodiments, cartridge 202 can be designed so that the total outside area dedicated to sample storage is 22.5 cm². Accordingly, no more than 4.5 cm² of the surface area of cartridge 202 can be devoted to each analyte. Depending on the sample matrix, temperature and other effects, as many as five calibrators can be necessary for each diagnostic test, meaning that no more than 0.75 cm² can be devoted to each analyte.

As exemplified in FIG. 10, cartridge 202 has a measurement density of 0.17 cm² per determination. Cartridge 202 can support 24 rows (4.8 cm), with a total dimension of 4.8 cm×1.6 cm devoted to testing and with a capacity of 6 or 8 analytes (7 or 6 determinations per analyte). Additional cartridge length may be required to provide light sealing, a sampling interface, and other possible features of cartridge 202. Cartridge 202 can also comprise 3 columns with a total testing area of 5 cm×2.4 cm and increasing the capacity of cartridge 202 to between 9 and 12 analytes. However, it is recognized that increasing the number of columns also necessitates designing optical paths capable of reaching the additional measurement zones without contaminating test results.

Measurement zone 1108 can be overfilled with excitation light in order to help achieve uniform illumination. The formula relating distance along the top of cartridge 202 illuminated by the full width (FW) angle to the angle of an excitation mechanism 1006, the angle of cartridge 202, the index of refraction of cartridge 202, the horizontal distance from excitation mechanism 1006 to the contact point of the center ray on cartridge 202, and the vertical distance from the contact point of the center ray on cartridge 202 to the top of cartridge 202 can be computed using Snell's law and geometry. In some embodiments, a laser diode and an optional excitation filter is used without a lens.

For example, if the FW angle=8°, the angle of the emitter θ₅=69°, the angle of the cartridge θ₃=82°, the index of refraction of the cartridge=1.66, the horizontal distance from the emitter to the contact point of the center ray on the cartridge is 1.5 mm, and -the vertical distance from the contact point of the center ray on the cartridge to the cartridge top=0.5 mm, then the distance illuminated on the top surface is 1.6 mm. In some embodiments, a laser diode and optional excitation filter is used with a lens so that the light is primarily collinear. In this case, the distance illuminated on the top surface is much simpler to compute and is not strongly dependent on the horizontal distance from the emitter to the contact point of the center ray on the cartridge.

FIG. 11 illustrates an exemplary optical design of a cartridge 202 in relation to an excitation mechanism 1006. By way of example, excitation mechanism 1006 can be a Sanyo DL-7140-201W laser diode having an 8° full-width half-maximum (FWHM) divergence angle. Diode 1006 can be set back 1.5 mm from an edge 1102 of cartridge 202, and can point to cartridge 202 with a 69° angle (θ₅). Cartridge edge 1102 can have an angle (θ₃) of 82°. The angle of the center ray from excitation mechanism at measurement zone 1108 is θ₄. The differing angles can prevent specular reflections from entering diode 1006. In FIG. 11, solid lines 1104 emanating from diode 1006 represent the FWHM angle, while dashed lines 1106 represent twice the FWHM angle. 84% of the optical power can be within the FWHM, while 99.5% of the optical power can be within twice the FWHM angle. Light outside twice the FWHM angle can be designed to miss the optical entrance of cartridge 202 because its angle would not totally internally reflect in measurement zone 1108. Measurement zone 1108 can be 1 mm across, well within the FWHM of 1.6 mm. Fluorescent light from measurement zone 1108 can be detected after traveling through cartridge 202. Cartridge 202 can comprise a lens 1110, such as a Fresnel lens, operative to help collect, collimate, and/or focus the light before it reaches the light detection mechanism.

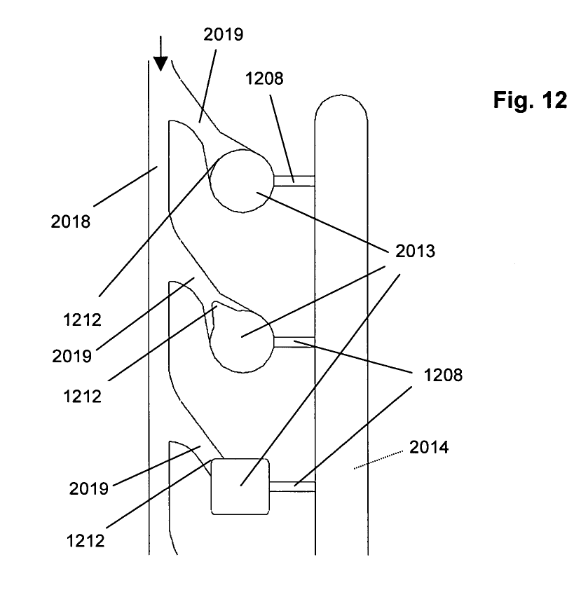

FIG. 12 illustrates a partial top view of an exemplary cartridge 202 for receiving a sample. In one aspect, cartridge 202 can require less than or equal to 0.25 ml of fluid. A sample can enter an incubation zone through sample distribution channel 2018 in the direction of the arrow. From the sample distribution channel 2018, the sample can fill one or more incubation zones 2013 via flow passageway 2019.

Sample distribution channel 2108 and flow passageway 2019 can have a small thickness to increase capillary forces, increase hydrodynamic resistance, and to reduce sample volume not in incubation zones 2013. Exemplary thicknesses include 10 μm, 20 μm, 50 μm, 75 μm, 100 μm, 125 μm, 150 μm, 200 μm, and 300 μm. Other thicknesses in between the specified values are contemplated. Thicknesses less than 10 μm and greater than 300 μm are also contemplated. Each incubation zone 2013 can have a different thickness than sample distribution channel 2018 and flow passageway 2019, and can have different thicknesses from each other. Each incubation zone 2013 can be, for example, 5 mm, 3 mm, 2 mm, 1.5 mm, 1 mm, 0.75 mm, 0.5 mm, or 0.25 mm or less, respectively, in diameter. After filling incubation zone 2013, the sample can travel through flow passageway 1208.

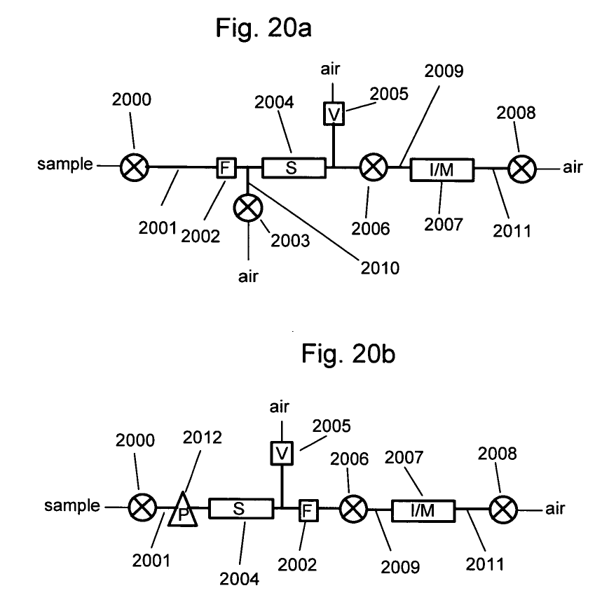

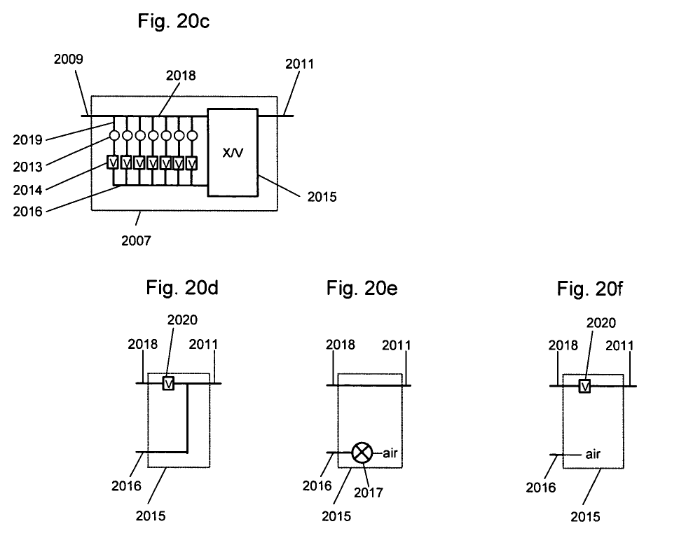

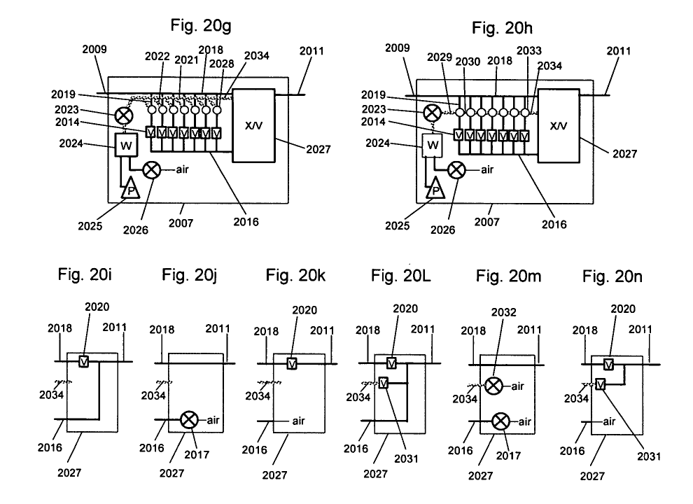

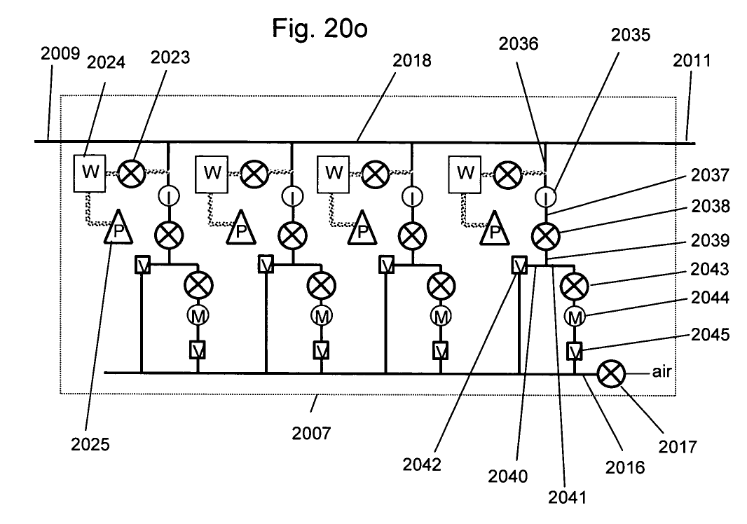

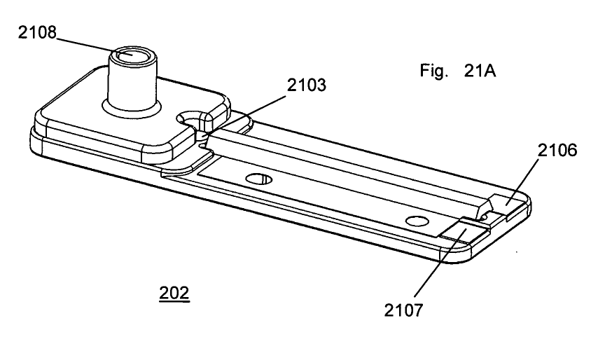

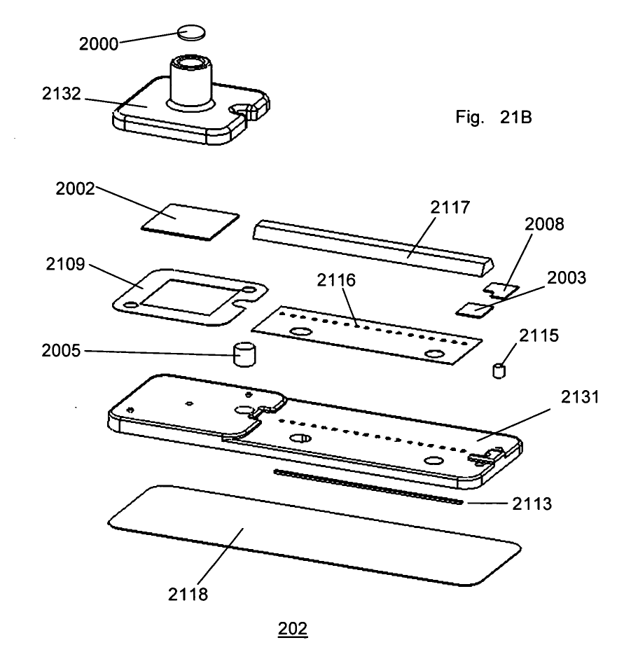

Incubation zones 2013 can have many shapes, three of which are shown in FIG. 12. Rectangular, or substantially rectangular, and circular, or substantially circular, cross-sections may match the geometry of a light detector used in the measurement of a label in the incubation zone. When incubation zones 2013 are thicker than flow passageway 2019, there can be capillary forces resisting the flow into the incubation zones. In some instances transitions 1212 into the incubation zone such as the one depicted in FIG. 12 offer advantages. The transition 1212 generates capillary forces to pull the liquid over the edge of the incubation zone and down that edge of the incubation zone to the bottom of the incubation zone. Such transitions 1212 assist in well filling and avoid trapped air in the incubation zone. Similarly, controlling the width of the incubation zone's 2013 opening in the direction of flow versus depth of the incubation zone geometry can also be used to avoid trapped air. Controlling these dimensions with respect to fill rates allows the fluid sufficient time to flow to the bottom of the incubation zone and fill upward before completely flowing over to passageway 1208 avoiding trapped air. Passageway 1208 can be resistive in order to slow the passageway of liquid through incubation zone 2013. Depending on the detection method, the measurement zone may be all or a portion of the incubation zone 2013. In some embodiments, passageway 1208 can be 500 μm×500 μm or less in cross section (e.g., 125×125, 100×100, 75×75, 50×50, 30×30, 20×20, 10×10 μm, or non-square cross sections of similar dimensions) and 20 mm or less long (e.g., 10, 5, 3, 2, 1, or 0.5 mm). A capillary transition can occur at the end of passageway 1208 as the sample enters vent 2013. If cartridge 202 is evacuated, vent 2013 can enable complete filling of incubation zones 2013. If cartridge 202 is not evacuated, vent 2013 can be configured as shown in FIG. 20.

Consistent with the principles disclosed herein, cartridge 202 can be operative to capture analytes contained in a sample on or near a detection surface in order to perform an assay. Cartridge 202 can capture the analytes through a number of techniques known in the art, including but not limited to surface capture and magnetic bead capture. Regardless of the technique used to capture sample analytes, dried calibrators can be located such that the probability of a calibrator analyte reaching the capture zone is the same as that of a sample analyte reaching the capture zone.

If surface capture is utilized, for example with a capture antibody, the capture antibody can be linked to the portion of cartridge 202 that serves as the total internal reflection surface. Dried, labeled antibody can be contained in cartridge 202 near the capture antibody, such that the dried, labeled antibody is rehydrated when a sample is inserted into cartridge 202. Because the capture antibody cannot diffuse, the reaction rate may be slow A reasonable fraction of the analyte can be bound nevertheless, by (1) decreasing the diffusion distance by geometrically shaping the incubation zone and measurement zones by increasing the diameter of incubation zone 2013 (assuming a cylindrical shape, increasing the area of the TIRF surface more generally) while keeping the incubation volume constant, (2) decreasing the diffusion distance by convectively transporting the fluid, and/or (3) increasing the diffusivity by, for example, increasing the temperature and/or decreasing the viscosity of the fluid.

If magnetizable capture bead capture is utilized, the capture antibody can be linked to the magnetizable capture bead. The beads, which can be 0.1 μm in diameter, can diffuse and interrogate the entire sample volume dedicated to the test with which the beads are associated. The beads can be drawn down to the surface for detection by the apparatus.

The material forming interface 204 of cartridge 202, which allows the apparatus to interact with the sample without physically contacting it, can vary depending on the assay technique employed by instrument 100. Particularly when instrument 100 employs a fluorescent assay, the refractive index of the material forming interface 204 is a factor to be considered. A large refractive index provides (i) better collimation of incoming light, a larger range of TIR angles; (ii) potentially more robustness to materials in the sample and surface imperfections; (iii) and possibly more options for other materials comprising cartridge 202. Possible materials for interface 204 include but are not limited to polyetherimide (Ultem®), polycarbonate, polystyrene, polypropylene and polymethylmethacrylate (acrylic). While Ultem® possesses a large refractive index (1.66), a greater amount of light entering Ultem® can be scattered. Acrylic, while having a lower refraction index than Ultem® (1.488), can allow much less scattering. Non-optical components of cartridge 202 can comprise a variety of materials, including but not limited to polypropylene, perfluoroalkoxy, polyvinylidene fluoride, cellulose acetate butyrate, acrylic, methyl-methacrylate (Lucite®), polyethylene terephthalate (PET), nylon, polyethylene terephthalate glycol (PETG), styrene acrylonitrile (SAN), polycarbonate, polyurethane, polyetherimide (Ultem®), and SLX polycarbonate co-polymer (Lexan®).

P. Calibration and Quality Control

In some embodiments, instrument 100 can perform self-tests. In some embodiments that use light emitters and light detectors, the operation of these devices can be used to test one another. In some embodiments that use temperature sensors and temperature controllers, the operation of these devices can be used to test one another.

Quality Control (QC) cartridges that simulate measurements can also be used. A QC cartridge can contain electronics to simulate electrical measurements, light emitters to simulate light-emitting labels, and/or fluorescent structures to simulate fluorescent assay techniques.

The instrument can also perform test calibrations, such as positive and negative controls. Additionally, the instrument can perform self-test controls in cartridge 202, such as detecting reagents and the expiration of substances contained in therein.

In certain embodiments, instrument 100 can perform a calibration in order to provide a context in which to evaluate the results of a test. Instrument 100 can perform a calibration in accordance with various techniques known in the art, or using a combination thereof. For example, calibration can be performed through the method of standard addition or the bound fraction method.

Using the method of standard addition, a known amount of the analyte of interest or an analog of the analyte of interest can be added to a number of measurement zones of a cartridge at the time of manufacture. Different amounts of the analyte of interest or an analog of the analyte of interest can be added to each measurement zones in order to construct a signal versus concentration curve. Fewer calibration measurements, possibly as few as one or two, can be made if the calibration curve is simple (e.g. linear) or the variation in the curve among samples and environmental conditions is limited or predictable. More measurements, possibly between three and five, can be made if the test is significantly affected by varying samples in non-trivial ways. The number of measurements to be performed can be evaluated at the time of calibration, based on the data received as each measurement is taken. The method of standard addition is limited in that the concentration values of data points used to reconstruct the mathematical curve are not known or selectable. Instead, only the difference is known and selectable.

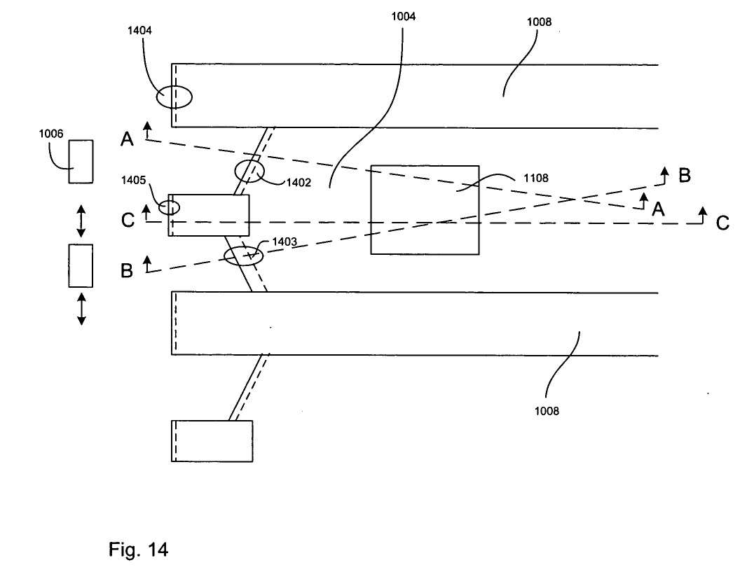

Using the bound fraction method, separate measurements of the bound and unbound label can be performed. For example, TIRF can be used to measure the bound label, and total volume fluorescence can be used to measure the unbound label. The discussion below in regard to FIG. 14 describes an exemplary embodiment. Knowing the total measurement zone volume, the total amount of the label, and the fraction of the analyte bound, the analyte concentration can be computed. At the time the bound fraction method is performed, a practitioner can determine whether another calibration method should also be performed, such as a reduced quantity of measurements using the standard addition described method.

In some embodiments, lot calibration by the manufacturer, encoded on the cartridge or an information sheet accompanying the cartridge or kit of cartridges and transmitted to the instrument, is sufficient to convert label measurements into analyte concentrations.

In some embodiments, cartridge 202 comprises one or more controls to verify proper calibration.

Q. Separation Filters

Consistent with the principles of the embodiments disclosed herein, calibration can be performed based on whole blood concentrations, or calibration can be corrected to plasma volumes through a number of techniques known in the art. For example, cartridge 202 can comprise a separation filter (2002) operative to prevent red blood cells from entering the analyte measurement zones. Alternatively, the hematocrit can be measured optically or via electrical conductivity. In some embodiments, separation filter 2002 is not used.

Separation filter 2002 can have differing pore size rating, depending on the embodiment. For example, 0.2 μm separation filters may be used to exclude viruses and larger particles. A 1 μm separation filter may be used to exclude spores and larger particles. A 3 μm separation filter may be used to exclude red blood cells and larger particles. A 5 μm separation filter may be used to exclude dirt particles and larger particles.

A separation filter may block at least 90% of the particles whose characteristic dimension is greater than the filter's pore size rating. In some embodiments, instrument may use a separation filter device with a pore size rating of 0.05, 0.1, 0.2, 0.5,1, 2, 3, 4, 7, 10, 15, 20, 50, or 100 μm to remove interfering components of the sample matrix. In further embodiments, the instrument may use a separation filter having a pore size rating ranging from 0.1 μm to 4 μm; from 0.02 μm to 0.1 μm; from 4 μm to 100 μm; and from 1 μm to 3 μm.

In whole blood samples, a fibrous web filter can be used as a size exclusion matrix. Plasma can move through this matrix without significant restriction; however, particles above a certain size have impeded flow. The fiber size and spacing between fibers can be designed to impede particles such as the cellular components in blood. The movement of red blood cells (RBC) can be slowed down, but not trapped or immobilized. This would prevent shear-induced lysis of the RBCs. White blood cells (WBC) are known to be very sticky and adhere to the fibrous media. Platelets may not be significantly impeded. Smaller objects like bacteria, viruses, proteins, or protein complexes move freely through the fibrous matrix.

An asymmetric pore membrane blood separation filter may be used to remove cellular components from whole blood samples and generate plasma for analysis. This type of separation filter has the pores change size across the thickness of the filter; from larger than blood cells to smaller than blood cells. For example, one side of the filter would have pores 10 microns in size, while the other side would have pores 1 micron in size, and the separation filter as a whole has a pore size rating of 1 μm. Since the pore size changes gradually, the cellular components are not subjected to large shear forces and become trapped in a transition layer without lysing. The filter region with smaller pores become enriched with plasma and depleted of cellular components.

The asymmetric pore membrane blood separation filter has advantages over fibrous web separation filters in the amount of area needed to separate plasma, particularly if the volume of plasma needed is small. The asymmetric pore membrane blood separation filter can be considered a dead end separation filter in which cellular components are trapped within the separation filter and plasma can flow out of the membrane. Thus, this type of membrane can be highly efficient until the amount of trapped cells clogs the pores and slows flow to very slow rates. Therefore, plasma yields are a function of separation filter surface area and level of clogged pores.

Conversely, the fibrous web separation filters use a wicking based size exclusion chromatography to effect plasma separation, in which the cellular components will eventually wick out of the separation filter. The amount of plasma generated will be a function distance wicked through this type of separation media.

Analysis of the plasma sample generated by filtration-based separation has usually been done within the separation filter, or wicked into an adjacent matrix. This invention contemplates, however, the removal of the filtrate from separation filters so that it can flow into channels, or passageways, that lead to measurement zones. This flow can be driven by capillary wetting of new surfaces or assisted by an external pressure gradient. The external pressure gradient increases flow rates and, if controlled within known parameters, can be used to recover plasma out of the separation filter without contamination by blood cellular components or the lysed contents of these cells.

The controlled use of pressure has defined ranges of action. When no pressure gradient is applied, only wicking type flow occurs, which is driven by the ability of the plasma to wet the channel surface but limited by viscous drag forces or wetting rates. Surface modifications can enhance wicking base flow rates, which then may be sufficiently fast for some embodiments.

As the pressure gradient is increased, flow rates typically increase, but fluid may not flow out of a separation filter. To induce fluid flow out of the filter, the pressure gradient must be above a minimal value, which can be called the flow pressure point. This minimal value is a function of fluid surface tension and effective pore size. As the pressure gradient is increased above the flow pressure point, fluid can flow out of the filter, if fluid is available to flow in.

The values for the flow pressure point can vary according to the separation filter type and construction. In the case of fibrous webs, the pressure can range from 0.1 psi to 1.5 psi. In the case of asymmetric pore membranes, pressures to induce flow can be smaller due to thinner filter dimensions and may include pressure ranges found in venous blood sampling methods.

Below a pressure level called the bubble point, flow will stop when all the fluid available to flow in has entered the separation filter. If the blood sample is a defined volume, then this property can be part of a control method to stop plasma flow at defined distance down stream of a separation filter. At pressures above the bubble point, air can enter the wetted filter and displace the contents. The values for the bubble point can vary, dependent on filter construction, fluid surface tension, fluid viscosity, and can range from 5 psi to 10 psi. High pressure gradients can impart high shear forces on the blood sample and cause lysis of the red blood cells. Therefore, pressure gradients can range from 0.01 psi to 5 psi, dependent on time constraints, plasma yield volumes, and red blood cell lysis.

Typically, particles smaller than the separation filter's pore size rating pass through a separation filter without hindrance, unless they are adsorbed to the filtration media. To prevent non-specific adsorption, filtration media can be surface-modified to reduce this type of interaction, e.g., by making the separation filter surface more wettable, i.e., more hydrophilic. It is generally believed that non-specific binding of analyte (that results in loss of recovery) is due to hydrophobic interactions, primarily through van der Waals type bonds. For example, coating the filtration media polyethersulphone (PES) with hydrophilic compounds like glycerol increases the ability of water to wet the surface and reduces analyte loss. The coating agent can also be a protein. A common blocking protein would be bovine serum albumin (BSA), which can be dried onto the surface. Other blocking agents include non-ionic detergents like Tween-20, Thesit, polyoxyethylene 9 lauryl ether, or alkyl-glucopyranoside.

Other methods to reduce non-specific absorption include, but are not limited to; free radical polymerization, ion beam initiated polymerization, ionizing radiation induced polymerization, plasma etching, and chemical coupling. These processes incorporate molecules with a significant number of hydroxyl groups that promote water hydration and reduce hydrophobic interactions. The specific method of surface modification depends primarily on the chemical nature of the filtration material used in the separation filter device. For example, ionizing radiation can be used to induce grafting of hydroxy-propyl-acrylate moieties onto nylon filtration media to render it hydrophilic and low protein binding. In some embodiments, the invention uses filtration media comprising the polymer polyethersulphone. In some embodiments, the polyethersulphone is coated with glycerol to render the surface wettable with water and to reduce analyte loss.

In some embodiments, filters can have chemical moieties attached to the surface to specifically bind interfering components. The filtration media can be covalently coupled to molecules that have high affinity interactions with classes of molecules that are known to interfere with the immunoreaction or the detection methodologies. For example, molecules like lectins, which bind to surface groups on red blood cells, or ethylenediaminetetraacetic acid (EDTA), which binds metal ions that could interfere with the detection process, can be attached to the filtration media.

R. Exemplary Instrument

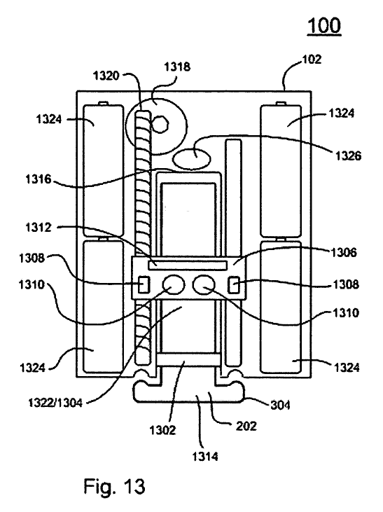

FIG. 13 is a top view of an exemplary instrument 100 with cartridge 202 plugged into housing 102, with an upper portion of housing 102 omitted. Cartridge 202 can be plugged into housing 102 before a sample is inserted therein. Alternatively, a sample can be inserted into cartridge 202 before cartridge 202 is plugged into housing 102. In some embodiments, as cartridge 202 is inserted, a magnetic strip (not pictured) located thereon can be read by a magnetic strip reader 1302. As discussed in detail above, the magnetic strip can transmit information regarding the sample, the history of cartridge 202 and/or a particular diagnostic test(s) to instrument 100. In the embodiment illustrated in FIG. 13, plugging cartridge 202 into housing 102 completes a “light tight” enclosure, preventing ambient light from entering instrument 100. End 1314 can comprise opaque surface 302 to complete a light-tight enclosure along with housing 102 to protect light detection mechanism 1310 from ambient light.

After cartridge 202 is inserted into housing 102, a heater 1304 can warm the sample contained in cartridge 202. Heater 1304 can be triggered by the insertion of cartridge 202 into housing 102 or, if cartridge 202 receives the sample after insertion into housing 102, by the insertion of a sample into cartridge 202. In certain embodiments, instrument 100 can comprise an optical bench 1306 comprising a mechanism operative to monitor the process of the sample through cartridge 202 and can notify the user through one or more of the techniques described above when incubation is complete and the diagnostic test can be performed. During the incubation process, any phosphorescence from cartridge 202 can decay, preventing such ambient phosphorescence from interfering with test results.

In some embodiments, instrument 100 can comprise a light source 1308, a light detection mechanism 1310 and a magnet 1312. As pictured in FIG. 13, light source 1308, light detection mechanism 1310 and magnet 1312 can be located adjacent one another on optical bench 1306. In addition to measuring the light emitted from the measurement zones of cartridge 202, light detection mechanism 1310 can be operative to detect when the sample has completely filled the measurement zones of cartridge 202. Magnet 1312 can be operative to attract label-containing beads, for purposes described above, to a measurement zone. Magnet 1312 can be movable so that it can have either minimal or substantial field strength in the incubation region of instrument 100, depending on its position relative to the incubation region. Magnet 1312 can be positioned such that its field strength is minimal during incubation so that capture antibodies can freely move around and participate in binding reactions. Magnet 1312 can be positioned such that its field strength is substantial after incubation in order to bring captured complex to the measurement zone.

As pictured in FIG. 13, the respective ends 1314 and 1316 of cartridge 202 can be free of measurement zones. End 1314 can be devoted to interfacing with a sample collection system (not pictured), and can also be out of the reach of magnet 1312. End 1316 can be devoted to a mechanism (not pictured) to assist the sample to flow into the respective incubation zones.

In various embodiments, instrument 100 can comprise a mechanism to move optical bench 1306, such as a motor 1318. Motor 1318 can drive a lead screw 1320, on which optical bench 1306 can be mounted. In this manner, optical bench 1306 can be driven along the length of a measurement area 1322, which can comprise a plurality of measurement zones (not pictured).

In order to power motor 1318, as well as the other components of instrument 100, one or more local energy storage devices 1324 can be provided. In various embodiments, energy storage devices 1324 can comprise one or more batteries, such as AA 3.6V, 750 mAh, lithium-ion batteries. In specific embodiments, energy storage devices 1324 may comprise one, two, three, or four batteries. In some embodiments, instrument 100 can be equipped with enough battery life to allow it to perform testing on at least four samples without changing or recharging its batteries.

In some embodiments, instrument 100 can also comprise a mechanism 1326 to detect and retain cartridge 202 in housing 102. Mechanism 1326 can be operative to release cartridge 202 upon engagement of a triggering mechanism.

In certain embodiments, instrument 100 can be operative to capture analytes of interest, as well as any other calibrators or substances needed to perform a test, in 190 seconds. In some embodiments, instrument 100 can be operative to detect and/or quantify the presence of an analyte of interest in the sample within 150 seconds after capture. Accordingly, consistent with the principles of the present invention, results of a test can be displayed to the user within 340 seconds after inserting a sample into cartridge 202.

S. Exemplary Optical Configurations

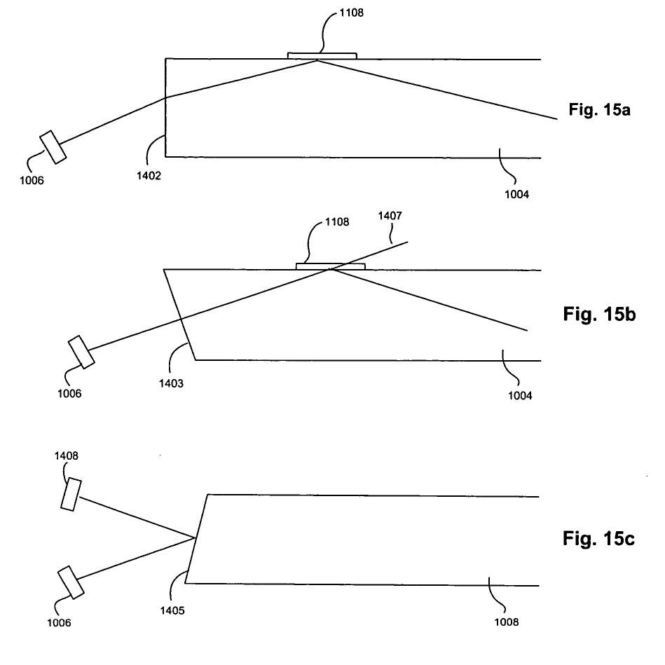

In certain embodiments, as illustrated in FIGS. 14, 15A, 15B and 15C, instrument 100 can be adapted to perform both TIRF and whole-volume fluorescence, allowing the ratio of free label to bound label to be calculated. Interface 204 of cartridge 202 can comprise a TIRF-entrance surface 1402 and a whole-volume entrance surface 1403. Each light path 1004 can be separated by a light barrier 1008, which can comprise a reflector surface 1404. A reflector surface 1405 can separate the TIRF-entrance surface 1402 and the whole-volume entrance surface 1403. Light source 1006 can be positioned such that emitted light enters TIRF-entrance surface 1402. The angles of TIRF-entrance surface 1402 and whole-volume entrance surface 1403, in both the horizontal and vertical dimensions, can be predetermined so as to achieve the desired TIR or whole-volume illumination, respectively.

Referring now to FIG. 15A, light entering TIRF-entrance surface 1402 can be totally internally reflected so that only the TIR surface is illuminated. Light source 1006 can also be positioned such that emitted light enters whole-volume entrance surface 1403 (FIG. 15B). A portion of the light entering whole-volume surface entrance surface 1403 is reflected, but a ray 1407 is transmitted, illuminating the whole volume of the reaction region.

Instrument 100 can use reflector surfaces 1404,1405 to track the position of light source 1006 and determine which measurement zone 1108 is illuminated. As illustrated in FIG. 15C, when light emitted from light source 1006 is reflected from reflector surface 1405, it can be captured by a light detector 1408. Instrument 100 can be operative to keep track of the number of reflector surfaces 1404, 1405 encountered, thereby enabling instrument 100 to determine which measurement zone 1108 is illuminated at any given time.

T. Exemplary Cartridge

FIG. 16 illustrates an exemplary cartridge 202 consistent with the principles of the present invention. The 1 cm scale bar is only an example of the size that cartridge 202 and its components can be. While FIG. 16 depicts a cartridge 202 adapted to receive a fluid sample, it is recognized that cartridge 202 can be adapted to receive numerous varieties of sample. A sample can enter cartridge 202 through valve 2000 (e.g., a pierceable seal), which can be the sample collection system 502 of cartridge 202. After passing through valve 2000, sample can enter storage zone 2004, which can contain a separation filter 2002. In certain embodiments, separation filter 2002 can comprise pores ranging from 0.2 μm to 5 μm in diameter; from 1 μm to 4 μm in diameter, or from 2 μm to about 2 μm in diameter.

Cartridge 202 can comprise a valve 2006 operative to prevent sample from flowing into sample distribution channel 2018 until the user desires to begin testing the sample. The barrier effect of valve 2006 can be overcome by instrument 100 in order to force the sample into sample distribution channel 2018. For example, cartridge 202 can comprise flexible walls in the region of storage zone 2004, allowing instrument 100 to apply enough pressure by squeezing the walls inward to force the sample through valve 2006. In certain embodiments, an electrode (not pictured) can be located in storage zone 2004 and can be triggered by the user to boil or electrolyze a portion of the sample. The heightened pressure occurring due to the transformation of the liquid to gas can force the sample through valve 2006.

After entering sample distribution channel 2018, sample can flow into incubation zones 2013. Sample can exit each incubation zone 2013 through passageway 1208. Passageway 1208 can be configured to slow the flow of sample through incubation zone 2013 to enable uniform filling of all incubation zones 2013. Incubation zones 2013, as well as the fluidic passageways leading to and from zones 2013, can be designed such that reagents contained therein cannot be diffusively or convectively transported to another incubation zone in less than or equal to 20 minutes. Incubation zones 2013 can be 2 mm or less in diameter or 1 mm or less in diameter. Sample exiting incubation zones 2013 through passageways 1208, as well as sample that never entered incubation zone 2013, can flow into flow passageway 2011, which may or may not be evacuated. Like passageway 1208, flow passageway 2011 can be configured to slow sample flow from sample distribution channel 2018 into flow passageway 2011. Cartridge 202 can be provided with exit feature 1608. Exit feature 1608 can be omitted if flow passageway is evacuated. Exit feature 1608 can be valve 2008 (FIG. 20B) to help control the flow of sample into the incubation zones 2013. Exit feature 1608 can also be vent 2020 (FIG. 20D) to release air from cartridge 202 as it fills with sample.

Cartridge 202 can comprise a mating feature 1610 that can engage mechanism 1326 of instrument 100 to retain cartridge 202 in housing 102 after insertion. Cartridge 202 can also comprise a flange 1612 operative to prevent ambient light from entering housing 102 after insertion of cartridge 202.

U. Fluidic Architectures

While FIG. 16 shows one exemplary cartridge 202 and its associated fluidic architecture, FIGS. 20A and 20B illustrate exemplary fluidic architectures in isolation that are consistent with the principles of the present invention. Turning to FIG. 20A, the sample enters the cartridge through valve 2000 into flow passageway 2001. Valve 2000 can be, for example, a needle pierceable membrane that reseals after removal of the needle. Alternatively, valve 2000 can be a needle, or it can be an opening that is optionally adapted to receive a needle. Alternatively, valve 2000 may be omitted and sample enters directly into flow passageway 2001. The sample entry zone comprises flow passageway 2001 and (when present) valve 2000. Flow passageway 2001 is in fluidic connection with optionally-present separation filter 2002. Separation filter 2002 is optionally configured to be a blood separation filter as described supra. Optionally-present valve 2003 is located between separation filter 2002 and storage zone 2004. Vent 2005 is located downstream of storage zone 2004 and may act as a sample fill indicator configured to provide visual indication to the operator that the cartridge has received sufficient sample. Some embodiments use a sample fill indicator that is separate from vent 2005. Optionally-present valve 2006 and/or valve 2008 prevent sample from flowing from storage zone 2004 into incubation/measurement zone 2007 until after the cartridge is placed in instrument 100 so that instrument 100 can control the incubation time.

Valve compositions can vary depending on the method of opening and whether they are required to return to their initial state; in some embodiments, valves 2003, 2006, and 2008 (when present) are only required to open once. Valves 2003, 2006, and 2008, when present, can be individually chosen to be based on capillary forces, a sealed membrane that is pierced by instrument 100 (e.g., mechanically piercing or optically piercing via a light source such as a laser), or a mechanical block that is removable by instrument 100 (e.g., meltable wax or a moveable membrane), or other valve types that can be opened, for example, by slitting, piercing/puncture, breaking/fracturing, buckling, tearing, busting/ripping, peeling, melting, environmental stress cracking with strain and chemical exposure, dissolving and or etching, dielectrically breaking down, removal of a seal, ultraviolet material degradation, exploding, and rapid oxidization to induce mechanical failure under strain. Valves 2000, 2003, and 2008, when present, open to the atmosphere.

Fluid transport from storage zone 2004 into incubation/measurement zone 2007 can be driven by capillary forces. Greater or lesser capillarity of a flow passageway over another flow passageway in-fluidic connection can be set be according to fundamental principles of surface tension and surface free energy (see Physical Chemistry of Surfaces, 6^{th} edition, Adamson & Gast, John Wiley & Sons, 1997). For brevity, if two flow passageways have the same surface free energy and different hydrodynamic radii, then liquid can flow from the larger to smaller radius flow passageway.

Yet another exemplary embodiment is illustrated in FIG. 20A. The sample enters the cartridge through valve 2000, which is a needle-pierceable membrane, and into flow passageway 2001. The cartridge is filled by a needle connecting a donor's vein to the cartridge. Venous pressure, as assisted by proper use of a tourniquet, can drive blood through separation filter 2002, allowing plasma to collect in storage zone 2004. After storage zone 2004 fills, plasma causes vent 2005, which advantageously also acts as a sample fill indicator, to visually change. During this filling process, the displaced gas is vented through vent 2005. After vent 2005 has contacted plasma, flow through the indicator stops (e.g., because the vent is a hydrophobic frit). Valve 2006 is not present. Valve 2008 is closed, preventing plasma from reaching incubation/measurement zone 2007, although there is some flow into flow passageway 2009 to generate gas pressure to resist the pressure driving the flow. Incubation/measurement zone 2007 can comprise one or more incubation and measurement zones. When the operator sees the visual change in vent 2005, the operator removes the needle and inserts the cartridge into instrument 100. Instrument 100 opens valves 2003 and 2008, enabling plasma to flow from storage zone 2004 into incubation zone 2007, via for example, capillary action.

In some embodiments, greatly simplified fluidics can be used. For example, sample can directly enter flow passageway 2001, and flow passageway 2001 directly connects to incubation/measurement zone 2007. Flow passageway 2011 connects to air. Not present are valves 2000, 2006, and 2008; separation filter 2002, storage zone 2004, vent 2005, and associated flow passageways. In some of these cases, cartridge 202 can be placed into instrument 100 before sample enters the cartridge. Thus, instrument 100 can measure the incubation time by measuring when the sample enters. In some of these cases, the incubation time after cartridge 100 is placed in instrument 100 is sufficiently long that equilibrium is sufficiently close that a variable time outside the instrument does not significantly changes results. In some of these cases, calibration measurements, which since on the same cartridge have similar incubation times, can be used to correct for variable and uncertain incubation times.

In some embodiments, separation filter 2002 can be omitted.

FIG. 20B shows another exemplary fluidic architecture. In this architecture, when compared to FIG. 20A, pump 2012 has been inserted just operatively downstream of flow passageway 2001, valve 2003 and flow passageway 2010 are removed, and separation filter 2002 has been moved operatively downstream of vent 2005 and before valve 2006. In this architecture, separation filter 2002 does not impede flow into storage zone 2004. Thus, reduced pressures and/or reduced times are needed for a sample to fill storage zone 2004. Pressure to drive sample across separation filter 2002 and into incubation/measurement zone 2007 can come in part from pump 2012. Valves 2006 and 2008 may both be omitted, if separation filter 2002 is sufficiently hydrophobic or sufficiently resistive as to act similar to valve 2006, in preventing filtrate from entering incubation/measurement zone 2007 until action by instrument 100. In some embodiments only one of valves 2006 and 2008 are present. With embodiments of pump. 2012 that allow retrograde flow, valve 2000 can be operative to prevent substantial retrograde flow. Pump 2012 can be a mechanically-based pump, created for example by displacing a flexible membrane that contacts the sample. Alternatively, Pump 2012 can be electrochemical in nature, generating hydrogen and/or oxygen gas to provide a pressure to move the sample. The rest of the fluidic architecture in FIG. 20B is sufficiently similar to FIG. 20A that additional description would merely be duplicative and is therefore omitted.

FIG. 20A and 20B both have incubation/measurement zone 2007, which is expanded in some detail in FIGS. 20C, 20G, 20H and 20O. In all these figures, liquid enters through flow passageway 2009 and leaves through flow passageway 2011.

Incubation/measurement zone 2007 comprises at least one incubation zone. In some embodiments, incubation/measurement zone 2007 can comprise at least one measurement zone. In other embodiments, incubation/measurement zone 2007 may not comprise a measurement zone.

1. Incubation/Measurement Zone 1

FIG. 20C shows an exemplary fluidic architecture of incubation/measurement zone 2007 in greater detail. Flow passageway 2009 is in fluidic connection to sample distribution channel 2018. Sample distribution channel 2018 serves to transport sample liquid into the discrete incubation zones 2013 using flow passageway 2019. As exemplified in FIG. 20C (also true but not repeated for brevity for FIG. 20G, 20H, and 20O), the distribution and subsequent filling of sample liquid into the incubation zones occur sequentially and linearly. The distribution and filling may take on forms other then sequential. The distribution channel may have a branched arrangement such that the incubation zones are filled simultaneously. Depending on differences in the capillary and other forces between sample distribution channel 2018 and the incubation zones 2013, sample may first fill all of sample distribution channel 2018 before substantially filling incubation zones 2013. Sample distribution channel 2018 further connects to outlet zone 2015. FIG. 20C shows a plurality (7) of incubation zones, although other numbers of incubation zones are equally possible. The number of incubation zones may be of sufficient number to assay a range of analytes in the sample to cover a panel. For example, an assay cartridge for a thyroid panel may have two incubations zones; one for thyroid stimulating hormone and one for thyroxine. Alternatively, the number of incubation zones is of sufficient number to include a range of analytes and calibrators for each analytes. Other combinations are possible. Each incubation zone holds binding reagents specific for an analyte. This may comprise a binding reagent such as an antibody specific for the analyte of interest, a labeled molecule, and magnetizable capture beads. The composition is preferably dried and occupies a substantial fraction of the incubation volume. Alternatively, the composition is in a liquid form. When sample from flow passageway 2019 enters an incubation zone 2013, it dissolves the assay reagents and initiates the binding reaction. Each incubation zone 2013 fluidically connects to a vent 2014. The sample displaced gas is transported to a vent 2014. The vent allows displaced gas to pass substantially unimpeded and provides a high fluidic resistance for liquids. Each vent is fluidically connected to flow passageway 2016. This flow passageway further connects to outlet zone 2015. Detailed examples of fluidic architectures for outlet zone 2015 are shown in FIGS. 20D, 20E, and 20F. Outlet zone 2015 connects to flow passageway 2011.

2. Outlet Zone 2

FIG. 20D shows one possible outlet zone 2015 fluidic architecture. Sample distribution channel 2018 terminates at vent 2020, which in turn connects to flow passageway 2011. Vent 2020 ensures that sample can not readily leave the incubation/measurement zone 2007 via sample distribution channel 2018. Both inputs to outlet zone 2015 (i.e., 2018 and 2016) connect to flow passageway 2011, enabling the overall architecture shown in FIGS. 20A and 20B to control sample movement.

3. Outlet Zone 3

FIG. 20E shows one possible outlet zone 2015 fluidic architecture. Distribution channel 2018 fluidically connects to flow passageway 2011, while flow passageway 2016 terminates at valve 2017 that is connectable to air. Thus, the combination of valve 2017 and the overall architecture shown in FIGS. 20A and 20B control sample movement.

4. Outlet Zone 1

FIG. 20F shows one possible outlet zone 2015 fluidic architecture. Distribution channel 2018 terminates at vent 2020, which in turn connects to flow passageway 2011. Vent 2020 ensures that sample can not readily leave the incubation/measurement zone 2007 via sample distribution channel 2018. Because flow passageway 2016 connects directly to air, the overall architecture in FIGS. 20A and 20B can not use valve 2008 to prevent flow into incubation/measurement zone 2007.

5. Incubation/Measurement Zone 2

FIG. 20G shows an alternative fluidic architecture for incubation/measurement zone 2007- in greater detail. The fluidic architecture includes all the elements of FIG. 20c and additional elements for-Stoke's wash. Flow passageway 2009 is in fluidic connection to sample distribution channel 2018. The distribution channel serves to transport the sample into the discrete detection chambers 2028 using flow passageway 2019. Flow passageway 2018 further connects to outlet zone 2027. Detailed examples of fluidic architectures for outlet zone 2027 are shown in FIGS. 20I, 20J, 20K, 20L, 20M, and 20N. Outlet zone 2027 connects to flow passageway 2011. FIG. 20G shows a plurality (7) of detection chambers connected to the sample distribution chamber along flow passageway 2019, although other numbers of detection chambers are equally possible. Each detection chamber comprises an incubation zone and measurement zone. Each incubation zone holds a composition comprising binding reagents specific for an analyte. The composition is preferably dried and occupies a substantial fraction of the incubation volume.

Alternatively, the composition is in a liquid form. When sample from flow passageway 2019 enters the detection chambers 2028, it dissolves the assay reagents and initiates the binding reaction. The measurement zone is configured to have lower capillarity than the incubation zone, and the fluidic network 2019, 2018, 2009, and 2004, thus preventing sample flowing from the incubation zone into the measurement zone. For example, the incubation zone and the measurement zone can have similar or the same geometry (e.g., part of the same cylinder), and the dry composition provides the incubation zone with increased capillary forces. Alternatively, a structure in detection chamber 2028 fluidically between the incubation zone and the detection zone has the required lower capillarity to prevent liquid flow from the incubation zone into the measurement zone. Wash liquid 2024 is dispensed by opening valve 2023 and either turning on optional pump 2025 or opening optional vent 2026. Pump 2026 can be electrochemical in nature; generating hydrogen and/or oxygen gas to provide a pressure to move the wash liquid. Valve 2023 can have similar construction to valves 2003, 2006 and/or 2008. For example, wash liquid 2024 may be in a sealed bag or ampoule that is opened/broken by instrument 100. Wash liquid 2024 is dispensed into wash distribution channel 2034. This channel is shown as linearly and sequentially transporting wash liquid to each detection chamber through flow passageway 2022. The distribution and filling of the measurement zone may take on forms other then sequential. The distribution channel may have a branched arrangement such that the measurement zones are filled simultaneously. Each detection chamber is fluidically connected to a vent 2014. The vent allows displaced gas to pass substantially unimpeded and provides a high fluidic resistance for wash buffer 2024. The wash buffer displaced gas is transported through vent 2014 along flow passageway 2016. This flow passageway further connects to outlet zone 2027. The architecture near the detection chambers is exemplified by FIGS. 17C, 17F, 18A, 18B, 18C, 18D, 18E, 18F, and 18G.

6. Incubation/Measurement Zone 3

FIG. 20H shows an alternative fluidic architecture for incubation/measurement zone 2007 in greater detail. The fluidic architecture includes all the elements of FIG. 20c and additional elements for Stoke's wash. Further the fluidic architecture includes elements 2026, 2025, 2024, and 2023 of FIG. 20G to dispense wash buffer. Flow passageway 2029 connects wash buffer to the first detection chamber. Flow passageway 2030 interconnects wash buffer sequentially to each subsequent detection chamber 2033. Flow passageway 2034 connects the last detection chamber in the sequence to outlet zone 2027. Flow passageway 2018 further connects to outlet zone 2027. The architecture near the detection chambers is exemplified by FIG. 19, and the embodiments disclosed in FIGS. 17C, 17F, 18A, 18B, 18C, 18D, 18E, 18F, and 18G could also be adapted to this architecture.

7. Outlet Zones 4-9

FIGS. 20I, 20J, 20K, 20L, 20M, and 20N exemplify possible outlet zone 2027 fluidic architectures. Vent 2020 has a similar operation as in FIGS. 20D and 20F. Flow passageway 2034 can be not connected, so that flow through 2034 stops at or soon after the last detection chamber 2028 (FIGS. 20I, 20J, and 20K). One purpose of extending flow passageway 2034 past the last detection chamber is to try to make the flow into each detection chamber more similar. If the small motion past the last detection due to capillary forces against a closed air volume is insufficient, flow passageway 2034 can be vented and connected to flow passageway 2011 (FIG. 20L and 20N), or it can be independently valved via valve 2032 (FIG. 20M). Alternatively, flow passageway 2034 can terminate at the last detection chamber 2028. Flow passageway 2016, coming from the detection chamber vents 2014, can be directly connected to flow passageway 2011 (FIG. 20I and 20L), independently valved via valve 2017 (FIGS. 20J and 20M), or directly connected to air (FIGS. 20K and 20N). The overall architecture shown in FIGS. 20A and 20B controls sample movement for outlet zones shown in FIGS. 201 and 20L. The overall architecture shown in FIGS. 20A and 20B in combination with valve 2017 (FIG. 20J) or valve 2017 and 2032 (FIG. 20M) controls sample movement for outlet zones shown in FIG. 20i and 20L. Because flow passageway 2016 connects directly to air in FIGS. 20K and 20N, the overall architecture in FIGS. 20A and 20B can not use valve 2008 to prevent flow into incubation/measurement zone 2007 in these embodiments.

8. Incubation/Measurement Zone 4

FIG. 20O shows an exemplary fluidic architecture of an incubation/measurement zone 2007 in greater detail. Flow passageway 2009 is in fluidic connection with sample distribution channel 2018. The distribution channel serves to transport sample liquid into discrete incubation zones 2035 through flow passageway 2036. As illustrated, the distribution and subsequent filling of sample into the incubation zones occurs sequentially and linearly; although other possible forms of distribution applicable in this example include those described for FIG. 20C. Sample flows from sample distribution channel 2018 and displaced air is vented flow passageway 2011 or through valve 2017. Depending on differences in the capillary forces and other forces between the sample distribution channel 2018 and the incubation zone 2035 sample may first fill all of the distribution channel 2018 before substantially filling flow passageway 2036 and incubation zones 2035. A plurality of incubation zones (4) are shown, although other numbers of incubation zones are equally possible. Binding reagents comprising magnetizable capture beads are contained within each incubation zone. The composition and form of binding reagents applicable in this example include those described for FIG. 20C. When sample fills the incubation volume 2035, assay reagents are mixed with the sample, and the binding reaction is initiated. At the end of the incubation time, the magnetizable capture beads can be magnetically collecting onto one surface of the incubation zone using a magnet positioned adjacent to the surface. A free-bound separation operation is performed using elements described for FIG. 20O. Flow passageway 2037 connects each incubation zone with an individual valve 2038. Valve 2038 can take on a number of forms including a capillary stop valve, where sample liquid ceases flow at this element because of lower capillarity. Valve 2038 can be configured to allow passage of gas so that gas displaced during the filling of incubation zone 2035 can be vented. During the time when the assay reagents are mixed and reacting with analyte of interest in the incubation zone, liquid does not flow past valve 2038. Valve 2038 can be opened for liquid flow, for example, by applying a force greater then the fundamental capillary force of valve 2038. Wash liquid 2024 is transported through valve 2023 using pump 2025 in a manor analogous to that described for FIG. 20G. The pressure generated by the pump 2025 can generate the pressure required to open valve 2038. Passageway 2039, initially gas filled, receives sample liquid after pump 2025 is turned on. Passageway 2040 and passageway 2041 can be initially gas filled, and are fluidically connected to passageway 2039. When sample liquid flows from passageway 2039, fluid will first and preferentially flow through passageway 2040 to vent 2042. Passageway 2041 does not allow fluid flow because of valve 2043. Valve 2043 can take on a number of forms including a capillary stop valve. The volume of passageway 2040 can be greater or equal to the incubation zone volume 2035. In this case, sample in the incubation zone is transported into passageway 2040 and wash liquid is transported into and across the incubation zone. During this operation, magnetically held beads remain in the incubation zone. The magnetically held beads, because of the exchange of sample for wash liquid are separated from sample matrix and unbound assay reagents. With the pump continuing to be on, a change in liquid flow direction occurs from passageway 2040 to 2041. The change in flow direction is caused when sample reaches vent 2042, which is configured to pass gas but not liquid (e.g., vent 2042 is a hydrophobic frit). When liquid reaches vent 2042, flow stops and pressure in the liquid increases because of pump 2025. This increased pressure can open valve 2043, causing the flow to change from primarily down passageway 2040 to primarily down passageway 2041. Thus, a controlled volume of liquid can washed over incubation zone 2037 and sent to a waste area before flow is passively redirected. When the fluid flow changes direction the external magnetic field is removed so as to release from the incubation zone the magnetizable capture beads. With continued flow, the washed beads are transported to measurement zone 2044. An external magnetic field can collect the magnetizable capture beads onto a surface of the measurement zone. Flow of wash liquid continues while pump is on or until wash liquid reaches vent 2045. Vent 2045 allows passage of wash buffer displaced gases and impedes flow of wash liquid. Displaced wash liquid gases are transported along flow passageway 2016 and through previously opened valve 2017 to air. For brevity, the applicable outlet architecture for this example is shown as analogous to FIG. 20E but may also be that shown in FIG. 20D or FIG. 20F. Measurement zone 2044 volume can be smaller or larger then the incubation zone volume. The geometry of the measurement zone can be, for example, rectangular, elliptical, cylindrical, and center plan. Detection of bead bound label can occur using an ECL electrode located on the capture surface and a light detector.

V. Exemplary Cartridge

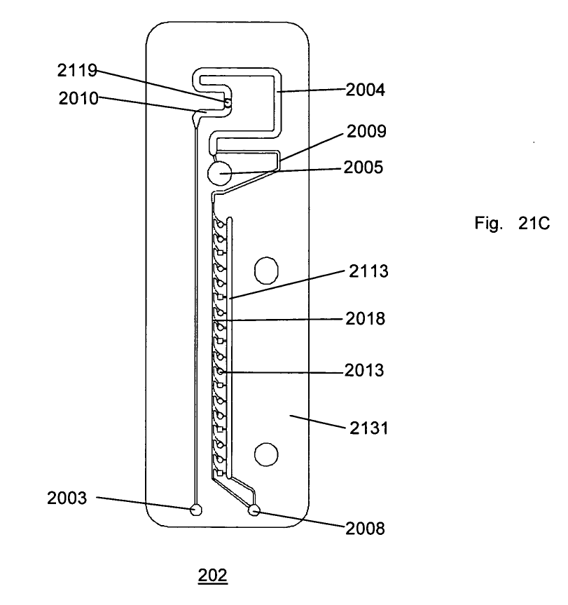

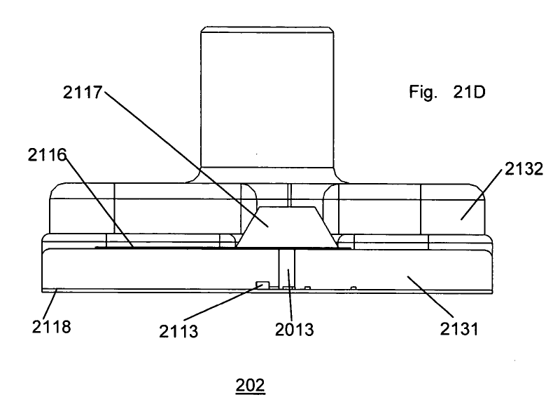

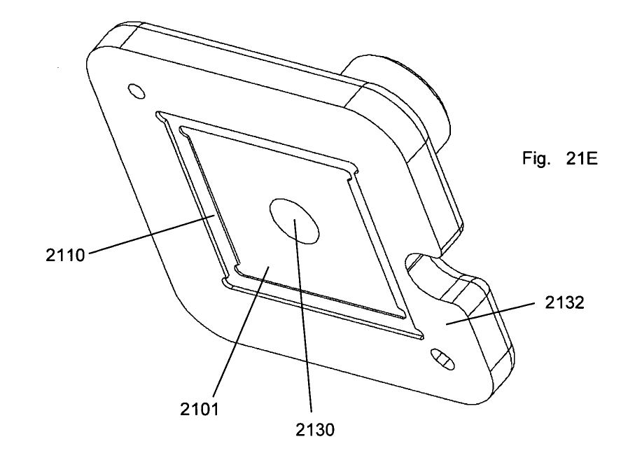

Yet another exemplary embodiment is illustrated in FIG. 21. Cartridge 202 comprises a sample entry zone, filtrate production, liquid volume distribution, transport and metering, reagent mixing, binding incubation, bound-free separation, and bound phase label readout. These combined operations conduct a two-site sandwich immunoassay for a plurality of analytes. The sample can be blood and the filtrate can be plasma.

An optional needle-pierceable membrane 2000 is located in cartridge top 2132. Cartridge top 2132 comprises sample entry zone 2130, which terminates in flow passageway 2101 above separation filter 2102. Flow passageway 2101 and sample entry zone 2130 comprise flow passageway 2001 shown in FIG. 20. If present, needle- pierceable membrane 2000 can be of sufficient thickness or sample entry zone 2130 can have sufficient length or a physical stop so that a needle entering through needle pierceable membrane 2000 does not contact separation filter 2102.

Separation filter 2102 can be an asymmetric pore membrane blood separation filter, having a pore size rating ranging from 0.02 μm to 0.1 μm, from 0.1 μm to 4 μm, or from 4 μm to 100 μm. In a specific embodiment, the pore size rating is 1 μm (e.g., Pall Corp. BTS-SP 300 GT). Separation filter 2102 has an area ranging from 100 mm² to 140 mm². A separation filter having an area of about 120 mm² may yield from 72 μL to 180 μL of plasma. Cartridge 202 requires only about 39 μL of plasma. The additional plasma capacity can increase the rate of plasma formation. Separation filter 2102 is sealed onto the device by crushing the edges (with crush zone 2110) and gasketing (with gasket 2109) to prevent contamination of the plasma with red blood cells. Gasket 2109 can be pressure sensitive adhesive. Crush zone 2110 can be scaled, for example, to compress separation filter 2102, for example, to half its original thickness. In some embodiments, crush zone 2110 compresses separation filter 2102 to 10%, 15%, 20%, 25%, 40%, 50%, 60%, or 80% of its original thickness.

Filtrate operatively coming from separation filter 2102 enters fluidic passageway 2119 before branching into flow passageway 2010 and storage zone 2004. Flow passageway 2010 terminates at valve 2003. Storage zone 2004 is fluidically connected to vent 2005 and flow passageway 2009. Flow passageway 2009 is ultimately fluidically connected to valve 2008. In operation, valve 2008 and valve 2003 are initially closed; thus, air in cartridge 202 operatively downstream of separation filter 2102 escapes through vent 2005 when sample enters cartridge 202 via sample entry zone 2130.

Valve 2003 and valve 2008 in FIGS. 21A-21E may be 0.005″ Kapton tape film that can be opened, for example, with a sharp implement.

In some embodiments, filtrate fills storage zone 2004 and part of flow passageways 2010 and 2009. Fluid flow stops when the gas pressure downstream in flow passageway 2010 and flow passageway 2009 equals the forces causing liquid to enter cartridge 202. These forces can result from capillary forces in flow passageway 2010 and flow passageway 2009 as well as external filling forces, such as the cardiovascular system of an animal (e.g., a vertebrate, a reptile, a bird, a mammal, or a human) to which cartridge 202 is connected. Alternative filling forces include pressure from a syringe and gravitational pressure heads. The embodiments for cartridge 202 illustrated in FIGS. 21A-21E are designed for a maximum of 3 psi filling force, which is approximately 1.5 times the mean arterial pressure of a human (see, for example, Cardiovascular Physiology, 6^{th} edition, Berne and Levy, Mosby Year Book, 1992). Cartridge 202 has 42 μL of compressible air operatively downstream of vent 2005, so that flow passageway 2009 has been sized at 7 μL. Storage zone 2004 and the expected filled portion of flow passageway 2010 are scaled to have orily moderate capillary forces while ensuring that liquid will completely span the cross-section (unlike, for example, a sewer pipe). In this embodiment, they are 1 mm by 1 mm. Flow passageway 2009 has increased capillary forces by reducing the width of the channel from 1 mm to 0.3 mm.

Valves 2003, valve 2008, and vent 2005 form a sample flow control apparatus. This apparatus regulates the flow of sample from the storage zone to the incubation zone. Sample can be put in the cartridge, and filtrate can be formed while the cartridge is outside the instrument that will use the cartridge. By the instrument controlling the actuation of valves 2003 and 2008, the instrument can determine when the filtrate contacts binding reagents located in incubation zones 2013. Thus, the instrument can measure and control the incubation time to provide more accurate and precise results.

After opening valves 2003 and 2008, the increased capillary forces of compression zone 2104 causes filtrate to flow from storage zone 2004. Flow passageway 2009 terminates in sample distribution channel 2018, which has substantially larger capillary forces both to draw filtrate from storage zone 2004 and flow passageway 2009 as well as to reduce the filtrate volume not terminating in an incubation zone 2013. Operatively connected to sample distribution channel 2018 are incubation zones 2013. Each incubation zone 2013 has a flow passageway 2019 from sample distribution channel 2018 so that binding reagents in various incubation zones do not mix by convection or by diffusion (in a 20 minute time scale). Flow passageway 2019 is designed to minimize adverse pressure gradients from the expansion of the leading edge of the filtrate flowing down sample distribution channel 2018 by angling off of sample distribution channel 2018 at an angle less than perpendicular. The channels are designed for a 15 degree contact angle which is typical of surfactant treated polymers. Additionally all fluidic transitions on the device have gradual transitions between channel dimensions in locations where liquid flow is intended to be continuous. Flow down sample distribution channel 2018 is stopped by vent 2115 that is upstream of valve 2008

In the embodiment illustrated in FIGS. 21A-21E, incubation zones 2013 have a diameter of 0.8 mm, a depth of 2 mm, and a volume of 1 μL. The outlet of each incubation zone connects to vent 2113. In this instance vent 2113 is formed with a porous hydrophobic media (10 μm pore size, 0.025 inch thick, Teflon® hydrophobic media, Porex Technologies, Fairburn, Ga.). Because vent 2113 is hydrophobic, the single-piece vent 2113 is operative like the vent array 2014 while being easier to manufacture. Vent 2113 leads to valve 2008 to complete the seal used to have a separate storage zone and incubation zone.

Incubation zones 2013 comprise dry reagents comprising a binding reagent for an analyte of interest, a labeled molecule comprising a label, and a plurality of magnetizable capture beads (e.g., 0.3 or 0.5 μm diameter), wherein the dry reagents occupy 90% of the incubation zone. In a specific embodiment, the magnetizable capture bead may specifically bind to at least one of the analyte of interest, the binding reagent, and a compound comprising the binding reagent. When rehydrated by filtrate, the filtrate will intercalate the dry reagents so that the capture bead, binding reagent, and label do not have to diffuse the entire distance of the incubation zone—their initial distribution will be approximately uniform in the region the dry reagents occupied.

Incubation zones 2013 are terminated by waveguide 2117. Waveguide 2117 has tapered walls with a 60° angle so that light can be bent from incoming light to an appropriate angle (e.g., 70°) for total internal reflection fluorescence (TIRF) measurements. In this example, waveguide 2127 is made from PMMA. Excitation light enters and leaves through the tapered walls. The optical passageway length for the excitation light in waveguide 2127 is short to minimize the opportunities for scattering (e.g., Rayleigh and Mie), which can generate non-TIR light. While waveguide 2117 is illustrated with continuous tapered walls, other configurations are possible. For example, waveguide 2117 can comprise a TIRF-entrance surface 1402 and a whole- volume entrance surface 1403. For example, waveguide 2117 can comprise light barrier 1008 to reduce cross-talk due to the undesired illumination of neighboring measurement zones. For example, waveguide 2117 can comprise reflector surface 1404 that can serve the function of light barrier 1008 and can also be used to help position a light source to the incubation zones 2013.

Free-bound separation is performed by magnetically capturing the capture beads on waveguide 2117. Because the measurement zone is very thin in TIRF, only a very small amount of unbound label will be present in the measurement zone (e.g., less than 1 part per 10,000 for an incubation zone 2 mm tall and a TIRF zone of 127 nm). Blocking layer 2116 attaches waveguide 2117 to cartridge base 2131 and prevents excitation light from entering the sides of incubation zone 2013. Alternatively, the sides of incubation zone 2013 can be made opaque by careful selection of the material used in cartridge base 2131 (e.g., a plastic with a high carbon black content), or by a secondary operation such as metal plating the sides of incubation zone 2013. Blocking layer 2116 can have a metal or opaque plastic carrier with adhesive on both sides.

Seal 2118 lids the fluidic channels (e.g., 2010, 2004, 2009, 2018, and 2013), and can be made out of, for example, a tape with adhesive on one side. Alternatively, seal 2128 can be material that is heat sealed or ultrasonically welded to cartridge base 2131.

### III. EXAMPLES

### Example 1

### Free-Bound Separation Using Stoke's Washing

A fluidic structure similar to that in FIG. 17C was constructed. An image of the structure in shown in FIG. 19, wherein analogous parts have the same last two digits. The flow channels were formed by cutting 0.004 inch thick double sided adhesive tape (ARCare 8039) to the desired widths. The tape layer was sandwiched on the top and bottom with transparent Mylar (Duralar). The magnet (labeled 1901, which is analogous to magnet 1701 in FIG. 17 and magnet 1801 in FIG. 18) is a rectangular magnet whose dimensions are 0.125 inch (wide), 0.188 inch (long), 0.138 inch (high, direction of magnetization) and a magnetic energy product of 45 MGO, purchased from Dexter Magnetic Technology (Elk Grove Village, Ill.). Fluidic structure 1914 (width is 0.060″, analogous to fluidic structure 1714) holds test sample 1902 (analogous to incubated sample 1702). Test sample 1902 comprises 0.35 μm diameter carboxyl coated magnetic particles (part number CM-025010 from Spherotech, Libertyville, Ill.) at a concentration of 750 μg/mL and red dye in deionized water. Wash liquid 1903 comprised 300 mM KH₂PO₄, 150 mM tri-n-propylamine (TPA), 150 mM NaCl, 0.2 g/L Polyoxyethylene 9 lauryl ether, and 1 g/L Oxaban-A™ (Dow Chemical, Midland, Mich.) in deionized water and was introduced into fluidic structure 1913 (0.120″ width at the junction with fluidic structure 1914) from the top of the image at a rate of roughly 5 μL/s. After passing fluidic structure 1914, fluidic structure 1913 splits into fluidic structure 1973 (0.07″ width) and 1983 (0.07″ width). While not required to be operable, the split pathway serves to contain test sample 1903 in fluidic structure 1973, while enabling more pure wash liquid 1903 to proceed down fluidic structure 1983. This splitting can be useful, for example, when performing multiple free-bound separations with one source of wash liquid 1903. As shown in FIG. 19, the free-bound separation is completed after 1 minute from the start of the flow of wash liquid 1903: the magnetizable capture beads (labeled 1904) from test sample 1902, have been pulled from test sample 1902 into wash liquid 1903. The brown bead mass is apparently free of the red dye from test sample 1902, indicating the matrix (dye) that was around magnetizable capture beads 1904 in the beginning of the experiment has been replaced by wash liquid 1903.

### Example 2

### Magnetic Particle Stokes' Wash Using Bilayer Flow and Electrochemiluminescence Detection

A test was run to assess the wash performance of a device configured with a dynamic bilayer flow arrangement (analogous to FIG. 17a). The device had two inlets and one common outlet. The two inlet flow paths were joined to form a uniform rectangular channel (width=0.140 inch, height=0.025 inch, volume=25 μL). Fluids entering the two inlets converged and joined to form two liquid layers; i.e. bilayer. The relative flow rate into each inlet was adjusted such that layer thicknesses were nearly the same. In the top most flow passageway, sample solution was drawn using a syringe pump at 20 μL/s. In the bottom passageway, a wash or separation buffer was drawn using the same pump at 20 L/s. The wash layer within the channel flowed over a 90% platinum/10% iridium electrochemiluminescence (ECL) electrode. A counter electrode was located opposite the ECL electrode on the top most surface. Because of the bilayer arrangement, the sample solution did not make fluidic contact with the ECL electrode. The entire device was housed within and operated with an M1M Analyzer (BioVeris Corp.; Gaithersburg, Md., USA). ECL was detected using a photodiode optically coupled to the channel on the top most surface. Below the ECL electrode was positioned a permanent magnet (Dexter Magnetic Technology) whose dimensions are 0.125 inch (w), 0.188 inch (I), 0.138 inch (h, direction of magnetization) and a magnetic energy product of 45 MGO. Because of the magnetic field, magnetic particles in the sample solution were drawn from the top sample layer, washed in the wash layer, and collected onto the ECL electrode.

As a means for comparison, a test device was configured identically as above except that it had one inlet and one outlet. Instead of drawing both solutions in parallel or simultaneously to form a bilayer, the solutions were drawn serially. Sample solution was first drawn through the channel at a flow rate of 40 μL/s. Magnetic particles in the sample solution were drawn and collected onto the electrode. Subsequently, wash solution was drawn through the channel to wash both the magnetic particles and electrode.

The sample solution was composed of 60% normal human serum, 20% BV Diluent (BioVeris Corp), and 20% Procell (Roche Diagnostics) to which magnetic particles (Dynal, streptavidin coated, M-280) were added at a concentration of 35 μg/mL. An ECL label, ruthenium tris-bipyridine NHS (BioVeris Corp.), was covalently bound to the magnetic particle through streptavidin. The sample solution was utilized because of the high content of serum—containing substances known to interfere with ECL.

As a control, a solution composed of 20% BV Diluent, 80% Procell, and magnetic particles were used. The magnetic particles were the same as the sample solution. This solution was free of interferences.

The wash liquid was composed of 300 mM KH₂PO₄, 150 mM tri-n-propylamine (TPA), 150 mM NaCl, 0.2 g/L Polyoxyethylene 9 lauryl ether, and 1 g/L Oxaban-A™ (Dow Chemical; Midland, Mich., USA) in deionized water.

The wash performance of each device was assessed by measuring the electrochemiluminescence from particle bound label collected onto the electrode using the two sample solutions. The results were reported as a recovery; the ratio of ECL from the sample solution to the ECL from the control. A recovery of 100% would have indicated that the device washed the magnetic particles free of all interferences.

TABLE 1
Results - Comparison between two devices for wash performance
with an electrochemiluminescent measurement.

| | ECL recovery |
|---|---|
| Bilayer flow, particle wash only | 93% |
| Sequential flow, electrode and particle wash | 49% |

With the bilayer flow arrangement, the ECL recovery is very near unity at 93%. This means the magnetic particles are nearly washed free from interferences.

With the device where the electrode and magnetic particles are washed, the wash performance is significantly lower.

### Example 3

### Magnetic Particle Stokes' Wash Using Bilayer Flow and Electrochemical Detection

As a means to further assess the wash performance of the dynamic bilayer flow arrangement, as described above, an electrochemical measurement was carried out.

The wash performance was assessed using the same solutions and devices as above. Instead of measuring the extent to which unwashed substances interfere with ECL, the extent to which unwashed or adsorbed substances foul the electrode was measured. Electrode fouling occurred when components of the sample solution, such as serum proteins, adsorbed on the electrode and block the passing of current to the electrode.

For each device the electrochemical current for tri-n-propylamine oxidation in the wash liquid was used as a measure of electrode fouling. The results were reported as a recovery; the ratio of current from the sample solution to the current from the control. A recovery of 100% would have indicated that the device washed the electrode free of all interferences.

Using the bilayer arrangement, proteinaceous serum substances were not exposed to the electrode. Had the serum containing sample contacted the electrode, as with the sequential flow device, unwanted adsorption of proteins to the electrode surface would have resulted. As a result, lower electrochemical current was observed because serum protein adsorption blocks or fouls the electrode.

TABLE 2
Results - Comparison between two devices for wash
performance with an electrochemical measurement

| | current recovery |
|---|---|
| Bilayer flow, particle wash only | 99% |
| Sequential flow, electrode and particle wash | 91% |

Because of the bilayer flow arrangement, protein electrode fouling was substantially eliminated. The current recovery was close to 100%. As sample was drawn into the device, the wash layer protected the electrode from unwanted fouling. The result is that the electrochemical current was essentially the same between solutions with or without fouling substances.

With the device where the electrode and magnetic particles are exposed to fouling substances, the wash performance is significantly lower. The current recovery for TPA oxidation was 91%.

### Example 4

### Venous Pressure Assisted Plasma Generation Using Asymmetric Pore Membrane Separation Filter

A test device was constructed with an inlet for a blood sample, an outlet for plasma, and a second outlet for venting. A 23 gauge blood collection line (Becton Dickenson 367283) was used to transport blood to the test device. The collection line had a length of 30.5 cm and volume of 239 μL.

A test device was constructed of PMMA (polymethylmethacrylate) with an inlet that accepts the blood collection line. The inlet connected to a rectangular fill channel of 155 μL volume. The top surface of the channel was PMMA. The bottom surface was a blood separation filter (an asymmetric pore membrane blood separation filter, Pall Corp., BTS-SP 300 GT) with area of 1.9 cm². The fill channel had an outlet to vent displaced air. Once the channel filled with blood, the vent was sealed. The blood separation filter was sealed to the PPMMA housing using a single sided adhesive tape. A 0.125 inch diameter opening in the tape was formed as a passageway for plasma. A fluidic channel was formed to draw off plasma from the opening using double sided adhesive tape and transparent Mylar. The volume of plasma generated was measured in the channel.

The test liquid, blood or water, was dispensed into a 2 ml vial. The vial was sealed with a pierceable septum. The 23 gauge needle from the blood collection line was pierced through the septum so as to connect the test device to the test liquid. To simulate venous pressure with a tourniquet appropriately applied, a pressure head of 1 psi was applied to the vial. To connect the pressure head to the vial, a second line from a pressure regulator was connected to a needle which made a second piercing to the septum.

Using the test device and blood collection line, the times to (1) fill the blood collection line, (2) fill the test device collection volume, and (3) generate plasma were derived. The blood collection line and test device fill times were derived using water and then correcting for viscosity. The blood viscosity was 4 mPa·s and water viscosity was 0.9 mPa·s. Combining the measured times with volumes yielded the average volume flow rates as shown in Table 3.

TABLE 3
Times and rates with 1 psi pressure head

| | Volume | Time | Volume velocity |
|---|---|---|---|
| | (μL) | (s) | (μL/s) |
| Blood collection line | 239 | 24 | 10 |
| Blood fill in test device | 155 | 16 | 10 |
| Plasma generation | 23 | 11 | 2 |

Blood flows at 10 μL/s through the collection line. When connected to the test device, blood preferentially fills the collection channel at 10 μL/s. Once the blood fills the channel, the flow is diverted through the separation filter. The plasma flow rate is significantly lower then the blood flow rate at 2 μL/s. This indicates that the hydrodynamic resistance of the fill channel is lower than that through the separation filter. This is the source of the preferential flow. Only after the channel is filled and the vent sealed does flow occur through the separation filter. Results indicate that tourniquet-assisted venous pressure is sufficient to deliver blood into a measurement cartridge and to assist in plasma generation. The additional time that the cartridge would have to be in fluidic connection with the patient in order to create plasma is 11 seconds out of a total of 51 seconds.

### Example 5

### Venous Pressure Assisted Plasma Generation Using an Asymmetric Pore Membrane Separation Filter

Plasma separation and recovery by asymmetric pore membrane blood separation filter was achieved by making a test device from multiple layers of Mylar sheets, pressure sensitive adhesives (PSAs), and the plasma separation filter. Discs of asymmetric pore blood separation filter (Pall Corporation, BTS-SP300-GT) about ½ inch diameter were bonded to a Mylar (Grafix, 0.005″ Dura-Lar) support ring (OD 1 3/16″, ID ¾″), via rings (OD ¾″, ID ⅜″) of Mylar/PSA laminates (top ring: 3M, 9561) (bottom ring: ARI, ArCare 8039). Attached to the underside of the bottom ring of Mylar/PSA Laminate were chambers and channels formed from sheets of Mylar (Grafix, 0.005″ Dura-Lar) and Mylar/PSA laminates (3M, 9561). These layers were about ¾ inch in width and about 3½ inch long. Prior to carrier layer removal from the channel Mylar/PSA laminate, a hole was cut by punch to be the plasma receiving chamber. In these examples the chamber size was varied from ⅛ inch diameter, to 3/16 inch diameter, or to ¼ inch diameter. A channel was cut about 3 inch long from the chamber edge to end of device. This channel was either about 0.060″ wide or about 0.040″ wide. Then, the carrier layer was removed from side of the channel Mylar/PSA laminate and bonded to the Mylar top sheet. A punch was used to make a hole through this layer, concentric and the same size as the chamber size in the lower layer. Then the bottom carrier layer was removed from the channel Mylar/PSA Laminate and the bottom Mylar layer was attached. The channel was rendered hydrophilic by treatment with a detergent, Tween 20 (Sigma Chemicals, P-7949). A disc (⅜″) of a fine mesh screen (SaatiTech, PES 105/52 Hyphyl) was cut and placed into the inner diameter (ID) of the bottom bonding layer of Mylar/PSA (ARI, ArCare 8039), in contact with the bottom of the asymmetric pore blood separation filter. Discs of sintered porous polyethylene (PE Discs) sheet stock (Porex, 268) were cut to chamber sizes. The PE sheet stock was previously treated with a detergent, Octyl Glucopyranoside (Fluka, 75081), to render the material hydrophilic and low non specific binding. A disc of a fine mesh screen (SaatiTech, PES 105/52 Hyphyl) was cut to the same size as the chamber size and place into the bottom of the chamber before the PE Disc was inserted. The outer carrier layer was removed from the bottom bonding layer of Mylar/PSA (ARI, ArCare 8039), and the lower section of the device (containing chamber and channel) was attached. These plasma separation devices were mounted in a holding clamp with the large pores of the asymmetric pore blood separation filter facing up. A small ruler was attached along the channel to allow measurement of the plasma front as it moves down the channel. A known volume (100 μL) of citrated whole blood was applied to the top surface, and a timer was started. At defined times, the plasma front was measured, and the plasma volume in the channel was calculated. The results are shown in Table 4. As can be seen, plasma volumes from 5 μL to 20 μL can be obtained in less than 6 minutes.

TABLE 4
Plasma recovery as a function of time

| | ⅛ inch | 3/16 inch | ¼ inch |
|---|---|---|---|
| | chamber size | chamber size | chamber size |
| Time (min) | Volume (μL) | Volume (μL) | Volume (μL) |
| 0 | 0 | 0 | 0 |
| 2 | 8.3 | 8.2 | 6.1 |
| 4 | 12.9 | 13.1 | 10.8 |
| 6 | 16.6 | 19.3 | 16.8 |
| 8 | 18.7 | 23.1 | 20.0 |

### Example 6

### A Prophetic Assay Cartridge Detecting Spiked IgG in Whole Blood.

An assay cartridge of fluidic structure similar to that in FIG. 21 is constructed. The device integrates whole blood collection, plasma separation, liquid volume distribution, transport and metering, reagent mixing, binding incubation, bound-free separation, and bound phase label readout. These combined operations conduct a two-site sandwich immunoassay for IgG spiked in a blood specimen.

Prior to assembly of the assay cartridge device, cartridge base 2131 is immersed in 1% Triton X-100 surfactant solution for 30 seconds and dried at 35° C. Prior to operation of the assay cartridge device, 1 μL of the liquid form of the assay reagents is dispensed into each incubation zone. This solution consists of 1) Phosphate buffer saline (PBS: 10 mM Na HPO4 pH 7.0 150 mM NaCl: (DiaMedix: #1000-3)), 2) non-ionic detergent Octyl Glucopyranoside (5 mM) (Fluka: #75081), 3) Dextran 8% (w/w) (Sigma: D4876: Ave MW 150,000), 4) Sucrose 2% (w/w) (Sigma: S9378), 5) Bovine Serum Albumin (BSA) (0.1% (w/w): 1 (mg/ml)) (Seracare: AP-4510), 6) 0.5 micron streptavidin coated paramagnetic beads (25 μg/ml: Spherotech: SVM-05-10) coated with capture antibody (e.g. Biotin labeled Goat anti-Mouse IgG: Jackson Immuno Research Laboratories: #115-006-071: 30 μg protein/mg bead), and 7) detection antibody (250 ng/ml) (e.g. Alexa Fluor Allophycocyanin labeled Goat anti-Mouse IgG: Invitrogen: #A-21006). Once this solution is dispensed into each incubation zone, the reagents are lyophilized (−40° C. for 18 hours, ramp to room temperature) and then sealed until use.

A. Whole Blood Collection

To an acid citrate dextrose preserved blood specimen, mouse IgG (Jackson Immuno Research Laboratories) is spiked to varying concentration levels. The IgG concentrations are 0, 1, 10, and 100 ng/mL. A 1 mL disposable plastic syringe with a luer connection is filled with the spiked blood specimen. The syringe is then connected to the device though the luer fitting. Blood is dispensed into the device collection flow passageway by application of pressure to the syringe. The pressure driving blood into the test device is near 1 psi. Blood flows into the device until pressure is released from the syringe or there is sufficient back pressure generated when the plasma front reaches hydrophobic vent (Porex, #5540). The time to fill the device is under 1 minute.

B. Plasma Separation and Transport to Plasma Storage Volume

Once the blood fills the device collection flow passageway, the blood is directed through the blood separation filter (Pall Corp., BTS-SP 300 GT). As blood is carried into the separation filter, it flows vertically through the plasma separation filter with an area of 1.2 cm². Blood is directed into the separation filter since this is the only available outlet for blood flow. Valve 2003 is closed. The rate at which plasma is generated and collected in the storage zone is driven by the pressure from the syringe. Once plasma contacts the hydrophobic vent, flow ceases and the plasma volume is contained.

The volume of plasma generated is 39 μL. This accounts for the plasma volume from the end of flow passageway 2119 to the hydrophobic vent 2005. A small volume of plasma, approximately 1 μL, enters compression zone 2010. Additionally, approximately 1 μL of-plasma enters compression zone 2009. Visually, the plasma is free of unwanted red blood cells.

C. Liquid Volume Transport, Distribution, and Metering

Storage zone plasma is transported to the distribution channel 2018 when in sequence valve 2008 and valve 2003 are pierced with the sharp tip of an Exacto blade. As plasma liquid is carried into the distribution channel, approximately 1 μL aliquots are diverted sequentially into 18 discrete incubation zones. Plasma continues to flow along the distribution channel until the front reaches vent 2115. Plasma fills each incubation and continues to flow until the front reaches vent 2113. The incubation zone geometry is in the form of a cylinder with a diameter of 0.8 mm and depth of 2.0 mm. The incubation zone volume is 1 μL.

D. Reagent Mixing

Each incubation zone is a unitized hold of all reagents necessary to assay plasma for IgG. As plasma fills each incubation zone, the dried reagents are rapidly dissolved into the plasma.

E. Binding Incubation

As plasma flows into each incubation zone, the binding reaction is initiated upon contact. The binding reaction proceeds for 5 minutes.

F. Free-Bound Separation

After 5 minutes, a NdFeB permanent magnet is position below each incubation zone. The magnetizable beads are collected onto the readout zone at the bottom of each incubation zone. The bead concentration is such that a closest packed layer equivalent to a half monolayer is formed. The collection time is sufficient to collection substantially all the magnetic bead; 1 minute. During this operation, only bead bound label is transported to the readout zone. Unbound label remains in the solution phase.

G. Bound Phase Label Readout

The extent of binding IgG analyte to the magnetizable beads is measured in each incubation zone by a TIRF readout. TIRF label is excited using a 650 nm VM65002 2 mW laser diode module (Midwest Laser Products; Frankfort, Ill.). An excitation filter is placed in front of the laser (Semrock (Rochester, N.Y.) 650/13/95). Detection of fluorescence from the label is accomplished by use of a silicon photodiode (S2386-18K; Hamamatsu Corporation; Bridgewater, N.J.). An emission filter is placed in front of the silicon photodiode (a Semrock 794/160/95 bandpass filter followed by a 2 mm thick piece of Schott glass RG715(Schott North America Inc.; Puryea, Pa.)). Each incubation zone is measured sequentially. The TIRF signal from each readout is collected and averaged for 2 seconds. The detector dark signal with the laser off is collected, averaged, and subtracted from each TIRF readout.

H. Results

Each assay cartridge yields 18 dark corrected TIRF readouts. Since all 18 incubation zones hold, in this example, identical assay reagents, an average of 18 readouts is taken. Four concentration levels (0,1,10, and 100 ng/mL) of mouse IgG in blood are run in triplicate. Each replicate and each concentration level requires an assay cartridge. The trial of 12 cartridges finds that with increasing levels of IgG spiked into blood, the TIRF signal increases in proportion to the analyte concentration.

The specification is most thoroughly understood in light of the teachings of the references cited within the specification. The embodiments within the specification provide an illustration of embodiments of the invention and should not be construed to limit the scope of the invention. The skilled artisan readily recognizes that many other embodiments are encompassed by the invention. All publications and patents cited in this disclosure are incorporated by reference in their entirety. To the extent the material incorporated by reference contradicts or is inconsistent with this specification, the specification will supersede any such material. The citation of any references herein is not an admission that such references are prior art to the present invention.

Unless otherwise indicated, all numbers expressing quantities of ingredients, reaction conditions, and so forth used in the specification, including claims, are to be understood as being modified in all instances by the term “about.” Accordingly, unless otherwise indicated to the contrary, the numerical parameters are approximations and may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Unless otherwise indicated, the term “at least” preceding a series of elements is to be understood to refer to every element in the series. Those skilled in the art will recognize, or be able to ascertain using no more than routine experimentation, many equivalents to the specific embodiments of the invention described herein. Such equivalents are intended to be encompassed by the following claims.

1. An assay cartridge comprising:
one or more incubation zones comprising at least one binding reagent specific for an analyte of interest and at least one labeled molecule comprising a label;
a sample collection system comprising at least one of a needle and a needle-pierceable membrane; and
a fluidic architecture that connects a sample entering the cartridge through the sample collection system to the incubation zone.

2-3. (canceled)

4. The cartridge of claim 1, wherein the cartridge comprises a separation filter located fluidically between the sample collection system and the incubation zone.

5-7. (canceled)

8. The cartridge of claim 4, wherein the separation filter is an asymmetric pore membrane blood separation filter.

9. The cartridge of claim 4, further comprising a storage zone, wherein the storage zone is fluidically located between the filter and the incubation zone.

10. The cartridge of claim 9, wherein the sample collection system, the separation filter, and the storage zone are configured so that a sample donor's heart can generate at least part of the pressure that causes a blood sample from the sample donor to flow into the cartridge and plasma to flow from the separation filter into the storage zone.

11-20. (canceled)

21. The cartridge of claim 1, further comprising a plurality of magnetizable capture beads having diameters ranging from about 0.08 μm to about 10 μm.

22-23. (canceled)

24. The cartridge of claim 1, wherein each incubation zone is operatively connected to at least one measurement zone, and wherein each measurement zone is operatively connected to only one incubation zone.

25. The cartridge of claim 24, wherein the cartridge comprises a plurality of incubation zones.

26-28. (canceled)

29. An assay cartridge comprising
one or more binding reagents for an analyte of interest;
one or more labeled molecules comprising a label; and
one or more incubation zones comprising a dry composition comprising a plurality of magnetizable capture beads; wherein the dry composition occupies about 10% or more of the incubation zone.

30. (canceled)

31. The cartridge of claim 29, wherein the dry composition occupies about 50% or more of the incubation zone.

32-33. (canceled)

34. The cartridge of claim 29, wherein the capture beads range from about 10 μm in diameter to about 0.08 μm in diameter.

35-36. (canceled)

37. An instrument adapted to use the cartridge of claim 29, wherein the instrument comprises a magnetic field source and excludes an agitation mechanism for the beads.

38. The cartridge of claim 29, wherein the dry composition comprises the binding reagent and the labeled molecule.

39. The cartridge of claim 38, wherein the cartridge comprises a sample entry zone fluidically connectable to said incubation zone and a separation filter located fluidically between the sample entry zone and the incubation zone.

40-47. (canceled)

48. The cartridge of claim 29, wherein the label comprises a fluorophore.

49-50. (canceled)

51. The cartridge of claim 48, wherein the label has a Stoke's shift of about 50 nm or more.

52-58. (canceled)

59. An assay cartridge comprising:
one or more incubation zones comprising at least one binding reagent for an analyte of interest, at least one labeled molecule comprising a label, and a plurality of magnetizable capture beads;
one or more measurement zones comprising gas and fluidically connectable to said incubation zone;
a liquid reagent storage zone fluidically connectable to said measurement zone;
a sample entry zone fluidically connectable to said incubation zone;
a capillary stop positioned fluidically between the incubation zone and the measurement zone, said stop operative to impede liquid from going from incubation zone into the measurement zone when the measurement zone comprises gas;
a position on which a magnet external to the cartridge can be placed, so that the length of an imaginary straight line extending from a fixed point in the incubation zone to a fixed point at the position is about 20 mm or less, and wherein the imaginary straight line intersects the measurement zone.

60. The cartridge of claim 59 wherein the length is about 4 mm or less.

61. The cartridge of claim 59 wherein the cartridge further comprises a separation filter located fluidically between the sample entry zone and the incubation zone.

62-65. (canceled)

66. The cartridge of claim 59, comprising binding reagents specific for a total of at least 2 different analytes of interest.

67-78. (canceled)

79. The cartridge of claim 59, wherein each incubation zone is operatively connected to at least one measurement zone, and wherein each measurement zone is operatively connected to only one incubation zone.

80. The cartridge of claim 79, wherein the cartridge comprises a plurality of incubation zones.

81. The cartridge of claim 80, wherein the cartridge comprises fluidic passageways connecting the incubation zones, and further wherein the fluidic passageways are configured so that binding reagents in one incubation zone can not be diffusively transported to another incubation zone in less than about 20 minutes.

82-83. (canceled)

84. An assay cartridge comprising an incubation zone comprising:
an assay-performance-substance for one of the one or more analytes of interest comprising a label, a non-magnetizable bead having a diameter ranging from about 5 nm to about 10 μm, and at least one component chosen from an added analyte of interest, an added analog of said analyte, a binding reagent of said analyte or said analog, or a reactive component capable of binding with any of the foregoing;
a plurality of magnetizable capture beads capable of binding with the analyte and/or said assay-performance-substance, wherein the capture beads have a diameter ranging from about 0.08 μm to about 10 μm; and
a plurality of magnetizable separation beads not capable of binding with the analyte and/or said assay-performance-substance, wherein the separation beads have a diameter ranging from about 1 nm to about 20 nm.

85. The cartridge of claim 84, wherein the cartridge comprises a sample entry zone fluidically connectable to said incubation zone and a filter located fluidically between the sample entry zone and the incubation zone.

86-89. (canceled)

90. The cartridge of claim 84, comprising binding reagents specific for a total of at least 2 different analytes of interest.

91-106. (canceled)

107. An assay cartridge comprising:
one or more incubation zones comprising at least one binding reagent for an analyte of interest;
one or more storage zones fluidically connectable to said incubation zone;
a sample entry zone fluidically connectable to a separation filter, said separation filter located so that filtrate operatively formed from a sample contacting the separation filter via the sample entry zone enters space fluidically connectable to said storage zone; and
a sample flow control apparatus that does not prevent a liquid sample from going from the sample entry zone through the filter into the storage zone, and is externally controllable to stop or allow the flow of sample from the storage zone to the incubation zone.

108. The cartridge of claim 107, wherein the sample flow control apparatus comprises:
a vent configured to allow the passage of gas but not liquid, said vent located fluidically between the storage zone and the incubation zone; and
an externally controllable valve operative to stop or allow the flow of fluid, said valve located fluidically between the storage zone and the incubation zone.

109. The cartridge of claim 107, wherein the sample flow control apparatus comprises:
a vent configured to allow the passage of gas but not liquid, said vent located fluidically between the storage zone and the incubation zone; and
an externally controllable first valve operative to stop or allow the flow of fluid, said first valve located operatively downstream of the incubation zone.

110. The cartridge of 109, wherein the sample flow control apparatus further comprises an externally controllable second valve operative to stop or allow the flow of fluid, said second valve located fluidically between the sample entry zone and the sample storage zone.

111-128. (canceled)

129. The cartridge of claim 107, wherein each incubation zone is operatively connected to at least one measurement zone, and wherein each measurement zone is operatively connected to only one incubation zone.

130. The cartridge of claim 129, wherein the cartridge comprises a plurality of incubation zones.

131-133. (canceled)

134. An assay cartridge comprising:
an incubation zone comprising binding reagents for an analyte of interest;
a inlet passageway operatively downstream of the incubation zone;
a first outlet passageway operatively downstream of the inlet passageway comprising a measurement zone; and
a gas-filled second outlet passageway operatively downstream of the inlet passageway, said second outlet passageway comprising a vent configured to allow the passage of air but not liquid, said vent located operatively downstream of the junction between the inlet passageway and the second outlet passageway.

135. The cartridge of claim 134, further comprising:
a sample entry zone fluidically connectable to a separation filter; said separation filter located so that filtrate operatively formed from said separation filter enters a space fluidically connectable to the incubation zone.

136-155. (canceled)

156. The cartridge of claim 134, further comprising one or more incubation zones; wherein each incubation zone is operatively connected to at least one measurement zone, and wherein each measurement zone is operatively connected to only one incubation zone.

157-160. (canceled)

161. The cartridge of any of claims 1, 59, 84, 107, or 134, wherein the incubation zone comprises a dry composition comprising:
a binding reagent for an analyte of interest;
a labeled molecule comprising a label; and
a plurality of magnetizable capture beads; wherein the dry composition occupies at least 10% of the incubation zone.

162-165. (canceled)

166. The cartridge of any of claims 59 or 107, wherein the sample entry zone comprises a sample collection system comprising at least one of a needle and a needle-pierceable membrane through which a sample can operatively enter the cartridge.

167. The cartridge of claim 59, wherein the incubation zone comprises an assay-performance-substance for one of the one or more analytes of interest comprising a label, a non-magnetizable bead having a diameter ranging from about 5 nm to about 10 μm, and a binding reagent for said analyte; wherein the plurality of magnetizable capture beads have a diameter ranging from about 0.08 μm to about 10 μm; and a plurality of magnetizable separation beads not capable of specifically binding with the analyte and/or said assay-performance-substance, wherein the separation beads have a diameter ranging from about 1 nm to about 20 nm.

168. The cartridge of claim 59, further comprising:
a filter fluidically connectable to the sample entry zone, said filter located so that filtrate operatively formed from a sample contacting the filter via the sample entry zone enters space fluidically connectable to a storage zone; and
a sample flow control apparatus that does not prevent a liquid sample from going from the sample entry zone through the filter into the storage zone and is externally controllable to stop or allow the flow of sample from the storage zone to the incubation zone.

169-171. (canceled)

172. The cartridge of claim 168, wherein the incubation zone comprises a dry composition comprising the binding reagent for an analyte of interest; the labeled molecule comprising a label; and the plurality of magnetizable capture beads; wherein the dry composition occupies at least about 10% of the incubation zone.

173-176. (canceled)

177. The cartridge of claim 172, wherein the sample entry zone comprises a sample collection system comprising at least one of a needle and a needle- pierceable membrane through which a sample can operatively enter the cartridge.

178. The cartridge of any of claims 84 or 134, further comprising a sample collection system comprising at least one of a needle and a needle-pierceable membrane; and a fluidic distribution system that connects a sample entering the cartridge through the sample collection system to the incubation zone.

179. The cartridge of claim 107, wherein the sample entry zone comprises a sample collection system comprising at least one of a needle and a needle-pierceable membrane through which a sample can operatively enter the cartridge; wherein the incubation zone comprises a dry composition comprising
the binding reagent for an analyte of interest; and the plurality of magnetizable capture beads; and wherein the dry composition occupies at least 10% of the incubation zone.

180-183. (canceled)

184. The cartridge of claim 107, further comprising
an inlet passageway operatively downstream of the incubation zone;
a first outlet passageway operatively downstream of the inlet passageway comprising a measurement zone; and
a gas-filled second outlet passageway operatively downstream of the inlet passageway, said second outlet passageway comprising a vent configured to allow the passage of air but not liquid, said vent located operatively downstream of the junction between the inlet passageway and the second outlet passageway.

185. (canceled)

186. An assay cartridge comprising an opaque surface operative to complete a light tight enclosure in an instrument comprising a light detector.

187. The cartridge of claim 186, wherein the instrument is portable.

188. A method for detecting the presence of one or more analytes of interest in a sample, comprising:
obtaining a sample using a sample collection system comprising at least one of needle and a needle-pierceable membrane and being adapted to connect to a cartridge adapted to store the sample;
inserting the cartridge into a testing instrument; and
performing a test to detect the presence of the analyte of interest in the sample.

189. The method of claim 188, wherein the instrument is portable.

190. A method of generating plasma from an animal comprising a cardiovascular system in an assay cartridge, the method comprising:
creating a fluidic connection between a vessel in the animal's cardiovascular system and a blood separation filter, wherein the filter is fluidically connected to the assay cartridge; and
collecting plasma in the assay cartridge.

191. The method of claim 190, wherein the animal is a human.

192-193. (canceled)

194. A method for detecting the presence of one or more analytes of interest optionally present in a sample comprising:
(a) forming a composition comprising
(i) said sample;
(ii) an assay-performance-substance comprising a label and at least one component chosen from:
(1) an added analyte of interest or an added analog of said analyte,
(2) a binding partner of said analyte or said analog, and
(3) a reactive component capable of binding with any analyte or analog of (1) or (2);
(iii) a plurality of magnetizable capture beads capable of specifically binding with at least one of the analyte or said assay-performance-substance;
(b) incubating said composition, wherein, in the presence of the analyte or analog of interest, linking between the magnetizable capture beads and the assay- performance-substance occurs;
(c) bringing said composition in fluidic contact with a liquid reagent distinct from the composition;
(d) applying a magnetic field across the composition and liquid reagent of step (c), wherein the magnetizable capture beads are moved into a measurement zone; and
(e) detecting the label in the measurement zone, wherein the presence, or lack of presence, of one or more analytes of interest is detected in the sample.

195-197. (canceled)

198. The method of claim 194, wherein the detecting step further comprises quantifying the presence of one or more analytes.
